(19) United States
(12) Patent Application Publication
(10) Pub. No.: US 2010/0190794 A1
(43) Pub. Date: Jul. 29, 2010

(54) Herbicidally Active Composition

(75) Inventors: Eike Hupe, Mannheim (DE); William Karl Moberg, Neustadt (DE); Robert Reinhard, Limburgerhof (DE); Bernd Sievernich, Hassloch (DE); Elmar Kibler, Hassloch (DE)

Correspondence Address: BRINKS, HOFER, GILSON & LIONE, P.O. BOX 1340, MORRISVILLE, NC, 27560, US

(73) Assignee: BASF SE, Ludwigshafen (DE)

(21) Appl. No.: 12/663,795

(22) PCT Filed: Jun. 11, 2008
(86) PCT No.: PCT/EP2008/057330

§ 371 Date: Dec. 9, 2009

(30) Foreign Application Priority Data
Jun. 12, 2007 (EP) 07110126.5

(51) Int. Cl. A01N 43/60; A01N 43/70; A01P 13/02

(52) U.S. Cl. 514/245; 514/255.02

(57) ABSTRACT

The present invention relates to herbicidally active compositions comprising at least one piperazinedione compound of the formula I

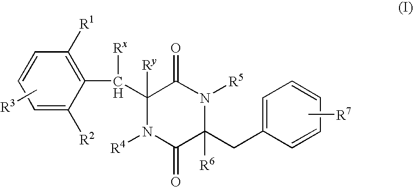

in which:
R^{x}, R^{y} are each hydrogen or together are a chemical bond;
R¹ is cyano or nitro;
R² is hydrogen, fluorine, chlorine, C₁-C₂-alkyl, ethenyl or C₁-C₂-alkoxy;
R³ is fluorine or hydrogen;
R⁴ is methyl;
R⁵ is hydrogen, methyl or ethyl;
R⁶ is hydrogen, methyl or ethyl; and
R⁷ is hydrogen or halogen;
and at least one further active compound selected from the group consisting of
b1) lipid biosynthesis inhibitors;
b2) acetolactate synthase inhibitors (ALS inhibitors);
b3) photosynthesis inhibitors;
b4) protoporphyrinogen-IX oxidase inhibitors,
b5) bleacher herbicides;
b6) enolpyruvyl shikimate 3-phosphate synthase inhibitors (EPSP inhibitors);
b7) glutamine synthetase inhibitors;
b8) 7,8-dihydropteroate synthase inhibitors (DHP inhibitors);
b9) mitose inhibitors;
b10) inhibitors of the synthesis of very long chain fatty acids (VLCFA inhibitors);
b11) cellulose biosynthesis inhibitors;
b12) decoupler herbicides;
b13) auxin herbicides;
b14) auxin transport inhibitors;
b15) other herbicides, and
C) safeners.

The present invention relates to herbicidally active compositions comprising at least one piperazinedione compound and at least one further compound selected from herbicidally active compounds and safeners.

In the case of crop protection compositions, it is desirable in principle to increase the specific activity of an active compound and the reliability of the effect. It is particularly desirable for the crop protection composition to control the harmful plants effectively, but at the same time to be compatible with the useful plants in question. Also desirable is a broad spectrum of activity allowing the simultaneous control of harmful plants. Frequently, this cannot be achieved using a single herbicidally active compound.

With many highly effective herbicides, there is the problem that their compatibility with useful plants, in particular dicotyledonous crop plants, such as cotton, oilseed rape and graminaceous plants, such as barley, millet, corn, rice, wheat and sugar cane, is not always satisfactory, i.e. in addition to the harmful plants, the crop plants, too, are damaged on a scale which cannot be tolerated. By reducing the application rates, the useful plants are spared; however, naturally, the extent of the control of harmful plants decreases, too.

In addition there is frequently the problem that, in order to achieve the desired herbicidal activity, the herbicides can only be used within a narrow time frame, where the time frame can be influenced unpredictably by weather conditions.

It is known that special combinations of different specifically active herbicides result in enhanced activity of a herbicide component in the sense of a synergistic effect. In this manner, it is possible to reduce the application rates of herbicidally active compounds required for controlling the harmful plants. Furthermore, it is known that in some cases joint application of specifically acting herbicides with organic active compounds, some of which may also have herbicidal activity, allows better crop plant compatibility to be achieved. In these cases, the active compounds act as antidotes or antagonists and are also referred to as safeners, since they reduce or even prevent damage to the crop plants.

The earlier patent application PCT/EP2006/070271 (WO 2007/077201) describes 2,5-diketopiperazine compounds having, in the 3-position and the 6-position, in each case an aryl or hetaryl radical attached via a methylene group.

The earlier patent application PCT/EP2007/050067 (WO 2007/077247) describes 2,5-diketopiperazine compounds which have, in the 3-position, an aryl or hetaryl radical attached via a methyne group and, in the 6-position, an aryl or hetaryl radical attached via a methylene group.

It is an object of the present invention to provide herbicidal compositions which are highly active against unwanted harmful plants. At the same time, the compositions should have good compatibility with useful plants. In addition, the compositions according to the invention should have a broad spectrum of activity.

This and further objects are achieved by the herbicidally active compositions below.

Accordingly, the present invention relates to herbicidally active compositions comprising:

A) at least one piperazinedione compound of the formula I

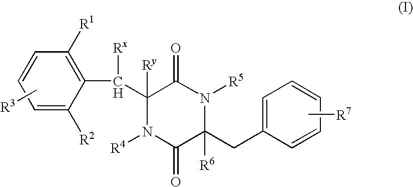

in which:
R^{x}, R^{y} are each hydrogen or together are a chemical bond;
R¹ is cyano or nitro;
R² is hydrogen, fluorine, chlorine, C₁-C₂-alkyl, ethenyl or C₁-C₂-alkoxy;
R³ is fluorine or hydrogen;
R⁴ is methyl;
R⁵ is hydrogen, methyl or ethyl;
R⁶ is hydrogen, methyl or ethyl; and
R⁷ is hydrogen or halogen;

and at least one further active compound selected from

B) herbicides of class b1) to b15):
b1) lipid biosynthesis inhibitors;
b2) acetolactate synthase inhibitors (ALS inhibitors);
b3) photosynthesis inhibitors;
b4) protoporphyrinogen-IX oxidase inhibitors,
b5) bleacher herbicides;
b6) enolpyruvyl shikimate 3-phosphate synthase inhibitors (EPSP inhibitors);
b7) glutamine synthetase inhibitors;
b8) 7,8-dihydropteroate synthase inhibitors (DHP inhibitors);
b9) mitose inhibitors;
b10) inhibitors of the synthesis of very long chain fatty acids (VLCFA inhibitors);
b11) cellulose biosynthesis inhibitors;
b12) decoupler herbicides;
b13) auxin herbicides;
b14) auxin transport inhibitors; and
b15) other herbicides selected from the group consisting of bromobutide, chlorflurenol, chlorflurenol-methyl, cinmethylin, cumyluron, dalapon, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-M-methyl, flurenol, flurenol-butyl, flurprimidol, fosamine, fosamine-ammonium, indanofan, maleic hydrazide, mefluidide, metam, methyl azide, methyl bromide, methyl-dymron, methyl iodide, MSMA, oleic acid, oxaziclomefone, pelargonic acid, pyributicarb, quinoclamine, triaziflam, tridiphane and 6-chloro-3-(2-cyclopropyl-6-methylphenoxy)-4-pyridazinol (CAS 499223-49-3) and its salts and esters;

and

C) safeners.

The invention relates in particular to compositions in the form of herbicidally active crop protection compositions comprising a herbicidally effective amount of an active compound combination comprising at least one piperazinedione compound A and at least one further compound selected from the herbicides B and the safeners C, as defined above, and also at least one liquid and/or solid carrier and/or one or more surfactants and, if desired, one or more further auxiliaries customary for crop protection compositions.

The invention also relates to compositions in the form of a crop protection composition formulated as a 1-component composition comprising an active compound combination comprising at least one piperazinedione compound of the formula I and at least one further active compound selected from the herbicides B and the safeners C, and at least one solid or liquid carrier and/or one or more surfactants and, if desired, one or more further auxiliaries customary for crop protection compositions.

The invention also relates to compositions in the form of a crop protection composition formulated as a 2-component composition comprising a first component comprising at least one piperazinedione compound of the formula I, a solid or liquid carrier and/or one or more surfactants, and a second component comprising at least one further active compound selected from the herbicides B and safeners C, a solid or liquid carrier and/or one or more surfactants, where additionally both components may also comprise further auxiliaries customary for crop protection compositions.

Surprisingly, the compositions according to the invention comprising at least one piperazinedione compound of the general formula I and at least one herbicide B have better herbicidal activity, i.e. better activity against harmful plants, than would have been expected based on the herbicidal activity observed for the individual compounds, or a broader activity spectrum. The herbicidal activity to be expected for mixtures based on the individual compound can be calculated using Colby's formula (see below). If the activity observed exceeds the expected additive activity of the individual compounds, synergism is said to be present.

In addition, the compositions according to the invention comprising at least one piperazine dione compound of the general formula I and one herbicide B and, if appropriate, one safener C extend the time frame during which the desired herbicidal action can be achieved. This allows a more flexible use over time of the compositions according to the invention compared to the individual compounds.

The compositions according to the invention comprising both at least one piperazinedione compound of the general formula I and at least one of the compounds mentioned under C also have good herbicidal activity against harmful plants and better compatibility with useful plants.

Surprisingly, the compositions according to the invention comprising at least one piperazinedione compound of the general formula I, at least one herbicide B and at least one of the compounds mentioned under C have better herbicidal activity, i.e. better activity against harmful plants, than would have been expected based on the herbicidal activity observed for the individual compounds, or a broader activity spectrum, and show better compatibility with useful plants than compositions comprising only one compound I and one herbicide B.

The invention furthermore relates to a method for controlling unwanted vegetation, in particular where crop plants are cultivated, for example in crops of the following crop plants: Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera, Zea mays, especially crops of cereals, corn, soybeans, rice, oilseed rape, cotton, potatoes, peanuts or permanent crops, and also in crops which are resistant to one or more herbicides or to attack by insects owing to genetic engineering or breeding.

The invention also relates to a method for the desiccation or defoliation of plants. In the last-mentioned method, it is of no importance whether the herbicidally active compounds of components A) and B) and, if appropriate, C) are formulated and applied jointly or separately and in which order application is carried out in the case of separate application.

The organic moieties mentioned in the definition of the substituents R¹ to R⁷ in formula I are—like the term halogen—collective terms for individual enumerations of the individual group members. The prefix Cₙ-Cₘ indicates in each case the possible number of carbon atoms in the group. Accordingly, C₁-C₂-alkyl is methyl or ethyl. C₁-C₂-alkoxy is methoxy or ethoxy. Aryl is a mono- or polycyclic aromatic hydrocarbon radical having from 6 to 14 carbon atoms, such as phenyl, naphthyl, anthracenyl or phenanthrenyl, preferably phenyl or naphthyl.

According to a first preferred embodiment of the invention, the composition comprises as active compound or component A at least one compound of the formula I in which R^{x} and R^{y} in formula I together are a covalent bond. Hereinbelow, these compounds are also referred to as compounds I.a.

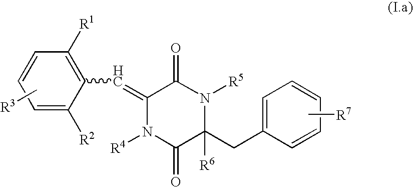

In formula I.a, R¹, R², R³, R⁴, R⁵, R⁶ and R⁷ have the meanings mentioned above. If R³ in formula I.a is fluorine, R³ is located in particular in the ortho-position to group R². If R⁷ is halogen, R⁷ is located in particular in the para-position to the point of attachment of the phenyl ring. If R⁷ is halogen, compounds of the formula I.a are also particularly preferred in which R⁷ is located in the meta-position to the point of attachment of the phenyl ring. Hereinbelow, compounds of the formula I.a in which R³ is located in the ortho-position to group R² and R⁷ is located in the meta- or para-position to the point of attachment of the phenyl ring are also referred to as compounds I.aa.

From among the compositions comprising as component A at least one compound I.a, preference is given to those compositions in which the compound of the formula I.a is present in the form of the (Z) isomer or in the form of a mixture of Z and E isomers which comprises predominantly the Z isomer. From among these, preference is given in particular to the pure Z isomer and to isomer mixtures having an E/Z ratio of not more than 1:2, in particular not more than 1:5.

At the carbon atom which carries the group R⁶, the compounds of the formula I have a center of chirality. A preferred embodiment of the invention relates to the pure enantiomers of the formula I.a-S given below in which R¹, R², R³, R⁴, R⁵, R⁶ and R⁷ have one of the meanings given above, in particular one of the meanings given below as being preferred or as being particularly preferred, and also to mixtures of enantiomers having an enantiomeric excess of the enantiomer of the formula I.a-S.

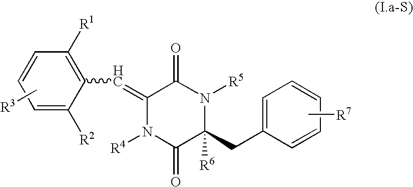

If R³ in formula I.a-S is fluorine, R³ is located in particular in the ortho-position to group R². If R⁷ is halogen, R⁷ is located in particular in the para-position to the point of attachment of the phenyl ring. If R⁷ is halogen, compounds of the formula I.a-S are also particularly preferred in which R⁷ is located in the meta-position to the point of attachment of the phenyl ring. Hereinbelow, compounds of the formula I.a-S in which R³ is located in the ortho-position to group R² and R⁷ is located in the meta- or para-position to the point of attachment of the phenyl ring are also referred to as compounds I.aa-S.

Enantiomeric excess preferably means an ee value (enantiomeric excess) of at least 70%, in particular at least 80% and especially at least 90%. Preference is also given to the agriculturally suitable salts of the enantiomers I.a-S and to mixtures of enantiomers of the salts having an enantiomeric excess of the enantiomer of the formula I.a-S.

Another embodiment of the invention, which is likewise preferred, relates to compositions comprising as active compound or component A a racemic mixture of at least one compound I.a-S with its optical antipode I.a-R.

According to a second embodiment of the invention, the composition comprises as component A at least one compound of the formula I in which R^{x} and R^{y} in formula I are each hydrogen. Hereinbelow, these compounds are also referred to as compounds I.b.

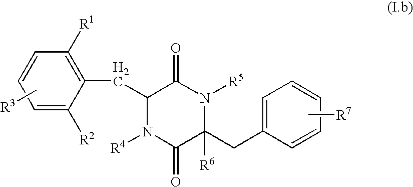

In formula I.b, R¹, R², R³, R⁴, R⁵, R⁶ and R⁷ have the meanings mentioned above. If R³ in formula I.b is fluorine, R³ is located in particular in the ortho-position to group R². If R⁷ is halogen, R⁷ is located in particular in the para-position to the point of attachment of the phenyl ring. If R⁷ is halogen, compounds of the formula I.b are also particularly preferred in which R⁷ is located in the meta-position to the point of attachment of the phenyl ring. Hereinbelow, compounds of the formula I.b in which R³ is located in the ortho-position to group R² and R⁷ is located in the meta- or para-position to the point of attachment of the phenyl ring are also referred to as compounds I.bb.

At the carbon atoms of the 3- and the 6-position of the piperazine ring, the compounds of the formula I.b each have centers of chirality. Preference is given to those compounds of the formula I.b in which the benzylic groups in the 3- and the 6-position have a cis arrangement with respect to the piperazine ring, i.e. to the S,S enantiomer (S,S)-I.b and to the R,R enantiomer (R,R)-I.b and to their mixtures. Preference is also given to mixtures of the cis compound(s) with the trans compound(s), in which the cis compound(s) is/are present in excess, in particular to cis/trans mixtures having a cis/trans ratio of at least 2:1, in particular at least 5:1.

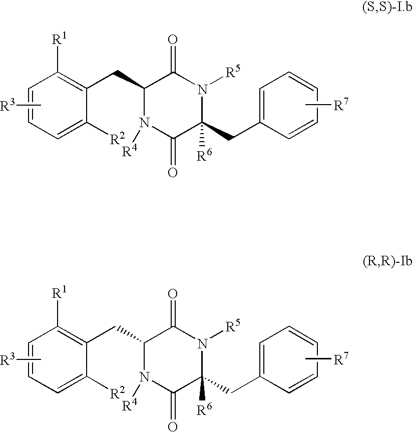

In the formulae (S,S)-I.b and (R,R)-I.b, R¹, R², R³, R⁴, R⁵, R⁶ and R⁷ have the meanings mentioned above. If R³ in formula I.b is fluorine, R³ is located in particular in the ortho-position to group R². If R⁷ is halogen, R⁷ is located in particular in the para-position to the point of attachment of the phenyl ring. If R⁷ is halogen, R⁷ is also located in particular in the meta-position to the point of attachment of the phenyl ring.

A particularly preferred embodiment of the invention relates to compositions comprising as component A the S,S enantiomer of the formula (S,S)-I.b, and also mixtures of enantiomers and mixtures of diastereomers of I.b in which the S,S enantiomer is the main component and accounts for preferably at least 70%, in particular at least 80% and especially at least 90% of the compound I. Preference is also given to the agriculturally suitable salts of the enantiomers (S,S)-I.b and to the mixtures of enantiomers and mixtures of diastereomers of the salts in which the S,S enantiomer is the main component and accounts for preferably at least 70%, in particular at least 80% and especially at least 90% of the compound I. Another embodiment, which is also preferred, relates to compositions comprising as component A a racemic mixture of the S,S enantiomer (S,S)-I.b with the R,R enantiomer (R,R)-I.b.

According to a preferred embodiment, R⁶ is hydrogen. According to another preferred embodiment, R⁶ is methyl or ethyl.

Independently thereof, the variables R², R³, R⁴, R⁵, R⁶ and R⁷ independently of one another preferably have one of the following meanings:

R²: hydrogen, fluorine, chlorine, methyl or methoxy, in particular hydrogen, fluorine or chlorine;

R³: hydrogen or fluorine;

R⁴: methyl;

R⁵: methyl;

R⁶: methyl;

R⁷: hydrogen or fluorine.

Preferred compounds of the formula I which, as component A, are constituent of the composition according to the invention are the compounds I-1 to I-102 listed below, in particular their Z isomers and especially the Z isomers in which the carbon in the 6-position of the piperazine ring has the S configuration.
I-1 2-[5-benzyl-1,4-dimethyl-3,6-dioxopiperazin-2-ylidenemethyl]benzonitrile,
I-2 2-[5-benzyl-1,4-dimethyl-3,6-dioxopiperazin-2-ylidenemethyl]-3-fluorobenzonitrile,
I-3 2-[5-benzyl-1,4-dimethyl-3,6-dioxopiperazin-2-ylidenemethyl]-3,4-difluorobenzonitrile,
I-4 2-[5-benzyl-1,4-dimethyl-3,6-dioxopiperazin-2-ylidenemethyl]-3-methoxybenzonitrile,
I-5 2-[5-benzyl-1,4-dimethyl-3,6-dioxopiperazin-2-ylidenemethyl]-3-ethenylbenzonitrile,
I-6 2-[5-(4-fluorobenzyl)I-1,4-dimethyl-3,6-dioxopiperazin-2-ylidenemethyl]benzonitrile,
I-7 2-[5-(4-fluorobenzyl)-1,4-dimethyl-3,6-dioxopiperazin-2-ylidenemethyl]-3-fluorobenzonitrile,
I-8 2-[5-(4-fluorobenzyl)-1,4-dimethyl-3,6-dioxopiperazin-2-ylidenemethyl]-3,4-difluorobenzonitrile,
I-9 2-[5-(4-fluorobenzyl)-1,4-dimethyl-3,6-dioxopiperazin-2-ylidenemethyl]-3-methoxybenzonitrile,
I-10 2-[5-(4-fluorobenzyl)-1,4-dimethyl-3,6-dioxopiperazin-2-ylidenemethyl]-3-ethenylbenzonitrile,
I-11 3-benzyl-6-[1-(2-nitrophenyl)methylidene]-1,4-dimethylpiperazine-2,5-dione,
I-12 3-benzyl-6-[1-(2-fluoro-6-nitrophenyl)methylidene]-1,4-dimethylpiperazine-2,5-dione,
I-13 3-benzyl-6-[1-(2-ethenyl-6-nitrophenyl)methylidene]-1,4-dimethylpiperazine-2,5-dione,
I-14 3-benzyl-6-[1-(2-methoxy-6-nitrophenyl)methylidene]-1,4-dimethylpiperazine-2,5-dione,
I-15 3-benzyl-6-[1-(2,3-difluoro-6-nitrophenyl)methylidene]-1,4-dimethylpiperazine-2,5-dione,
I-16 3-(4-fluorobenzyl)-6-[1-(2-nitrophenyl)methylidene]-1,4-dimethylpiperazine-2,5-dione,
I-17 3-(4-fluorobenzyl)-6-[1-(2-fluoro-6-nitrophenyl)methylidene]-1,4-dimethylpiperazine-2,5-dione,
I-18 3-(4-fluorobenzyl)-6-[1-(2-methyl-6-nitrophenyl)methylidene]-1,4-dimethylpiperazine-2,5-dione,
I-19 3-(4-fluorobenzyl)-6-[1-(2-methoxy-6-nitrophenyl)methylidene]-1,4-dimethylpiperazine-2,5-dione,
I-20 3-(4-fluorobenzyl)-6-[1-(2,3-difluoro-6-nitrophenyl)methylidene]-1,4-dimethylpiperazine-2,5-dione,
I-21 2-[5-benzyl-1,4,5-trimethyl-3,6-dioxopiperazin-2-ylidenemethyl]benzonitrile,
I-22 2-[5-benzyl-1,4,5-trimethyl-3,6-dioxopiperazin-2-ylidenemethyl]-3-fluorobenzonitrile,
I-23 2-[5-benzyl-1,4,5-trimethyl-3,6-dioxopiperazin-2-ylidenemethyl]-3-methoxybenzonitrile,
I-24 2-[5-benzyl-1,4,5-trimethyl-3,6-dioxopiperazin-2-ylidenemethyl]-3,4-difluorobenzonitrile,
I-25 2-[5-benzyl-1,4,5-trimethyl-3,6-dioxopiperazin-2-ylidenemethyl]-3-methylbenzonitrile,
I-26 2-[5-benzyl-1,5-dimethyl-3,6-dioxopiperazin-2-ylidenemethyl]benzonitrile,
I-27 2-[5-benzyl-1,5-dimethyl-3,6-dioxopiperazin-2-ylidenemethyl]-3-fluorobenzonitrile,
I-28 2-[5-benzyl-1,5-dimethyl-3,6-dioxopiperazin-2-ylidenemethyl]-3-methoxybenzonitrile,
I-29 2-[5-benzyl-1,5-dimethyl-3,6-dioxopiperazin-2-ylidenemethyl]-3,4-difluorobenzonitrile,
I-30 2-[5-benzyl-1,5-dimethyl-3,6-dioxopiperazin-2-ylidenemethyl]-3-methylbenzonitrile,
I-31 2-[5-benzyl-5-ethyl-1,4-dimethyl-3,6-dioxopiperazin-2-ylidenemethyl]-benzonitrile,
I-32 2-[5-benzyl-5-ethyl-1,4-dimethyl-3,6-dioxopiperazin-2-ylidenemethyl]-3-fluorobenzonitrile,
I-33 2-[5-benzyl-5-ethyl-1,4-dimethyl-3,6-dioxopiperazin-2-ylidenemethyl]-3-methoxy-benzonitrile,
I-34 2-[5-benzyl-5-ethyl-1,4-dimethyl-3,6-dioxopiperazin-2-ylidenemethyl]-3,4-difluorobenzonitrile,
I-35 2-[5-benzyl-5-ethyl-1,4-dimethyl-3,6-dioxopiperazin-2-ylidenemethyl]-3-methylbenzonitrile,
I-36 2-[5-benzyl-5-ethyl-1-methyl-3,6-dioxopiperazin-2-ylidenemethyl]benzonitrile,
I-37 2-[5-benzyl-5-ethyl-1-methyl-3,6-dioxopiperazin-2-ylidenemethyl]-3-fluorobenzonitrile,
I-38 2-[5-benzyl-5-ethyl-1-methyl-3,6-dioxopiperazin-2-ylidenemethyl]-3-methoxybenzonitrile,
I-39 2-[5-benzyl-5-ethyl-1-methyl-3,6-dioxopiperazin-2-ylidenemethyl]-3,4-difluorobenzonitrile,
I-40 2-[5-benzyl-5-ethyl-1-methyl-3,6-dioxopiperazin-2-ylidenemethyl]-3-methylbenzonitrile,
I-41 3-benzyl-6-[1-(2-nitrophenyl)methylidene]-1,3,4-trimethylpiperazine-2,5-dione,
I-42 3-benzyl-6-[1-(2-fluoro-6-nitrophenyl)methylidene]-1,3,4-trimethylpiperazine-2,5-dione,
I-43 3-benzyl-6-[1-(2,3-difluoro-6-nitrophenyl)methylidene]-1,3,4-trimethylpiperazine-2,5-dione,
I-44 3-benzyl-6-[1-(2-methoxy-6-nitrophenyl)methylidene]-1,3,4-trimethylpiperazine-2,5-dione,
I-45 3-benzyl-6-[1-(2-methyl-6-nitrophenyl)methylidene]-1,3,4-trimethylpiperazine-2,5-dione,
I-46 3-benzyl-6-[1-(2-ethenyl-6-nitrophenyl)methylidene]-1,3,4-trimethylpiperazine-2,5-dione,
I-47 3-benzyl-6-[1-(2-nitrophenyl)methylidene]-1,3-dimethylpiperazine-2,5-dione,
I-48 3-benzyl-6-[1-(2-fluoro-6-nitrophenyl)methylidene]-1,3-dimethylpiperazine-2,5-dione,
I-49 3-benzyl-6-[1-(2,3-difluoro-6-nitrophenyl)methylidene]-1,3-dimethylpiperazine-2,5-dione,
I-50 3-benzyl-6-[1-(2-methoxy-6-nitrophenyl)methylidene]-1,3-dimethylpiperazine-2,5-dione,
I-51 3-benzyl-6-[1-(2-methyl-6-nitrophenyl)methylidene]-1,3-dimethylpiperazine-2,5-dione,
I-52 3-benzyl-6-[1-(2-nitrophenyl)-methylidene]-3-ethyl-1,4-dimethylpiperazine-2,5-dione,
I-53 3-benzyl-6-[1-(2-fluoro-6-nitrophenyl)methylidene]-3-ethyl-1,4-dimethylpiperazine-2,5-dione,
I-54 3-benzyl-6-[1-(2,3-difluoro-6-nitrophenyl)methylidene]-3-ethyl-1,4-dimethylpiperazine-2,5-dione,
I-55 3-benzyl-6-[1-(2-methoxy-6-nitrophenyl)methylidene]-3-ethyl-1,4-dimethylpiperazine-2,5-dione,
I-56 3-benzyl-6-[1-(2-methyl-6-nitrophenyl)methylidene]-3-ethyl-1,4-dimethylpiperazine-2,5-dione,
I-57 3-benzyl-6-[1-(2-ethenyl-6-nitrophenyl)methylidene]-3-ethyl-1,4-dimethylpiperazine-2,5-dione,
I-58 3-benzyl-6-[1-(2-nitrophenyl)methylidene]-3-ethyl-1-methylpiperazine-2,5-dione,
I-59 3-benzyl-6-[1-(2-fluoro-6-nitrophenyl)-methylidene]-3-ethyl-1-methylpiperazine-2,5-dione,
I-60 3-benzyl-6-[1-(2,3-difluoro-6-nitrophenyl)methylidene]-3-ethyl-1-methylpiperazine-2,5-dione,
I-61 3-benzyl-6-[1-(2-methoxy-6-nitrophenyl)methylidene]-3-ethyl-1-methylpiperazine-2,5-dione,
I-62 3-benzyl-6-[1-(2-methyl-6-nitrophenyl)methylidene]-3-ethyl-1-methylpiperazine-2,5-dione, and
I-63 2-[5-(4-fluorobenzyl)-1,4,5-trimethyl-3,6-dioxopiperazin-2-ylidenemethyl]-benzonitrile,
I-64 2-[5-(4-fluorobenzyl)-1,4,5-trimethyl-3,6-dioxopiperazin-2-ylidenemethyl]-3-fluorobenzonitrile,
I-65 2-[5-(4-fluorobenzyl)-1,4,5-trimethyl-3,6-dioxopiperazin-2-ylidenemethyl]-3-methoxybenzonitrile,
I-66 2-[5-(4-fluorobenzyl)-1,4,5-trimethyl-3,6-dioxopiperazin-2-ylidenemethyl]-3,4-difluorobenzonitrile,
I-67 2-[5-(4-fluorobenzyl)-1,4,5-trimethyl-3,6-dioxopiperazin-2-ylidenemethyl]-3-methylbenzonitrile,
I-68 2-[5-(4-fluorobenzyl)-1,5-dimethyl-3,6-dioxopiperazin-2-ylidenemethyl]benzonitrile,
I-69 2-[5-(4-fluorobenzyl)-1,5-dimethyl-3,6-dioxopiperazin-2-ylidenemethyl]-3-fluorobenzonitrile,
I-70 2-[5-(4-fluorobenzyl)-1,5-dimethyl-3,6-dioxopiperazin-2-ylidenemethyl]-3-methoxybenzonitrile,
I-71 2-[5-(4-fluorobenzyl)-1,5-dimethyl-3,6-dioxopiperazin-2-ylidenemethyl]-3,4-difluorobenzonitrile,
I-72 2-[5-(4-fluorobenzyl)-1,5-dimethyl-3,6-dioxopiperazin-2-ylidenemethyl]-3-methylbenzonitrile,
I-73 2-[5-(4-fluorobenzyl)-5-ethyl-1,4-dimethyl-3,6-dioxopiperazin-2-ylidenemethyl]-benzonitrile
I-74 2-[5-(4-fluorobenzyl)-5-ethyl-1,4-dimethyl-3,6-dioxopiperazin-2-ylidenemethyl]-3-fluorobenzonitrile
I-75 2-[5-(4-fluorobenzyl)-5-ethyl-1,4-dimethyl-3,6-dioxopiperazin-2-ylidenemethyl]-3-methoxybenzonitrile
I-76 2-[5-(4-fluorobenzyl)-5-ethyl-1,4-dimethyl-3,6-dioxopiperazin-2-ylidenemethyl]-3,4-difluorobenzonitrile,
I-77 2-[5-(4-fluorobenzyl)-5-ethyl-1,4-dimethyl-3,6-dioxopiperazin-2-ylidenemethyl]-3-methylbenzonitrile,
I-78 2-[5-(4-fluorobenzyl)-5-ethyl-1-methyl-3,6-dioxopiperazin-2-ylidenemethyl]-benzonitrile,
I-79 2-[5-(4-fluorobenzyl)-5-ethyl-1-methyl-3,6-dioxopiperazin-2-ylidenemethyl]-3-fluorobenzonitrile,
I-80 2-[5-(4-fluorobenzyl)-5-ethyl-1-methyl-3,6-dioxopiperazin-2-ylidenemethyl]-3-methoxybenzonitrile,
I-81 2-[5-(4-fluorobenzyl)-5-ethyl-1-methyl-3,6-dioxopiperazin-2-ylidenemethyl]-3,4-difluorobenzonitrile,
I-82 2-[5-(4-fluorobenzyl)-5-ethyl-1-methyl-3,6-dioxopiperazin-2-ylidenemethyl]-3-methylbenzonitrile,
I-83 3-(4-fluorobenzyl)-6-[1-(2-nitrophenyl)methylidene]-1,3,4-trimethylpiperazine-2,5-dione,
I-84 3-(4-fluorobenzyl)-6-[1-(2-fluoro-6-nitrophenyl)methylidene]-1,3,4-trimethyl-piperazine-2,5-dione,
I-85 3-(4-fluorobenzyl)-6-[1-(2,3-difluoro-6-nitrophenyl)methylidene]-1,3,4-trimethyl-piperazine-2,5-dione,
I-86 3-(4-fluorobenzyl)-6-[1-(2-methoxy-6-nitrophenyl)methylidene]-1,3,4-trimethyl-piperazine-2,5-dione,
I-87 3-(4-fluorobenzyl)-6-[1-(2-methyl-6-nitrophenyl)methylidene]-1,3,4-trimethyl-piperazine-2,5-dione,
I-88 3-(4-fluorobenzyl)-6-[1-(2-nitrophenyl)methylidene]-1,3-dimethylpiperazine-2,5-dione,
I-89 3-(4-fluorobenzyl)-6-[1-(2-fluoro-6-nitrophenyl)methylidene]-1,3-dimethyl-piperazine-2,5-dione,
I-90 3-(4-fluorobenzyl)-6-[1-(2,3-difluoro-6-nitrophenyl)methylidene]-1,3-dimethyl-piperazine-2,5-dione,
I-91 3-(4-fluorobenzyl)-6-[1-(2-methoxy-6-nitrophenyl)methylidene]-1,3-dimethyl-piperazine-2,5-dione,
I-92 3-(4-fluorobenzyl)-6-[1-(2-methyl-6-nitrophenyl)methylidene]-1,3-dimethyl-piperazine-2,5-dione,
I-93 3-(4-fluorobenzyl)-6-[1-(2-nitrophenyl)methylidene]-3-ethyl-1,4-dimethyl-piperazine-2,5-dione,
I-94 3-(4-fluorobenzyl)-6-[1-(2-fluoro-6-nitrophenyl)methylidene]-3-ethyl-1,4-dimethyl-piperazine-2,5-dione,
I-95 3-(4-fluorobenzyl)-6-[1-(2,3-difluoro-6-nitrophenyl)methylidene]-3-ethyl-1,4-dimethylpiperazine-2,5-diose,
I-96 3-(4-fluorobenzyl)-6-[1-(2-methoxy-6-nitrophenyl)methylidene]-3-ethyl-1,4-dimethylpiperazine-2,5-dione,
I-97 3-(4-fluorobenzyl)-6-[1-(2-methyl-6-nitrophenyl)methylidene]-3-ethyl-1,4-dimethylpiperazine-2,5-dione,
I-98 3-(4-fluorobenzyl)-6-[1-(2-nitrophenyl)methylidene]-3-ethyl-1-methylpiperazine-2,5-dione,
I-99 3-(4-fluorobenzyl)-6-[1-(2-fluoro-6-nitrophenyl)methylidene]-3-ethyl-1-methyl-piperazine-2,5-dione,
I-100 3-(4-fluorobenzyl)-6-[1-(2,3-difluoro-6-nitrophenyl)methylidene]-3-ethyl-1-methyl-piperazine-2,5-dione,
I-101 3-(4-fluorobenzyl)-6-[1-(2-methoxy-6-nitrophenyl)methylidene]-3-ethyl-1-methyl-piperazine-2,5-dione and
I-102 3-(4-fluorobenzyl)-6-[1-(2-methyl-6-nitrophenyl)methylidene]-3-ethyl-1-methyl-piperazine-2,5-dione.

Preferred compounds of the formula I which, as component A are constituent of the composition according to the invention are furthermore the compounds I-103 to I-146 listed below, in particular their cis isomers and especially their S,S isomers.
I-103 2-[5-benzyl-1,4,5-trimethyl-3,6-dioxopiperazin-2-ylmethyl]benzonitrile,
I-104 2-[5-benzyl-1,4,5-trimethyl-3,6-dioxopiperazin-2-ylmethyl]-3-fluorobenzonitrile,
I-105 2-[5-benzyl-1,4,5-trimethyl-3,6-dioxopiperazin-2-ylmethyl]-3-methoxybenzonitrile,
I-106 2-[5-benzyl-1,4,5-trimethyl-3,6-dioxopiperazin-2-ylmethyl]-3,4-difluorobenzonitrile,
I-107 2-[5-benzyl-1,5-dimethyl-3,6-dioxopiperazin-2-ylmethyl]benzonitrile,
I-108 2-[5-benzyl-1,5-dimethyl-3,6-dioxopiperazin-2-ylmethyl]-3-fluorobenzonitrile,
I-109 2-[5-benzyl-1,5-dimethyl-3,6-dioxopiperazin-2-ylmethyl]-3-methoxybenzonitrile,
I-110 2-[5-benzyl-1,5-dimethyl-3,6-dioxopiperazin-2-ylmethyl]-3,4-difluorobenzonitrile,
I-111 2-[5-benzyl-1,4-dimethyl-3,6-dioxopiperazin-2-ylmethyl]benzonitrile,
I-112 2-[5-benzyl-1,4-dimethyl-3,6-dioxopiperazin-2-ylmethyl]-3-fluorobenzonitrile,
I-113 2-[5-benzyl-1,4-dimethyl-3,6-dioxopiperazin-2-ylmethyl]-3-methoxybenzonitrile,
I-114 2-[5-benzyl-1,4-dimethyl-3,6-dioxopiperazin-2-ylmethyl]-3,4-difluorobenzonitrile,
I-115 2-[5-(4-fluorobenzyl)-1,4,5-trimethyl-3,6-dioxopiperazin-2-ylmethyl]benzonitrile,
I-116 2-[5-(4-fluorobenzyl)-1,4,5-trimethyl-3,6-dioxopiperazin-2-ylmethyl]-3-fluorobenzonitrile,
I-117 2-[5-(4-fluorobenzyl)-1,4,5-trimethyl-3,6-dioxopiperazin-2-ylmethyl]-3-methoxybenzonitrile,
I-118 2-[5-(4-fluorobenzyl)-1,4,5-trimethyl-3,6-dioxopiperazin-2-ylmethyl]-3,4-difluorobenzonitrile,
I-119 2-[5-(4-fluorobenzyl)-1,5-dimethyl-3,6-dioxopiperazin-2-ylmethyl]benzonitrile,
I-120 2-[5-(4-fluorobenzyl)-1,5-dimethyl-3,6-dioxopiperazin-2-ylmethyl]-3-fluorobenzonitrile,
I-121 2-[5-(4-fluorobenzyl)-1,5-dimethyl-3,6-dioxopiperazin-2-ylmethyl]-3-methoxybenzonitrile,
I-122 2-[5-(4-fluorobenzyl)-1,5-dimethyl-3,6-dioxopiperazin-2-ylmethyl]-3,4-difluorobenzonitrile,
I-123 2-[5-(4-fluorobenzyl)-1,4-dimethyl-3,6-dioxopiperazin-2-ylmethyl]benzonitrile,
I-124 2-[5-(4-fluorobenzyl)-1,4-dimethyl-3,6-dioxopiperazin-2-ylmethyl]-3-fluorobenzonitrile,
I-125 2-[5-(4-fluorobenzyl)-1,4-dimethyl-3,6-dioxopiperazin-2-ylmethyl]-3-methoxy-benzonitrile,
I-126 2-[5-(4-fluorobenzyl)-1,4-dimethyl-3,6-dioxopiperazin-2-ylmethyl]-3,4-difluoro-benzonitrile,
I-127 3-benzyl-6-(2-nitrobenzyl)-1,3,4-trimethylpiperazine-2,5-dione,
I-128 3-benzyl-6-(2-fluoro-6-nitrobenzyl)-1,3,4-trimethylpiperazine-2,5-dione,
I-129 3-benzyl-6-(2,3-difluoro-6-nitrobenzyl)-1,3,4-trimethylpiperazine-2,5-dione,
I-130 3-benzyl-6-(2-methoxy-6-nitrobenzyl)-1,3,4-trimethylpiperazine-2,5-dione,
I-131 3-benzyl-6-(2-nitrobenzyl)-1,3-dimethylpiperazine-2,5-dione,
I-132 3-benzyl-6-(2-fluoro-6-nitrobenzyl)-1,3-dimethylpiperazine-2,5-dione,
I-133 3-benzyl-6-(2,3-difluoro-6-nitrobenzyl)-1,3-dimethylpiperazine-2,5-dione,
I-134 3-benzyl-6-(2-methoxy-6-nitrobenzyl)-1,3-dimethylpiperazine-2,5-dione,
I-135 3-benzyl-6-(2-nitrobenzyl)-1,4-dimethylpiperazine-2,5-dione,
I-136 3-benzyl-6-(2-fluoro-6-nitrobenzyl)-1,4-dimethylpiperazine-2,5-dione,
I-137 3-benzyl-6-(2,3-difluoro-6-nitrobenzyl)-1,4-dimethylpiperazine-2,5-dione,
I-138 3-benzyl-6-(2-methoxy-6-nitrobenzyl)-1,4-dimethylpiperazine-2,5-dione,
I-139 3-(4-fluorobenzyl)-6-(2-nitrobenzyl)-1,3,4-trimethylpiperazine-2,5-dione,
I-140 3-(4-fluorobenzyl)-6-(2-fluoro-6-nitrobenzyl)-1,3,4-trimethylpiperazine-2,5-dione,
I-141 3-(4-fluorobenzyl)-6-(2,3-difluoro-6-nitrobenzyl)-1,3,4-trimethylpiperazine-2,5-dione,
I-142 3-(4-fluorobenzyl)-6-(2-methoxy-6-nitrobenzyl)-1,3,4-trimethylpiperazine-2,5-dione,
I-143 3-(4-fluorobenzyl)-6-(2-nitrobenzyl)-1,3-dimethylpiperazine-2,5-dione,
I-144 3-(4-fluorobenzyl)-6-(2-fluoro-6-nitrobenzyl)-1,3-dimethylpiperazine-2,5-dione,
I-145 3-(4-fluorobenzyl)-6-(2,3-difluoro-6-nitrobenzyl)-1,3-dimethylpiperazine-2,5-dione and
I-146 3-(4-fluorobenzyl)-6-(2-methoxy-6-nitrobenzyl)-1,3-dimethylpiperazine-2,5-dione.

According to a particularly preferred embodiment of the invention, the composition comprises, as compound A, the compound I-1, i.e. 2-[5-benzyl-1,4-dimethyl-3,6-dioxopiperazin-2-ylidenemethyl]benzonitrile.

According to a further particularly preferred embodiment of the invention, the composition comprises, as compound A, the compounds I-21, i.e. 2-[5-benzyl-1,4,5-trimethyl-3,6-dioxopiperazin-2-ylidenemethyl]benzonitrile.

According to a further particularly preferred embodiment of the invention, the composition comprises, as compound A, the compounds I-103, i.e. 2-[5-benzyl-1,4,5-trimethyl-3,6-dioxopiperazin-2-ylmethyl]benzonitrile.

The piperazinedione compounds of the formula I in which R⁶ is hydrogen are known from the earlier patent applications PCT/EP2006/070271 (WO 2007/077201) (compounds where R^{x}═R^{y}═H) and PCT/EP2007/050067 (WO 2007/077247) (compounds where R^{x} forms a bond with R^{y}).

Compounds of the formula I in which R⁶ is methyl or ethyl are subject of parallel applications.

The compounds I in which R⁶ is hydrogen can be prepared analogously to the methods described in PCT/EP2006/070271 (WO 2007/077201) and PCT/EP2007/050067 (WO 2007/077247). The relevant disclosure in PCT/EP2006/070271 and PCT/EP2007/050067 is hereby incorporated herein in its entirety. Besides, reference is made to the preparation examples in the present application.

This apart, the compounds I can be prepared, for example, by the methods outlined in the schemes below:

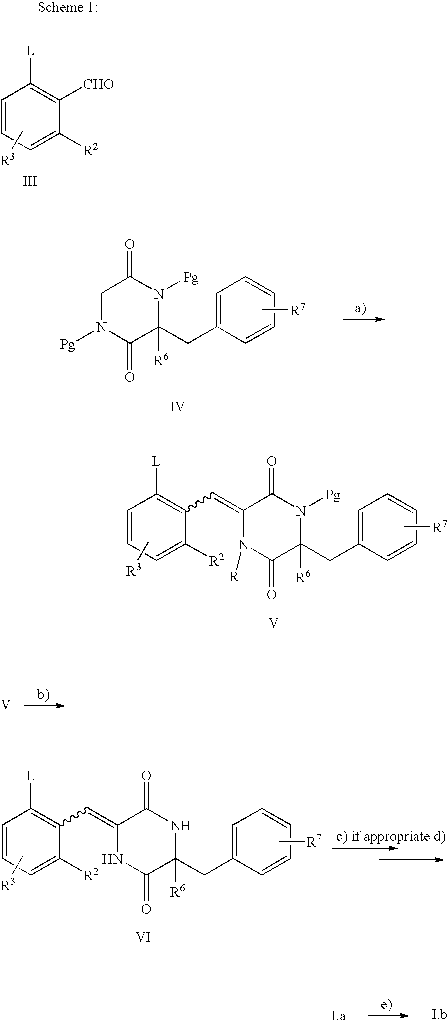

In scheme 1, R², R³, R⁶ and R⁷ have the meanings mentioned above. L is halogen, e.g. bromine, CN or nitro. Pg is a nitrogen protective group, for example an acetyl radical. R is hydrogen or a protective group Pg.

In step a), a substituted benzaldehyde compound III is reacted under the conditions of an aldol condensation with an N-protected piperazine-2,5-dione compound IV which is benzylated in the 3-position.

Such aldol condensations can be carried out analogously to the process described in J. Org. Chem. 2000, 65 (24), 8402-8405, Synlett 2006, 677, J. Heterocycl. Chem. 1988, 25, 591, the entire contents of which is hereby incorporated herein.

The aldol condensation is typically carried out in the presence of suitable bases. Suitable bases are those which are usually employed in aldol condensations. The base used is preferably an alkali metal or alkaline earth metal carbonate, for example sodium carbonate, potassium carbonate or cesium carbonate, or mixtures thereof.

The reaction is preferably carried out in an inert, preferably aprotic, organic solvent. Examples of suitable solvents are in particular dichloromethane, dichloro-ethane, chlorobenzene, ethers, such as diethyl ether, diisopropyl ether, tert-butyl methyl ether, dioxane, anisole and tetrahydrofuran, nitriles, such as acetonitrile and propionitrile, and also dimethyl sulfoxide, dimethylformamide, N-methylpyrrolidone and dimethylacetamide. Preferred solvents are selected in particular from the group consisting of dimethylformamide, N-methylpyrrolidone and dimethylacetamide.

The temperatures required for the aldol condensation are generally in the range of from 0° C. to the boiling point of the solvent used and in particular in the range of from 10 to 80° C.

The aldol condensation gives an at least partially N-protected compound V. Depending on the type of the protective group Pg and depending on the chosen reaction conditions, the protective group adjacent to the newly introduced radical is cleaved off even during the aldol condensation (R═H). The removal of the (remaining) protective group(s) in step b) can be carried out analogously to standard methods of protective group chemistry, for example by the method described in Green, Wuts, Protective Groups in Organic Synthesis, 3rd ed. 1999, John Wiley and Sons, p. 553 ff.

In step c), the compound of the formula VI obtained in this manner is then reacted with an alkylating agent to introduce the radicals R⁴ and, if appropriate, R⁵. To this end, the piperazine compound of the formula VI is reacted according to customary alkylation methods as known, for example, from Heterocycles, 45, 1997, 1151 and Chem. Commun. 1998, 659, with a suitable alkylating agent of the formula X¹—R⁴ and, if appropriate, an alkylating agent X¹—R⁵. In the alkylating agents X¹—R⁴ and X¹—R⁵, X¹ may be halogen or O—SO₂—R^{m}, where R^{m} is C₁-C₄-alkyl or aryl which are optionally substituted by halogen, C₁-C₄-alkyl or halo-C₁-C₄-alkyl. In the alkylating agents X¹—R⁴ and X¹—R⁵, R⁴ and R⁵ independently of one another are methyl or methyl or ethyl. If R⁴ and R⁵ are not identical, the alkylation steps are carried out successively. If R⁴ and R⁵ are identical, the alkylation steps can be carried out simultaneously or successively in any order.

The alkylation of VI is usually carried out at temperatures in the range of from −78° C. to the boiling point of the reaction mixture, preferably from −50° C. to 65° C., particularly preferably from −30° C. to 65° C. In general, the reaction is carried out in a solvent, preferably in an inert organic solvent.

Suitable solvents are aliphatic hydrocarbons, such as pentane, hexane, cyclohexane and mixtures of C₅-C₈-alkanes, aromatic hydrocarbons, such as toluene, o-, m- and p-xylene, halogenated hydrocarbons, such as dichloromethane, dichloroethane, chloroform and chlorobenzene, ethers, such as diethyl ether, diisopropyl ether, tert-butyl methyl ether, dioxane, anisole and tetrahydrofuran, nitriles, such as acetonitrile and propionitrile, ketones, such as acetone, methyl ethyl ketone, diethyl ketone and tert-butyl methyl ketone, alcohols, such as methanol, ethanol, n-propanol, isopropanol, n-butanol, tert-butanol, water, dimethyl sulfoxide, N-methyl-pyrrolidone, dimethylformamide and dimethylacetamide, and also morpholine and N-methylmorpholine and mixtures thereof. Preferred solvents are toluene, dichloromethane, tetrahydrofuran, N-methylpyrrolidone or dimethylformamide and mixtures thereof.

In general, the alkylation of the compound VI with the alkylating agent is carried out in the presence of a base. Suitable bases are inorganic compounds, such as alkali metal and alkaline earth metal hydroxides, such as lithium hydroxide, sodium hydroxide, potassium hydroxide or calcium hydroxide, aqueous ammonia solutions, alkali metal or alkaline earth metal oxides, such as lithium oxide, sodium oxide, calcium oxide and magnesium oxide, alkali metal and alkaline earth metal hydrides, such as lithium hydride, sodium hydride, potassium hydride and calcium hydride, alkali metal amides, such as lithium amide, for example lithium diisopropylamide, sodium amide and potassium amide, alkali metal and alkaline earth metal carbonates, such as lithium carbonate, potassium carbonate, cesium carbonate and calcium carbonate, and also alkali metal bicarbonates, such as sodium bicarbonate, organometallic compounds, in particular alkali metal alkyls, such as methyllithium, butyllithium and phenyllithium, alkylmagnesium halides, such as methylmagnesium chloride, and also alkali metal and alkaline earth metal alkoxides, such as sodium methoxide, sodium ethoxide, potassium methoxide, potassium tert-butoxide, potassium tert-pentoxide and dimethoxy-magnesium, moreover organic bases, for example tertiary amines, such as trimethyl-amine, triethylamine, diisopropylethylamine, 2-hydroxypyridine and N-methylpiperidine, pyridine, substituted pyridines, such as collidine, lutidine and 4-dimethylaminopyridine, and also bicyclic amines. The bases are generally employed in equimolar amounts. They can also be used in excess or even as solvent. In a preferred embodiment, the base is added in an equimolar amount or in essentially equimolar amount. In a further preferred embodiment, the base used is sodium hydride.

If R⁶ in formula VI is hydrogen, a methyl or ethyl group as radical R⁶ may be introduced at this stage by reaction with an alkylating agent R⁶—X¹. In the alkylating agent R⁶—X¹, X¹ has one of the meanings mentioned above. R⁶ is methyl or ethyl. The alkylation can be carried out according to standard methods as described, for example, in J. Am. Chem. Soc. 105, 1983, 3214. If the radicals R⁴, R⁵ and R⁶ are identical, all 3 groups can be introduced simultaneously or successively by alkylation, where generally the piperazine nitrogens are alkylated first.

If L is a halogen atom, for example chlorine, bromine or iodine, a nitrile group may be introduced in step d). To prepare the compound I in which R¹ is CN, the compound I.a in which L is chlorine, bromine or iodine can be reacted with copper cyanide analogously to known processes (see, for example, Organikum, 21st edition, 2001, Wiley, p. 404, Tetrahedron Lett. 42, 2001, p. 7473 or Org. Lett. 5, 2003, 1785 and the literature cited therein). These reactions are usually carried out at temperatures in the range of from 100° C. to the boiling point of the reaction mixture, preferably at from 100° C. to 250° C. In general, the reaction is carried out in an inert organic solvent. Suitable solvents are in particular aprotic polar solvents, for example dimethyl formamide, N-methylpyrrolidone, N,N′-dimethylimidazolidin-2-one and dimethylacetamide.

In this manner, a compound of the formula I.a is obtained, i.e. compounds of the formula I in which R^{x} and R^{y} form a chemical bond.

The compound of the formula I.a can then be hydrogenated to the compound I.b. The hydrogenation can be carried out analogously to known processes for reducing C═C double bonds (see, for example, J. March, Advanced Organic Chemistry, 3rd ed. John Wiley & Sons 1985, pp. 690-700, see also Peptide Chemistry 17, 1980, pp. 59-64, Tetrahedron Lett. 46, 1979, pp. 4483-4486). Frequently, the hydrogenation is carried out by reaction with hydrogen in the presence of transition metal catalysts, for example catalysts containing Pt, Pd, Rh or Ru as active metal species. Suitable are both heterogeneous catalysts, such as supported Pd or Pt catalysts, for example Pd on activated carbon, furthermore PtO₂, and also homogeneous catalysts. The use of stereoselective catalysts allows enantioselective hydrogenation of the double bond (see Peptide Chemistry 17, 1980, pp. 59-64, Tetrahedron Lett. 46, 1979, pp. 4483-4486).

The hydrogenation of I.a can be carried out either after the alkylation of VI, i.e. after step c) or d), or prior to the alkylation, i.e. after step b).

The aldehyde III is either commercially available or can be synthesized according to known processes for preparing aldehydes.

The compounds of the formula IV can be prepared by intramolecular cyclization of compounds of the general formula VII and subsequent introduction of protective groups Pg into the resulting compound VIII.

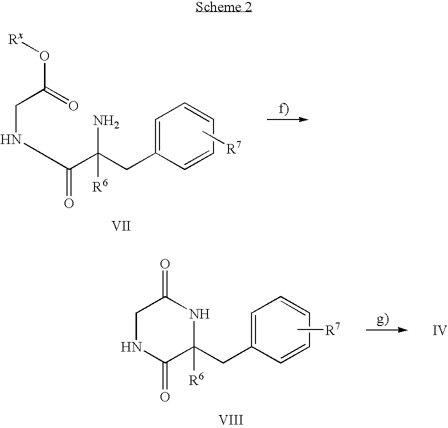

In scheme 2, the variables R⁶ and R⁷ have the meanings mentioned above. Here, R^{x} is, for example, C₁-C₆-alkyl, in particular methyl or ethyl, or phenyl-C₁-C₆-alkyl, for example benzyl.

The cyclization of VII in step f) can be carried out analogously to further processes known from the literature, for example according to T. Kawasaki et al., Org. Lett. 2 (19) (2000), 3027-3029, Igor L. Rodionov et al., Tetrahedron 58 (42) (2002), 8515-8523 or A. L. Johnson et al., Tetrahedron 60 (2004), 961-965. For further details, reference is made to the methods described in PCT/EP2006/070271 (WO 2007/077201) and PCT/EP2007/050067 (WO 2007/077247) and to the examples.

In step g), suitable protective groups Pg are then introduced into the compound VIII. The introduction of the protective groups into the compound VIII can be carried out analogously to known processes of protective group chemistry, for example by reacting the corresponding compound VIII having free NH groups with anhydrides of the formula (R⁵²C(O))₂O, in which R52 is C₁-C₄-alkyl, for example methyl for example according to the method described in Green, Wuts, Protective Groups in Organic Synthesis, 3rd ed. 1999, John Wiley and Sons, p. 553.

For their part, the compounds of the formula VII are known and can be prepared by coupling glycine esters or hydrochlorides thereof with suitable phenylalanine compounds analogously to processes known from the literature, for example according to Wilford L. Mendelson et al., Int. J. Peptide & Protein Research 35 (3), (1990), 249-57, Glenn L. Stahl et al., J. Org. Chem. 43 (11), (1978), 2285-6 or A. K. Ghosh et al., Org. Lett. 3 (4), (2001), 635-638. For further details, reference is made to the methods described in PCT/EP2006/070271 (WO 2007/077201) and PCT/EP2007/050067 (WO 2007/077247) and to the examples.

According to a first embodiment of the invention, the compositions comprise at least one lipid biosynthesis inhibitor (herbicide b1). These are compounds which inhibit lipid biosynthesis. This inhibition may be based on an inhibition of acetyl CoA carboxylase (also referred to hereinbelow as ACC herbicides) or on another mechanism (also referred to hereinbelow as non-ACC herbicides). The ACC herbicides belong to group A of the HRAC classification, whereas the non-ACC herbicides belong to group N of the HRAC classification.

According to a second embodiment of the invention, the compositions comprise at least one ALS inhibitor (herbicide b2). These are compounds whose herbicidal action as based on the inhibition of acetolactate synthase and thus on the inhibition of the biosynthesis of branched amino acids. Such inhibitors belong to group B of the HRAC classification.

According to a third embodiment of the invention, the compositions comprise at least one photosynthesis inhibitor (herbicide b3). These are compounds whose herbicidal action is based on the inhibition of photosystem II in plants (PSII inhibitors, groups C1, C2 and C3 of the HRAC classification) or on the hindrance of electron transfer in photosystem I of the plants (PSI inhibitors, group D of the HRAC classification) and thus on an inhibition or interference in the photosynthesis. Among these, PSII inhibitors are preferred.

According to a fourth embodiment of the invention, the compositions comprise at least one protoporphyrinogen IX oxidase inhibitor (herbicide b4). These are compounds whose herbicidal action is based on the inhibition of protoporphyrinogen IX oxidase. Such inhibitors belong to group E of the HRAC classification.

According to a fifth embodiment of the invention, the compositions comprise at least one bleacher herbicide (herbicide b5). These are compounds whose herbicidal action is based on the inhibition of or interference in the carotinoid biosynthesis. These include compounds which prevent carotinoid biosynthesis by inhibiting phytoene desaturase (PDS inhibitors, class F1 of the HRAC classification), compounds which inhibit 4-hydroxyphenylpyruvate dioxygenase (HPPD inhibitors, class F2 of the HRAC classification), and also compounds which inhibit the carotinoid biosynthesis in an as yet unexplained manner (bleachers—unknown target, class F3 of the HRAC classification).

According to a sixth embodiment of the invention, the compositions comprise at least one EPSP synthase inhibitor (herbicide b6). These are compounds whose herbicidal action is based on the inhibition of enolpyruvyl shikimate-3-phosphate synthase and thus on the inhibition of the biosynthesis of amino acids in plants. Such inhibitors belong to group G of the HRAC classification.

According to a seventh embodiment of the invention, the compositions comprise at least one glutamine synthetase inhibitor (herbizide b7). These are compounds whose herbicidal action is based on the inhibition of glutamine synthetase and thus likewise on the inhibition of the biosynthesis of amino acids and plants. Such inhibitors belong to group H of the HRAC classification.

According to an eighth embodiment of the invention, the compositions comprise at least one DHP synthase inhibitor (herbizide b8). These are compounds whose herbidical action is based on the inhibition of 7,8-dihydropteroate synthase. Such inhibitors belong to group I of the HRAC classification.

According to a ninth embodiment of the invention, the compositions comprise at least one mitosis inhibitor (herbicide b9). These are compounds whose herbicidal action is based on the interference in or inhibition of the production or organization of microtubuli and thus inhibits mitosis. Such inhibitors belong to groups K1 and K2 of the HRAC classification. Among these, compounds of group K1, in particular dinitroanilines, are preferred.

According to a tenth embodiment of the invention, the compositions comprise at least one VLCFA inhibitor (herbizide b10). These are compounds whose herbicidal action is based on the inhibition of the synthesis of long-chain fatty acids and thus on the interference in or inhibition of cell division in plants. Such inhibitors belong to group K3 of the HRAC classification.

According to an eleventh embodiment of the invention, the compositions comprise at least one cellulose biosynthesis inhibitor (herbicide b11). These are compounds whose herbicidal action is based on the inhibition of the biosynthesis of cellulose and thus the formation of cell walls in plants. Such inhibitors belong to group L of the HRAC classification.

According to a twelfth embodiment of the invention, the compositions comprise at least one decoupler herbicide (herbicide b12). These are compounds whose herbicidal action is based on the destruction of the cell membrane. Such inhibitors belong to group M of the HRAC classification.

According to a thirteenth embodiment of the invention, the compositions comprise at least one auxin herbicide (herbicide b13). These are compounds which act like auxins, i.e. phytohormones, in plants, and inhibit the growth of the plants. Such compounds belong to group O of the HRAC classification.

According to a fourteenth embodiment of the invention, the compositions comprise at least one auxin transport inhibitor (herbicide b14). These are compounds whose herbicidal action is based on the inhibition of auxin transport in plants. Such compounds belong to group P of the HRAC classification.

For the stated mechanisms of action and the classification of the active compounds, see, for example, “HRAC, Classification of Herbicides According to Mode of Action”, http://www.plantprotection.org/hrac/MOA.html).

From among the compositions according to the invention, preference is given to those which comprise at least one herbicide B selected from the herbicides of classes b1), b2), b3), b4), b5), b9), b10, b11) and b13).

A particularly preferred embodiment of the invention relates to compositions comprising at least one herbicide B selected from the herbicides of class b10.

Examples of herbicides B which can be used in combination with the piperazinedione compounds of the formula I according to the present invention are:

b1) from the group of the lipid biosynthesis inhibitors:

ACC herbicides such as alloxydim, alloxydim-sodium, butroxydim, clethodim, clodinafop, clodinafop-propargyl, cycloxydim, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, pinoxaden, profoxydim, propaquizafop, quizalofop, quizalofop-ethyl, quizalofop-tefuryl, quizalofop-P, quizalofop-P-ethyl, quizalofop-P-tefuryl, sethoxydim, tepraloxydim and tralkoxydim, as well as non ACC herbicides such as benfuresate, butylate, cycloate, dalapon, dimepiperate, EPIC, esprocarb, ethofumesate, flupropanate, molinate, orbencarb, pebulate, prosulfocarb, TCA, thiobencarb, tiocarbazil, triallate and vernolate;

b2) from the group of the ALS inhibitors:

sulfonylureas such as amidosulfuron, azimsulfuron, bensulfuron, bensulfuron-methyl, chlorimuron, chlorimuron-ethyl, chlorsulfuron, cinosulfuron, cyclosulfamuron, ethametsulfuron, ethametsulfuron-methyl, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, iodosulfuron, iodosulfuron-methyl-sodium, mesosulfuron, metsulfuron, metsulfuron-methyl, nicosulfuron, orthosulfamuron, oxasulfuron, primisulfuron, primisulfuron-methyl, prosulfuron, pyrazosulfuron, pyrazosulfuron-ethyl, rimsulfuron, sulfometuron, sulfometuron-methyl, sulfosulfuron, thifensulfuron, thifensulfuron-methyl, triasulfuron, tribenuron, tribenuron-methyl, trifloxysulfuron, triflusulfuron, triflusulfuron-methyl and tritosulfuron; imidazolinones such as imazamethabenz, imazamethabenz-methyl, imazamox, imazapic, imazapyr, imazaquin and imazethapyr, triazolopyrimidine herbicides and sulfonanilides such as cloransulam, cloransulam-methyl, diclosulam, flumetsulam, florasulam, metosulam, penoxsulam, pyrimisulfan and pyroxsulam,
pyrimdinylbenzoates such as bispyribac, bispyribac-sodium, pyribenzoxim, pyriftalid, pyriminobac, pyriminobac-methyl, pyrithiobac, pyrithiobac-sodium, and also sulfonylaminocarbonyltriazolinone herbicides such as flucarbazone, flucarbazone-sodium, propoxycarbazone, propoxycarbazone-sodium, thiencarbazone and thiencarbazone-methyl. Among these, compositions comprising at least one imidazolinone herbicide represent a preferred embodiment of the invention;

b3) from the group of the photosynthesis inhibitors:

amicarbazone, photosystem II inhibitors, for example, triazine herbicides, including chlorotriazines, triazinones, triazinediones, methylthiotriazines and pyridazinones such as ametryn, atrazine, chloridazone, cyanazine, desmetryn, dimethametryn, hexazinone, metribuzin, prometon, prometryn, propazine, simazine, simetryn, terbumeton, terbuthylazine, terbutryn and trietazine;
arylureas such as chlorobromuron, chlorotoluron, chloroxuron, dimefuron, diuron, fluometuron, isoproturon, isouron, linuron, metamitron, methabenzthiazuron, metobenzuron, metoxuron, monolinuron, neburon, siduron, tebuthiuron and thidiazuron,
phenyl carbamates such as desmedipham, karbutilate, phenmedipham, phenmedipham-ethyl,
nitrile herbicides such as bromofenoxim, bromoxynil and its salts and esters, ioxynil and its salts and esters,
uracils such as bromacil, lenacil and terbacil,
as well as bentazone and bentazone-sodium, pyridate, pyridafol, pentanochlor and propanil,
and photosystems I inhibitors such as diquat, diquat-dibromide, paraquat, paraquat-dichloride and paraquat-dimetilsulfate.

From among these, compositions comprising at least one arylurea herbicide constitute a preferred embodiment of the invention. From among these, compositions comprising at least one triazine herbicide also constitute a preferred embodiment of the invention. From among these, compositions comprising at least one nitrile herbicide furthermore constitute a preferred embodiment of the invention.

b4) from the group of the protoporphyrinogen-IX oxidase inhibitors: acifluorfen, acifluorfen-sodium, azafenidin, bencarbazone, benzfendizone, bifenox, butafenacil, carfentrazone, carfentrazone-ethyl, chlomethoxyfen, cinidon-ethyl, fluazolate, flufenpyr, flufenpyr-ethyl, flumiclorac, flumiclorac-pentyl, flumioxazin, fluoroglycofen, fluoroglycofen-ethyl, fluthiacet, fluthiacet-methyl, fomesafen, halosafen, lactofen, oxadiargyl, oxadiazon, oxyfluorfen, pentoxazone, profluazol, pyraclonil, pyraflufen, pyraflufen-ethyl, sulfentrazone, thidiazimin, 2-chloro-5-[3,6-dihydro-3-methyl-2,6-dioxo-4-(trifluoromethyl)-1(2H)-pyrimidinyl]-4-fluoro-N-[(isopropyl)-methylsulfamoyl]benzamide (CAS 372137-35-4), ethyl[3-[2-chloro-4-fluoro-5-(1-methyl-6-trifluoromethyl-2,4-dioxo-1,2,3,4,-tetrahydropyrimidin-3-yl)phenoxy]-2-pyridyloxy]acetate (CAS 353292-31-6), N-ethyl-3-(2,6-dichloro-4-trifluoro-methylphenoxy)-5-methyl-1H-pyrazole-1-carboxamide (CAS 452098-92-9), N-tetrahydrofurfuryl-3-(2,6-dichloro-4-trifluoromethylphenoxy)-5-methyl-1H-pyrazole-1-carboxamide (CAS 915396-43-9), N-ethyl-3-(2-chloro-6-fluoro-4-trifluoromethyl-phenoxy)-5-methyl-1H-pyrazole-1-carboxamide (CAS 452099-05-7) and N-tetrahydro-furfuryl-3-(2-chloro-6-fluoro-4-trifluoromethylphenoxy)-5-methyl-1H-pyrazole-1-carboxamide (CAS 45100-03-7);

b5) from the group of the bleacher herbicides:

PDS-inhibitors: beflubutamid, diflufenican, fluridone, fluorochloridone, flurtamone, norflurazon, picolinafen and 4-(3-trifluoromethylphenoxy)-2-(4-trifluoromethylphenyl)pyrimidine (CAS 180608-33-7), HPPD-inhibitors: benzo-bicyclon, benzocenap, isoxaflutole, mesotrione, pyrasulfotole, pyrazolynate, pyrazoxyfen, sulcotrione, tefuryltrione, tembotrione, topramezone, 4-hydroxy-3-[[2-[(2-methoxyethoxy)methyl]-6-(trifluoromethyl)-3-pyridyl]carbonyl]bicyclo[3.2.1]oct-3-en-2-one (CAS 352010-68-5),
bleachers, unknown target: aclonifen, amitrol and clomazone;

b6) from the group of the EPSP synthase inhibitors:

glyphosate, glyphosate-isopropylammonium and glyphosate-trimesium (sulfosate);

b7) from the group of the glutamine synthase inhibitors:

bilanaphos (bialaphos), bilanaphos-sodium, glufosinate and glufosinate-ammonium;

b8) from the group of the DHP synthase inhibitors:

asulam;

b9) from the group of the mitosis inhibitors:

compounds of group K1: dinitroanilines, such as benfluralin, butralin, dinitramine, ethalfluralin, fluchloralin, oryzalin, pendimethalin, prodiamine and trifluralin, phosphoramidates, such as amiprophos, amiprophos-methyl and butamiphos, benzoic acids, such as chlorthal, chlorthal-dimethyl, pyridines, such as dithiopyr and thiazopyr, benzamides, such as propyzamide and tebutam,
compounds of group K2: chlorpropham, propham and carbetamide.
From among these, compounds of group K1 and in particular dinitroanilines are preferred;

b10) from the group of the VLCFA inhibitors:

chloroacetamides such as acetochlor, alachlor, butachlor, dimethachlor, dimethanamid, dimethenamid-P, metazachlor, metolachlor, metolachlor-S, pethoxamid, pretilachlor, propachlor, propisochlor and thenylchlor;

Oxyacetanilides, such as flufenacet and mefenacet, acetanilides, such as diphenamid, naproanilide and napropamide, tetrazolinones, such as fentrazamide, and

others, such as anilofos, cafenstrol, piperophos, pyroxasulfone and also isoxazoline compounds, different from pyroxasulfone, of the formula II

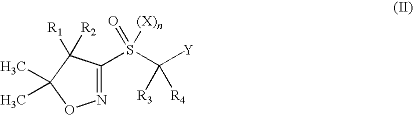

in which R₁, R₂, R₃, R₄, X, Y and n have the meanings below:
R₁, R₂, R₃, R₄ are each independently of one another hydrogen, halogen or C₁-C₄-alkyl;
Y is phenyl or monocyclic 5-, 6-, 7-, 8-, 9- or 10-membered heterocyclyl which, in addition to carbon ring members, contains one, two or three identical or different heteroatoms selected form the group consisting of oxygen, sulfur and nitrogen as ring members, where phenyl and heterocyclyl are unsubstituted or carry 1, 2 or 3 substitutes R^{yy} selected from the group consisting of halogen, C₁-C₄-alkyl, C₁-C₄-alkoxy, C₁-C₄-haloalkyl and C₁-C₄-haloalkoxy, preferably phenyl or 5- or 6-membered aromatic heterocyclyl (hetaryl) which, in addition to carbon ring members, contains 1, 2 or 3 nitrogen atoms as ring members, where phenyl and hetaryl are unsubstituted or carry 1, 2 or 3 substituents R^{yy},
X is oxygen or NH; and
n is zero or one.

From among the isoxazoline compounds of the formula II, preference is given to the isoxazoline compounds of the formula II in which
R₁, R₂, R₃, R₄ each independently of one another are H, F, Cl or methyl;
X is oxygen;
n is 0 or 1; and
Y is phenyl, pyrazolyl or 1,2,3-triazolyl, where the three last-mentioned radicals are unsubstituted or carry one, two or three substituents R^{yy}, specifically one of the radicals below:

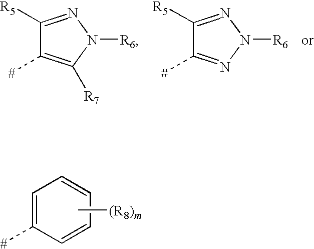

in which

R₅ is halogen, C₁-C₄-alkyl or C₁-C₄-haloalkyl;

R₆ is C₁-C₄-alkyl;

R₇ is halogen, C₁-C₄-alkoxy or C₁-C₄-haloalkoxy;

R₃ is halogen, C₁-C₄-alkyl, C₁-C₄-haloalkyl or C₁-C₄-haloalkoxy;

m is 0, 1, 2 or 3; and

# denotes the point of attachment to group CR₃R₄.

From among these, very particular preference is given to isoxazoline compounds of the formula II in which

R₁ is hydrogen;
R₂ is fluorine;
R₃ is hydrogen or fluorine;
R₄ is hydrogen or fluorine;
X is oxygen;
n is zero or 1, in particular 1; and
Y is one of the radicals of the formulae Y₁, Y₂, Y₃ and Y₄,

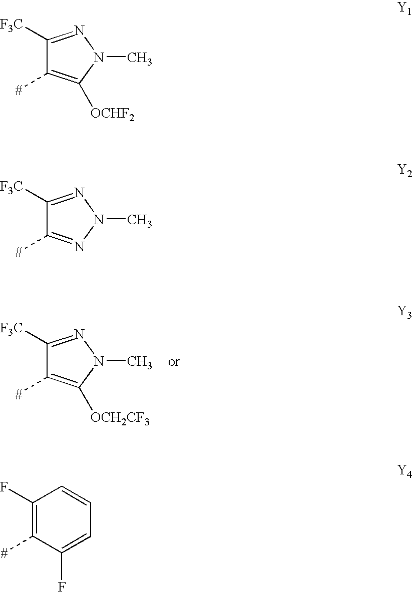

in which # denotes the point of attachment to group CR₃R₄.

From among these, the isoxazoline compounds of the formulae II.1, II.2, II.3, II.4, II.5, II.6, II.7, II.8 and II.9 are especially preferred.

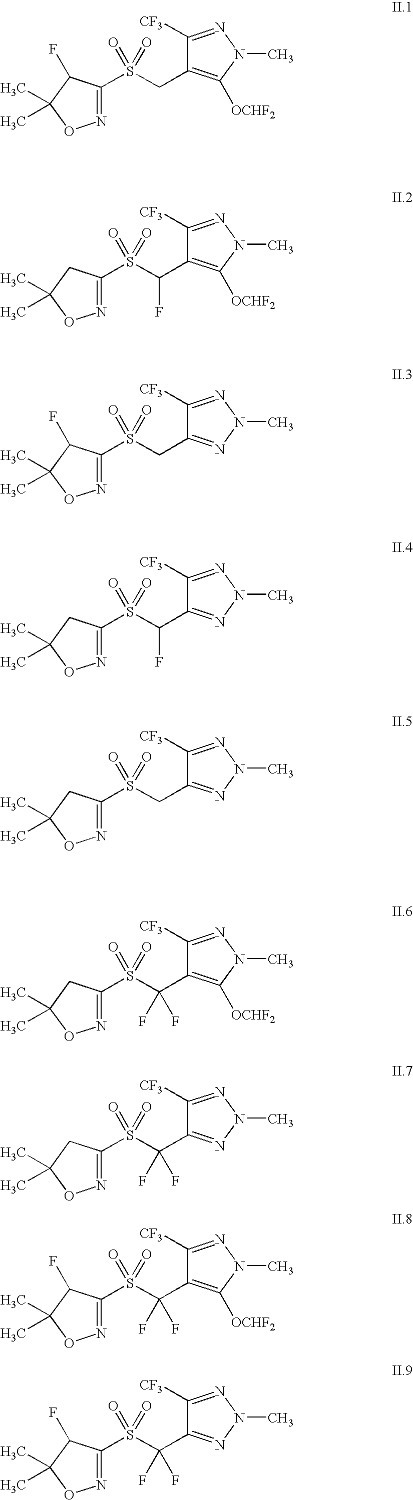

The isoxazoline compounds of the formula II are known from the literature, for example from WO 2006/024820, WO 2006/037945, WO 2007/071900 and WO 2007/096576. From among the VLCFA inhibitors, preference is given to chloroacetamides, oxyacetamides and pyroxasulfone;

b11) from the group of the cellulose biosynthesis inhibitors:

chlorthiamid, dichlobenil, flupoxam and isoxaben;

b12) from the group of the decoupler herbicides:

dinoseb, dinoterb and DNOC and its salts;

b13) from the group of the auxin herbicides:

2,4-D and its salts and esters, 2,4-DB and its salts and esters, aminopyralid and its salts such as aminopyralid-tris(2-hydroxypropyl)ammonium and its esters, benazolin, benazolin-ethyl, chioramben and its salts and esters, clomeprop, clopyralid and its salts and esters, dicamba and its salts and esters, dichlorprop and its salts and esters, dichlorprop-P and its salts and esters, fluoroxypyr, fluoroxypyr-butomethyl, fluoroxypyr-meptyl, MCPA and its salts and esters, MCPA-thioethyl, MCPB and its salts and esters, mecoprop and its salts and esters, mecoprop-P and its salts and esters, picloram and its salts and esters, quinclorac, quinmerac, TBA (2,3,6) and its salts and esters, triclopyr and its salts and esters, and 5,6-dichloro-2-cyclopropyl-4-pyrimidinecarboxylic acid (CAS 858956-08-8) and its salts and esters;

b14) from the group of the auxin transport inhibitors: diflufenzopyr, diflufenzopyr-sodium, naptalam and naptalam-sodium;

b15) from the group of the other herbicides: bromobutide, chlorflurenol, chlorflurenol-methyl, cinmethylin, cumyluron, dalapon, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-M-methyl, flurenol, flurenol-butyl, flurprimidol, fosamine, fosamine-ammonium, indanofan, maleic hydrazide, mefluidide, metam, methyl azide, methyl bromide, methyl-dymron, methyl iodide, MSMA, oleic acid, oxaziclomefone, pelargonic acid, pyributicarb, quinoclamine, triaziflam, tridiphane and 6-chloro-3-(2-cyclopropyl-6-methylphenoxy)-4-pyridazinol (CAS 499223-49-3) and its salts and esters.

Preferred herbicides B which can be used in combination with the piperazinedione compounds of the formula I according to the present invention are:

b1) from the group of the lipid biosynthesis inhibitors:

clethodim, clodinafop-propargyl, cycloxydim, cyhalofop-butyl, diclofop-methyl, fenoxaprop-P-ethyl, fluazifop-P-butyl, haloxyfop-P-methyl, metamifop, pinoxaden, profoxydim, propaquizafop, quizalofop-P-ethyl, quizalofop-P-tefuryl, sethoxydim, tepraloxydim, tralkoxydim, benfuresate, dimepiperate, EPTC, esprocarb, ethofumesate, molinate, orbencarb, prosulfocarb, thiobencarb and triallate;

b2) from the group of the ALS inhibitors:

amidosulfuron, azimsulfuron, bensulfuron-methyl, bispyribac-sodium, chlorimuron-ethyl, chlorsulfuron, cloransulam-methyl, cyclosulfamuron, diclosulam, ethametsulfuron-methyl, ethoxysulfuron, flazasulfuron, florasulam, flucarbazone-sodium, flucetosulfuron, flumetsulam, flupyrsulfuron-methyl-sodium, foramsulfuron, halosulfuron-methyl, imazamethabenz-methyl, imazamox, imazapic, imazapyr, imazaquin, imazethapyr, imazosulfuron, iodosulfuron, iodosulfuron-methyl-sodium, mesosulfuron, metosulam, metsulfuron-methyl, nicosulfuron, orthosulfamuron, oxasulfuron, penoxsulam, primisulfuron-methyl, propoxycarbazon-sodium, prosulfuron, pyrazosulfuron-ethyl, pyribenzoxim, pyrimisulfan, pyriftalid, pyriminobac-methyl, pyrithiobac-sodium, pyroxsulam, rimsulfuron, sulfometuron-methyl, sulfosulfuron, thiencarbazone-methyl, thifensulfuron-methyl, triasulfuron, tribenuron-methyl, trifloxysulfuron, triflusulfuron-methyl and tritosulfuron;

b3) from the group of the photosynthesis inhibitors:

amicarbazone, atrazine, bentazone, bentazone-sodium, bromoxynil and its salts and esters, chloridazone, chlorotoluron, cyanazine, desmedipham, diquat-dibromide, diuron, fluometuron, hexazinone, ioxynil and its salts and esters, isoproturon, lenacil, linuron, metamitron, methabenzthiazuron, metribuzin, paraquat, paraquat-dichloride, phenmedipham, propanil, pyridate, simazine, terbuthylazine and thidiazuron;

b4) from the group of the protoporphyrinogen-IX oxidase inhibitors:

acifluorfen-sodium, bencarbazone, benzfendizone, butafenacil, carfentrazone-ethyl, cinidon-ethyl, flufenpyr-ethyl, flumiclorac-pentyl, flumioxazin, fluoroglycofen-ethyl, fomesafen, lactofen, oxadiargyl, oxadiazon, oxyfluorfen, pentoxazone, pyraflufen-ethyl, sulfentrazone, 2-chloro-5-[3,6-dihydro-3-methyl-2,6-dioxo-4-(trifluoromethyl)-1(2H)-pyrimidinyl]-4-fluoro-N-[(isopropyl)methylsulfamoyl]benzamide (CAS 372137-35-4), ethyl[3-[2-chloro-4-fluoro-5-(1-methyl-6-trifluoromethyl-2,4-dioxo-1,2,3,4,-tetrahydropyrimidin-3-yl)phenoxy]-2-pyridyloxy]acetate (CAS 353292-31-6), N-ethyl-3-(2,6-dichloro-4-trifluoromethylphenoxy)-5-methyl-1H-pyrazole-1-carboxamide (CAS 452098-92-9), N-tetrahydrofurfuryl-3-(2,6-dichloro-4-trifluoromethylphenoxy)-5-methyl-1H-pyrazole-1-carboxamide (CAS 915396-43-9), N-ethyl-3-(2-chloro-6-fluoro-4-trifluoro-methylphenoxy)-5-methyl-1H-pyrazole-1-carboxamide (CAS 452099-05-7) and N-tetrahydrofurfuryl-3-(2-chloro-6-fluoro-4-trifluoromethylphenoxy)-5-methyl-1H-pyrazole-1-carboxamide (CAS 45100-03-7);

b5) from the group of the bleacher herbicides:

aclonifen, beflubutamid, benzobicyclon, clomazone, diflufenican, fluorochloridone, flurtamone, isoxaflutole, mesotrione, norflurazon, picolinafen, pyrasulfutole, pyrazolynate, sulcotrione, tefuryltrione, tembotrione, topramezone, 4-hydroxy-3-[[2-[(2-methoxyethoxy)methyl]-6-(trifluoromethyl)-3-pyridyl]carbonyl]bicyclo[3.2.1]oct-3-en-2-one (CAS 352010-68-5) and 4-(3-trifluoromethylphenoxy)-2-(4-trifluoromethylphenyl)-pyrimidine (CAS 180608-33-7);

b6) from the group of the EPSP synthase inhibitors:

glyphosate, glyphosate-isopropylammonium and glyphosate-trimesium (sulfosate);

b7) from the group of the glutamine synthase inhibitors:

glufosinate, glufosinate-ammonium;

b8) from the group of the DHP synthase inhibitors: asulam;

b9) from the group of the mitose inhibitors:

benfluralin, dithiopyr, ethalfluralin, oryzalin, pendimethalin, thiazopyr and trifluralin;

b10) from the group of the VLCFA inhibitors:

acetochlor, alachlor, anilofos, butachlor, cafenstrole, dimethenamid, dimethenamid-P, fentrazamide, flufenacet, mefenacet, metazachlor, metolachlor, S-metolachlor, naproanilide, napropamide, pretilachlor, pyroxasulfone, thenylchlor and isoxazoline compounds of the formulae II.1, II.2, II.3, II.4, II.5, II.6, II.7, II.8 and II.9.

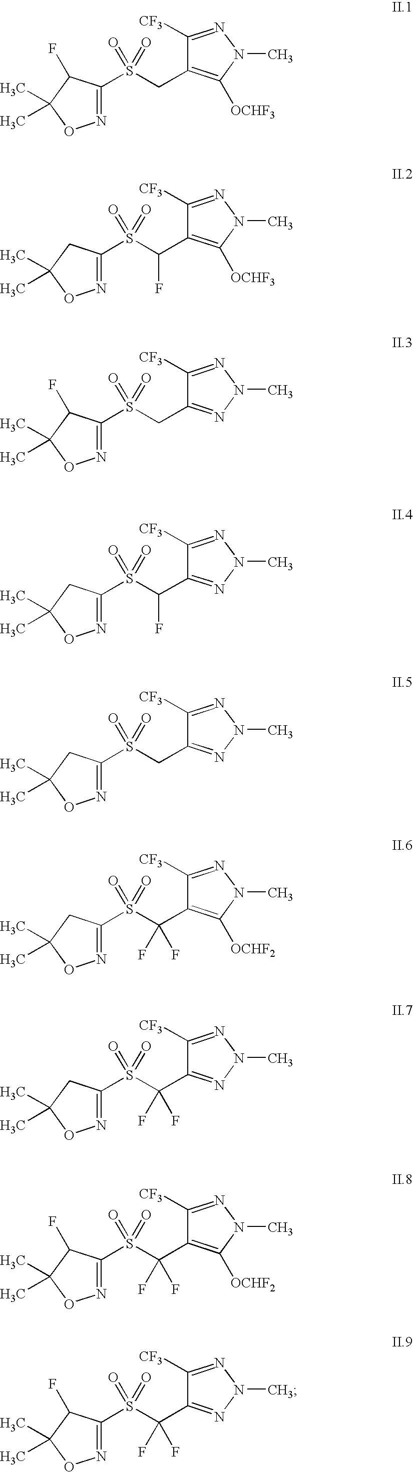

b11) from the group of the cellulose biosynthesis inhibitors: dichlobenil, isoxaben, flupoxam;

b13) from the group of the auxin herbicides:

2,4-D and its salts and esters, aminopyralid and its salts such as aminopyralid-tris(2-hydroxypropyl)ammonium and its esters, clopyralid and its salts and esters, dicamba and its salts and esters, dichlorprop-P and its salts and esters, fluoroxypyr-meptyl, MCPA and its salts and esters, MCPB and its salts and esters, mecoprop-P and its salts and esters, picloram and its salts and esters, quinclorac, quinmerac, triclopyr and its salts and esters, and 5,6-dichloro-2-cyclopropyl-4-pyrimidinecarboxylic acid (CAS 858956-08-8) and its salts and esters;

b14) from the group of the auxin transport inhibitors: diflufenzopyr and diflufenzopyr-sodium;

b15) from the group of the other herbicides: bromobutide, cinmethylin, cumyluron, dalapon, difenzoquat, difenzoquat-metilsulfate, DSMA, dymron (=daimuron), flamprop, flamprop-isopropyl, flamprop-methyl-, flamprop-M-isopropyl, flamprop-M-methyl, indanofan, metam, methylbromide, MSMA, oxaziclomefone, pyributicarb, triaziflam, tridiphane and 6-chloro-3-(2-cyclopropyl-6-methylphenoxy)-4-pyridazinol (CAS 499223-49-3) and its salts and esters.

Particularly preferred herbicides B which can be used in combination with the piperazinedione compounds of the formula I according to the present invention are:

b1) from the group of the lipid biosynthesis inhibitors: clodinafop-propargyl, cycloxydim, cyhalofop-butyl, fenoxaprop-P-ethyl, pinoxaden, profoxydim, tepraloxydim, tralkoxydim, esprocarb, prosulfocarb, thiobencarb and triallate;

b2) from the group of the ALS inhibitors: bensulfuron-methyl, bispyribac-sodium, cyclosulfamuron, flumetsulam, flupyrsulfuron-methyl-sodium, foramsulfuron, imazamox, imazapic, imazapyr, imazaquin, imazethapyr, imazosulfuron, iodosulfuron, iodosulfuron-methyl-sodium, mesosulfuron, nicosulfuron, penoxsulam, propoxycarbazon-sodium, pyrazosulfuron-ethyl, pyroxsulam, rimsulfuron, sulfosulfuron, thiencarbazon-methyl and tritosulfuron;

b3) from the group of the photosynthesis inhibitors: atrazine, diuron, fluometuron, hexazinone, isoproturon, metribuzin, paraquat, paraquat-dichloride, propanil and terbuthylazine;

b4) from the group of the protoporphyrinogen-IX oxidase inhibitors: flumioxazin, oxyfluorfen, sulfentrazone, 2-chloro-5-[3,6-dihydro-3-methyl-2,6-dioxo-4-(trifluoromethyl)-1(2H)-pyrimidinyl]-4-fluoro-N-[(isopropyl)methylsulfamoyl]benzamide (CAS 372137-35-4) and ethyl[3-[2-chloro-4-fluoro-5-(1-methyl-6-trifluoromethyl-2,4-dioxo-1,2,3,4,-tetrahydropyrimidin-3-yl)phenoxy]-2-pyridyloxy]acetate (CAS 353292-31-6);

b5) from the group of the bleacher herbicides: clomazone, diflufenican, fluorochloridone, isoxaflutole, mesotrione, picolinafen, sulcotrione, tefuryltrione, tembotrione, topramezone and 4-hydroxy-3-[[2-[(2-methoxyethoxy)methyl]-6-(trifluoromethyl)-3-pyridyl]carbonyl]bicyclo[3.2.1]oct-3-en-2-one (CAS 352010-68-5);

b6) from the group of the EPSP synthase inhibitors: glyphosate, glyphosate-isopropylammonium and glyphosate-trimesium (sulfosate);

b7) from the group of the glutamine synthase inhibitors: glufosinate, glufosinate-ammonium;

b9) from the group of the mitose inhibitors: pendimethalin and trifluralin;

b10) from the group of the VLCFA inhibitors: acetochlor, cafenstrole, dimethenamid-P, fentrazamide, flufenacet, mefenacet, metazachlor, S-metolachlor and pyroxasulfone. Also preferred are isoxazoline compounds of the formulae 11.1, 11.2, 11.3, 11.4, 11.5, 11.6, 11.7, 11.8 and 11.9.

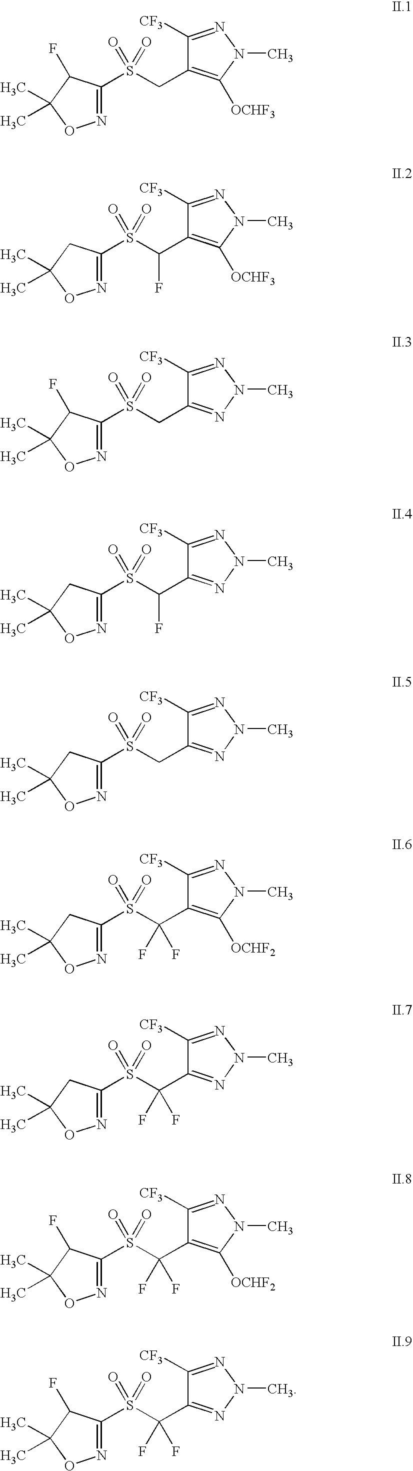

b11) from the group of the cellulose biosynthesis inhibitors: isoxaben;

b13) from the group of the auxin herbicides: 2,4-D and its salts and esters, aminopyralid and its salts and its esters, clopyralid and its salts and esters, dicamba and its salts and esters, fluoroxypyr-meptyl, quinclorac, quinmerac and 5,6-dichloro-2-cyclopropyl-4-pyrimidinecarboxylic acid (CAS 858956-08-8) and its salts and esters;

b14) from the group of the auxin transport inhibitors: diflufenzopyr and diflufenzopyr-sodium,

b15) from the group of the other herbicides: dymron (=daimuron), indanofan, oxaziclomefone and triaziflam.

Examples of preferred safeners C are benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, MON4660 [CAS RN 71526-07-3], naphthalic anhydride, oxabetrinil, 4-(dichloroacetyl)-1-oxa-4-azaspiro[4.5]decane (MON4660, CAS 71526-07-3) and 2,2,5-trimethyl-3-(dichloroacetyl)-1,3-oxazolidine (R-29148, CAS 52836-31-4).

Preferred safeners C are benoxacor, cloquintocet, cyprosulfamide, dichlormid, fenchlorazole, fenclorim, flurazole, fluxofenim, isoxadifen, mefenpyr, MON4660 [CAS RN 71526-07-3], naphthalic anhydride, oxabetrinil, 4-(dichloroacetyl)-1-oxa-4-azaspiro-[4.5]decane (MON4660, CAS 71526-07-3) and 2,2,5-trimethyl-3-(dichloroacetyl)-1,3-oxazolidine (R-29148, CAS 52836-31-4).

Particularly preferred safeners C are benoxacor, cloquintocet, cyprosulfamide, dichlormid, fenchlorazole, isoxadifen, mefenpyr, 4-(dichloroacetyl)-1-oxa-4-azaspiro-[4.5]decane (MON4660, CAS 71526-07-3) and 2,2,5-trimethyl-3-(dichloroacetyl)-1,3-oxazolidine (R-29148, CAS 52836-31-4).

The active compounds B of groups b1) to b15) and the active compounds C are known herbicides and safeners, see, for example, The Compendium of Pesticide Common Names (http://www.alanwood.net/pesticides/); Farm Chemicals Handbook 2000 volume 86, Meister Publishing Company, 2000; B. Hock, C. Fedtke, R. R. Schmidt, Herbizide [Herbicides], Georg Thieme Verlag, Stuttgart 1995; W. H. Ahrens, Herbicide Handbook, 7th edition, Weed Science Society of America, 1994; and K. K. Hatzios, Herbicide Handbook, Supplement for the 7th edition, Weed Science Society of America, 1998. 2,2,5-Trimethyl-3-(dichloroacetyl)-1,3-oxazolidine [CAS No. 52836-31-4] is also referred to as R-29148. 4-(Dichloroacetyl)-1-oxa-4-azaspiro[4.5]decane [CAS No. 71526-07-3] is also referred to as AD-67 and MON 4660. Further herbicidally active compounds are known from WO 96/26202, WO 97/41116, WO 97/41117, WO 97/41118 and WO 01/83459 and also from W. Krämer et al. (ed.) “Modern Crop Protection Compounds”, Vol. 1, Wiley VCH, 2007 and the literature cited therein.

The assignment of the active compounds to the respective mechanisms of action is based on current knowledge. If several mechanisms of action apply to one active compound, this substance was only assigned to one mechanism of action.

If the herbicides B and/or the safener C are capable of forming geometrical isomers, for example E/Z isomers, both the pure isomers and mixtures thereof may be used in the compositions according to the invention. If the herbicides B and/or the safener C have one of more centers of chirality and are thus present as enantiomers or diastereomers, both the pure enantiomers and diastereomers and mixtures thereof may be used in the compositions according to the invention.

If the herbicides B and/or the safener C have ionizable functional groups, they can also be employed in the form of their agriculturally acceptable salts. Suitable are, in general, the salts of those cations and the acid addition salts of those acids whose cations and anions, respectively, have no adverse effect on the activity of the active compounds.

Preferred cations are the ions of the alkali metals, preferably of lithium, sodium and potassium, of the alkaline earth metals, preferably of calcium and magnesium, and of the transition metals, preferably of manganese, copper, zinc and iron, further ammonium and substituted ammonium in which one to four hydrogen atoms are replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, methylammonium, isopropylammonium, dimethylammonium, diisopropylammonium, trimethylammonium, tetramethylammonium, tetraethylammonium, tetrabutylammonium, 2-hydroxyethyl-ammonium, 2-(2-hydroxyeth-1-oxy)eth-1-ylammonium, di(2-hydroxyeth-1-yl)-ammonium, benzyltrimethylammonium, benzyltriethylammonium, furthermore phosphonium ions, sulfonium ions, preferably tri(C₁-C₄-alkyl)sulfonium, such as trimethylsulfonium, and sulfoxonium ions, preferably tri(Cᵢ-C₄-alkyl)sulfoxonium.

Anions of useful acid addition salts are primarily chloride, bromide, fluoride, iodide, hydrogensulfate, methylsulfate, sulfate, dihydrogenphosphate, hydrogen-phosphate, nitrate, bicarbonate, carbonate, hexafluorosilicate, hexafluorophosphate, benzoate and also the anions of C₁-C₄-alkanoic acids, preferably formate, acetate, propionate and butyrate.

Active compounds B and C having a carboxyl group can be employed in the form of the acid, in the form of an agriculturally suitable salt or else in the form of an agriculturally acceptable derivative in the compositions according to the invention, for example as amides, such as mono- and di-C₁-C₆-alkylamides or arylamides, as esters, for example as allyl esters, propargyl esters, C₁-C₁₀-alkyl esters, alkoxyalkyl esters and also as thioesters, for example as C₁-C₁₀-alkylthio esters. Preferred mono- and di-C₁-C₆-alkylamides are the methyl and the dimethylamides. Preferred arylamides are, for example, the anilides and the 2-chloroanilides. Preferred alkyl esters are, for example, the methyl, ethyl, propyl, isopropyl, butyl, isobutyl, pentyl, mexyl (1-methylhexyl) or isooctyl (2-ethylhexyl) esters. Preferred C₁-C₄-alkoxy-C₁-C₄-alkyl esters are the straight-chain or branched C₁-C₄-alkoxy ethyl esters, for example the methoxyethyl, ethoxyethyl or butoxyethyl ester. An example of a straight-chain or branched C₁-C₁₀-alkylthio ester is the ethylthio ester.

A first preferred embodiment of the invention relates to compositions according to the invention comprising, in addition to a piperazinedione compound of the formula I, especially an active compound from the group consisting of I-1 to I-146, at least one and especially exactly one herbicidally active compound from group b1), in particular selected from the group consisting of clodinafop-propargyl, cycloxydim, cyhalofop-butyl, fenoxaprop-P-ethyl, pinoxaden, profoxydim, tepraloxydim, tralkoxydim, esprocarb, prosulfocarb, thiobencarb and triallate.

A second preferred embodiment of the invention relates to compositions according to the invention comprising, in addition to a piperazinedione compound of the formula I, especially an active compound from the group consisting of I-1 to I-146, at least one and especially exactly one herbicidally active compound from group b2), in particular selected from the group consisting of bensulfuron-methyl, bispyribac-sodium, cyclosulfamuron, flumetsulam, flupyrsulfuron-methyl-sodium, foramsulfuron, imazamox, imazapic, imazapyr, imazaquin, imazethapyr, imazosulfuron, iodosulfuron, iodosulfuron-methyl-sodium, mesosulfuron, nicosulfuron, penoxsulam, propoxycarbazon-sodium, pyrazosulfuron-ethyl, pyroxsulam, rimsulfuron, sulfosulfuron, thiencarbazon-methyl and tritosulfuron.

A third preferred embodiment of the invention relates to compositions according to the invention comprising, in addition to a piperazinedione compound of the formula I, especially an active compound from the group consisting of I-1 to I-146, at least one and especially exactly one herbicidally active compound from group b3), in particular selected from the group consisting of atrazine, diuron, fluometuron, hexazinone, isoproturon, metribuzin, paraquat, paraquat-dichloride, propanil and terbuthylazine.

A fourth preferred embodiment of the invention relates to compositions according to the invention comprising, in addition to a piperazinedione compound of the formula I, especially an active compound from the group consisting of I-1 to I-146, at least one and especially exactly one herbicidally active compound from group b4), in particular selected from the group consisting of flumioxazin, oxyfluorfen, sulfentrazone, 2-chloro-5-[3,6-dihydro-3-methyl-2,6-dioxo-4-(trifluoromethyl)-1(2H)-pyrimidinyl]-4-fluoro-N-[(isopropyl)methylsulfamoyl]benzamide (CAS 372137-35-4) and ethyl[3-[2-chloro-4-fluoro-5-(1-methyl-6-trifluoromethyl-2,4-dioxo-1,2,3,4,-tetrahydropyrimidin-3-yl)-phenoxy]-2-pyridyloxy]acetate (CAS 353292-31-6).

A fifth preferred embodiment of the invention relates to compositions according to the invention comprising, in addition to a piperazinedione compound of the formula I, especially an active compound from the group consisting of I-1 to I-146, at least one and especially exactly one herbicidally active compound from group b5), in particular selected from the group consisting of clomazone, diflufenican, fluorochloridone, isoxaflutole, mesotrione, picolinafen, sulcotrione, tefuryltrione, tembotrione, topramezone and 4-hydroxy-3-[[2-[(2-(2-methoxyethoxy)methyl]-6-(trifluoromethyl)-3-pyridyl]carbonyl]bicyclo[3.2.1]oct-3-en-2-one (CAS 352010-68-5).

A sixth preferred embodiment of the invention relates to compositions according to the invention comprising, in addition to a piperazinedione compound of the formula I, especially an active compound from the group consisting of I-1 to I-146, at least one and especially exactly one herbicidally active compound from group b6), in particular selected from the group consisting of glyphosate, glyphosate-isopropylammonium and glyphosate-trimesium (sulfosate).

A seventh preferred embodiment of the invention relates to compositions according to the invention comprising, in addition to a piperazinedione compound of the formula I, especially an active compound from the group consisting of I-1 to I-146, at least one and especially exactly one herbicidally active compound from group b7), in particular selected from the group consisting of glufosinate and glufosinate-ammonium.

An eighth preferred embodiment of the invention relates to compositions according to the invention comprising, in addition to a piperazinedione compound of the formula I, especially an active compound from the group consisting of I-1 to I-146, at least one and especially exactly one herbicidally active compound from group b9), in particular selected from the group consisting of pendimethalin and trifluralin.

A ninth preferred embodiment of the invention relates to compositions according to the invention comprising, in addition to a piperazinedione compound of the formula I, especially an active compound from the group consisting of I-1 to I-146, at least one and especially exactly one herbicidally active compound from group b10), in particular selected from the group consisting of acetochlor, cafenstrole, dimethenamid-P, fentrazamide, flufenacet, mefenacet, metazachlor, S-metolachlor and pyroxasulfone. Preference is likewise given to compositions comprising, in addition to a piperazine dione compound of the formula I, specifically an active compound from the group consisting of I-1 to I-146, at least one and especially exactly one herbicidally active compound from group b10), in particular selected from the isoxazoline compounds of the formulae II.1, II.2, II.3, II.4, II.5, II.6, II.7, II.8 and II.9 as defined above.

A tenth preferred embodiment of the invention relates to compositions according to the invention comprising, in addition to a piperazinedione compound of the formula I, especially an active compound from the group consisting of I-1 to I-146, at least one and especially exactly one herbicidally active compound from group b11), in particular isoxaben.

An eleventh preferred embodiment of the invention relates to compositions according to the invention comprising, in addition to a piperazinedione compound of the formula I, especially an active compound from the group consisting of I-1 to I-146, at least one and especially exactly one herbicidally active compound from group b13), in particular selected from the group consisting of 2,4-D and its salts and esters, aminopyralid and its salts such as aminopyralid-tris(2-hydroxypropyl)ammonium and its esters, clopyralid and its salts and esters, dicamba and its salts and esters, fluoroxypyr-meptyl, quinclorac, quinmerac and 5,6-dichloro-2-cyclopropyl-4-pyrimidinecarboxylic acid (CAS 858956-08-8) and its salts and esters.

A twelfth preferred embodiment of the invention relates to compositions according to the invention comprising, in addition to a piperazinedione compound of the formula I, especially an active compound from the group consisting of I-1 to I-146, at least one and especially exactly one herbicidally active compound from group b14), in particular selected from the group consisting of diflufenzopyr and diflufenzopyr-sodium.

A 13th preferred embodiment of the invention relates to compositions according to the invention comprising, in addition to a piperazinedione compound of the formula I, especially an active compound from the group consisting of I-1 to I-146, at least one and especially exactly one herbicidally active compound from group b15), in particular selected from the group consisting of dymron (=daimuron), indanofan, oxaziclomefone and triaziflam.

A 14th preferred embodiment of the invention relates to compositions according to the invention comprising, in addition to a piperazinedione compound of the formula I, especially an active compound from the group consisting of I-1 to I-146, at least one and especially exactly one herbicidally active compound from the safeners C, in particular selected from the group consisting of benoxacor, cloquintocet, cyprosulfamide, dichlormid, fenchlorazole, isoxadifen, mefenpyr, 4-(dichloroacetyl)-1-oxa-4-azaspiro[4.5]decane (MON4660, CAS 71526-07-3) and 2,2,5-trimethyl-3-(dichloroacetyl)-1,3-oxazolidine (R-29148, CAS 52836-31-4).

Further preferred embodiments relate to ternary compositions which correspond to the binary compositions of embodiments 1 to 13 and additionally comprise a safener C, in particular selected from the group consisting of benoxacor, cloquintocet, cyprosulfamide, dichlormid, fenchlorazole, isoxadifen, mefenpyr, 4-(dichloroacetyl)-1-oxa-4-azaspiro[4.5]decane (MON4660, CAS 71526-07-3) and 2,2,5-trimethyl-3-(dichloroacetyl)-1,3-oxazolidine (R-29148, CAS 52836-31-4).

Here and below, the term “binary compositions” includes compositions comprising one or more, for example 1, 2 or 3, active compounds of the formula I and either one or more, for example 1, 2 or 3, herbicides B or one or more safeners. Correspondingly, the term “ternary compositions” includes compositions comprising one or more, for example 1, 2 or 3, active compounds of the formula I, one or more, for example 1, 2 or 3, herbicides B and one or more, for example 1, 2 or 3, safeners C.

In binary compositions comprising at least one compound of the formula I as component A and at least one herbicide B, the weight ratio of the active compounds A:B is generally in the range of from 1:1000 to 1000:1, preferably in the range of from 1:500 to 500:1, in particular in the range of from 1:250 to 250:1 and particularly preferably in the range of from 1:75 to 75:1.

In binary compositions comprising at least one compound of the formula I as component A and at least one safener C, the weight ratio of the active compounds A:C is generally in the range of from 1:1000 to 1000:1, preferably in the range of from 1:500 to 500:1, in particular in the range of from 1:250 to 250:1 and particularly preferably in the range of from 1:75 to 75:1.

In ternary compositions comprising both at least one compound of the formula I as component A, at least one herbicide B and at least one safener C, the relative proportions by weight of the components A:B are generally in the range of from 1:1000 to 1000:1, preferably in the range of from 1:500 to 500:1, in particular in the range of from 1:250 to 250:1 and particularly preferably in the range of from 1:75 to 75:1, the weight ratio of the components A:C is generally in the range of from 1:1000 to 1000:1, preferably in the range of from 1:500 to 500:1, in particular in the range of from 1:250 to 250:1 and particularly preferably in the range of from 1:75 to 75:1, and the weight ratio of the components B:C is generally in the range of from 1:1000 to 1000:1, preferably in the range of from 1:500 to 500:1, in particular in the range of from 1:250 to 250:1 and particularly preferably in the range of from 1:75 to 75:1. The weight ratio of components A+B to component C is preferably in the range of from 1:500 to 500:1, in particular in the range of from 1:250 to 250:1 and particularly preferably in the range of from 1:75 to 75:1.

Examples of particularly preferred mixing partners and mixing partner combinations are given in table A below.

TABLE A

| | Herbicide(s) B | Safener C |
|---|---|---|
| 1. | clodinafop-propargyl | — |
| 2. | cycloxydim | — |
| 3. | cyhalofop-butyl | — |
| 4. | fenoxaprop-P-ethyl | — |
| 5. | pinoxaden | — |
| 6. | profoxydim | — |
| 7. | tepraloxydim | — |
| 8. | tralkoxydim | — |
| 9. | esprocarb | — |
| 10. | prosulfocarb | — |
| 11. | thiobencarb | — |
| 12. | triallate | — |
| 13. | bensulfuron-methyl | — |
| 14. | bispyribac-sodium | — |
| 15. | cyclosulfamuron | — |
| 16. | flumetsulam | — |
| 17. | flupyrsulfuron-methyl-sodium | — |
| 18. | foramsulfuron | — |
| 19. | imazamox | — |
| 20. | imazapic | — |
| 21. | imazapyr | — |
| 22. | imazaquin | — |
| 23. | imazethapyr | — |
| 24. | imazosulfuron | — |
| 25. | iodosulfuron-methyl-sodium | — |
| 26. | mesosulfuron | — |
| 27. | nicosulfuron | — |
| 28. | penoxsulam | — |
| 29. | propoxycarbazon-sodium | — |
| 30. | pyrazosulfuron-ethyl | — |
| 31. | pyroxsulam | — |
| 32. | rimsulfuron | — |
| 33. | sulfosulfuron | — |
| 34. | thiencarbazone-methyl | — |
| 35. | tritosulfuron | — |
| 36. | 2,4-D and its salts and esters | — |
| 37. | aminopyralid and its salts and esters | — |
| 38. | clopyralid and its salts and esters | — |
| 39. | dicamba and its salts and esters | — |
| 40. | fluroxypyr-meptyl | — |
| 41. | quinclorac | — |
| 42. | quinmerac | — |
| 43. | 5,6-dichloro-2-cyclopropyl-4-pyrimidine- | — |
| | carboxylic acid (CAS 858956-08-8) | |
| 44. | diflufenzopyr | — |
| 45. | diflufenzopyr-sodium | — |
| 46. | clomazone | — |
| 47. | diflufenican | — |
| 48. | flurochloridone | — |
| 49. | isoxaflutole | — |
| 50. | mesotrione | — |
| 51. | picolinafen | — |
| 52. | sulcotrione | — |
| 53. | tefuryltrione | — |
| 54. | tembotrione | — |
| 55. | topramezone | — |
| 56. | 4-hydroxy-3-[[2-[(2-methoxyethoxy)- | — |
| | methyl]-6-(trifluoromethyl)-3-pyridyl]- | |
| | carbonyl]bicyclo[3.2.1]oct-3-en-2-one | |
| | (CAS 352010-68-5) | |
| 57. | atrazine | — |
| 58. | diuron | — |
| 59. | fluometuron | — |
| 60. | hexazinone | — |
| 61. | isoproturon | — |
| 62. | metribuzin | — |
| 63. | propanil | — |
| 64. | terbuthylazine | — |
| 65. | paraquat-dichloride | — |
| 66. | flumioxazin | — |
| 67. | oxyfluorfen | — |
| 68. | sulfentrazone | — |
| 69. | 2-chloro-5-[3,6-dihydro-3-methyl-2,6- | — |
| | dioxo-4-(trifluoromethyl)-1(2H)-pyrimidin- | |
| | yl]-4-fluoro-N-[(isopropyl)methylsulfamoyl]benzamide | |
| | (CAS 372137-35-4) | |
| 70. | ethyl [3-[2-chloro-4-fluoro-5-(1-methyl-6- | — |
| | trifluoromethyl-2,4-dioxo-1,2,3,4-tetra- | |
| | hydropyrimidin-3-yl)phenoxy]-2-pyridyl- | |
| | oxy]acetate (CAS 353292-31-6) | |
| 71. | glyphosate | — |
| 72. | glyphosate-isopropylammonium | — |
| 73. | glyphosate-trimesium (sulfosate) | — |
| 74. | glufosinate | — |
| 75. | glufosinate-ammonium | — |
| 76. | pendimethalin | — |
| 77. | trifluralin | — |
| 78. | acetochlor | — |
| 79. | cafenstrole | — |
| 80. | dimethenamid-P | — |
| 81. | fentrazamide | — |
| 82. | flufenacet | — |
| 83. | mefenacet | — |
| 84. | metazachlor | — |
| 85. | metolachlor-S | — |
| 86. | pyroxasulfone | — |
| 87. | isoxaben | — |
| 88. | dymron | — |
| 89. | indanofan | — |
| 90. | oxaziclomefone | — |
| 91. | triaziflam | — |
| 92. | atrazine + 2-chloro-5-[3,6-dihydro-3- | — |
| | methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 93. | atrazine + glyphosate | — |
| 94. | atrazine + mesotrione | — |
| 95. | atrazine + nicosulfuron | — |
| 96. | atrazine + tembotrione | — |
| 97. | atrazine + topramezone | — |
| 98. | clomazone + glyphosate | — |
| 99. | diflufenican + clodinafop-propargyl | — |
| 100. | diflufenican + fenoxaprop-P-ethyl | — |
| 101. | diflufenican + flupyrsulfuron-methyl- | — |
| | sodium | |
| 102. | diflufenican + glyphosate | — |
| 103. | diflufenican + mesosulfuron-methyl | — |
| 104. | diflufenican + pinoxaden | — |
| 105. | diflufenican + pyroxsulam | — |
| 106. | flumetsulam + glyphosate | — |
| 107. | flumioxazin + glyphosate | — |
| 108. | imazapic + glyphosate | — |
| 109. | imazethapyr + glyphosate | — |
| 110. | isoxaflutole + 2-chloro-5-[3,6-dihydro-3- | — |
| | methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 111. | isoxaflutole + glyphosate | — |
| 112. | metazachlor + 2-chloro-5-[3,6-dihydro-3- | — |
| | methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 113. | metazachlor + glyphosate | — |
| 114. | metazachlor + mesotrione | — |
| 115. | metazachlor + nicosulfuron | — |
| 116. | metazachlor + terbuthylazine | — |
| 117. | metazachlor + topramezone | — |
| 118. | metribuzin + glyphosate | — |
| 119. | pendimethalin + 2-chloro-5-[3,6-dihydro- | — |
| | 3-methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 120. | pendimethalin + clodinafop-propargyl | — |
| 121. | pendimethalin + fenoxaprop-P-ethyl | — |
| 122. | pendimethalin + flupyrsulfuron-methyl- | — |
| | sodium | |
| 123. | pendimethalin + glyphosate | — |
| 124. | pendimethalin + mesosulfuron-methyl | — |
| 125. | pendimethalin + mesotrione | — |
| 126. | pendimethalin + nicosulfuron | — |
| 127. | pendimethalin + pinoxaden | — |
| 128. | pendimethalin + pyroxsulam | — |
| 129. | pendimethalin + tembotrione | — |
| 130. | pendimethalin + topramezone | — |
| 131. | pyroxasulfone + tembotrione | — |
| 132. | pyroxasulfone + topramezone | — |
| 133. | sulfentrazone + glyphosate | — |
| 134. | terbuthylazine + 2-chloro-5-[3,6-dihydro- | — |
| | 3-methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 135. | terbuthylazine + foramsulfuron | — |
| 136. | terbuthylazine + glyphosate | — |
| 137. | terbuthylazine + mesotrione | — |
| 138. | terbuthylazine + nicosulfuron | — |
| 139. | terbuthylazine + tembotrione | — |
| 140. | terbuthylazine + topramezone | — |
| 141. | trifluralin + glyphosate | — |
| 142. | — | benoxacor |
| 143. | — | cloquintocet |
| 144. | — | cyprosulfamide |
| 145. | — | dichlormid |
| 146. | — | fenchlorazole |
| 147. | — | isoxadifen |
| 148. | — | mefenpyr |
| 149. | — | 4-(dichloroacetyl)-1-oxa-4- |
| | | azaspiro[4.5]decane |
| | | (MON4660, CAS 71526-07-3) |
| 150. | — | 2,2,5-trimethyl-3-(dichloro- |
| | | acetyl)-1,3-oxazolidine (R- |
| | | 29148, CAS 52836-31-4) |
| 151. | clodinafop-propargyl | benoxacor |
| 152. | cycloxydim | benoxacor |
| 153. | cyhalofop-butyl | benoxacor |
| 154. | fenoxaprop-P-ethyl | benoxacor |
| 155. | pinoxaden | benoxacor |
| 156. | profoxydim | benoxacor |
| 157. | tepraloxydim | benoxacor |
| 158. | tralkoxydim | benoxacor |
| 159. | esprocarb | benoxacor |
| 160. | prosulfocarb | benoxacor |
| 161. | thiobencarb | benoxacor |
| 162. | triallate | benoxacor |
| 163. | bensulfuron-methyl | benoxacor |
| 164. | bispyribac-sodium | benoxacor |
| 165. | cyclosulfamuron | benoxacor |
| 166. | flumetsulam | benoxacor |
| 167. | flupyrsulfuron-methyl-sodium | benoxacor |
| 168. | foramsulfuron | benoxacor |
| 169. | imazamox | benoxacor |
| 170. | imazapic | benoxacor |
| 171. | imazapyr | benoxacor |
| 172. | imazaquin | benoxacor |
| 173. | imazethapyr | benoxacor |
| 174. | imazosulfuron | benoxacor |
| 175. | iodosulfuron-methyl-sodium | benoxacor |
| 176. | mesosulfuron | benoxacor |
| 177. | nicosulfuron | benoxacor |
| 178. | penoxsulam | benoxacor |
| 179. | propoxycarbazon-sodium | benoxacor |
| 180. | pyrazosulfuron-ethyl | benoxacor |
| 181. | pyroxsulam | benoxacor |
| 182. | rimsulfuron | benoxacor |
| 183. | sulfosulfuron | benoxacor |
| 184. | thiencarbazone-methyl | benoxacor |
| 185. | tritosulfuron | benoxacor |
| 186. | 2,4-D and its salts and esters | benoxacor |
| 187. | aminopyralid and its salts and esters | benoxacor |
| 188. | clopyralid and its salts and esters | benoxacor |
| 189. | dicamba and its salts and esters | benoxacor |
| 190. | fluroxypyr-meptyl | benoxacor |
| 191. | quinclorac | benoxacor |
| 192. | quinmerac | benoxacor |
| 193. | 5,6-dichloro-2-cyclopropyl-4-pyrimidine- | benoxacor |
| | carboxylic acid (CAS 858956-08-8) | |
| 194. | diflufenzopyr | benoxacor |
| 195. | diflufenzopyr-sodium | benoxacor |
| 196. | clomazone | benoxacor |
| 197. | diflufenican | benoxacor |
| 198. | flurochloridone | benoxacor |
| 199. | isoxaflutole | benoxacor |
| 200. | mesotrione | benoxacor |
| 201. | picolinafen | benoxacor |
| 202. | sulcotrione | benoxacor |
| 203. | tefuryltrione | benoxacor |
| 204. | tembotrione | benoxacor |
| 205. | topramezone | benoxacor |
| 206. | 4-hydroxy-3-[[2-[(2-methoxyethoxy)- | benoxacor |
| | methyl]-6-(trifluoromethyl)-3-pyridyl]- | |
| | carbonyl]bicyclo[3.2.1]oct-3-en-2-one | |
| | (CAS 352010-68-5) | |
| 207. | atrazine | benoxacor |
| 208. | diuron | benoxacor |
| 209. | fluometuron | benoxacor |
| 210. | hexazinone | benoxacor |
| 211. | isoproturon | benoxacor |
| 212. | metribuzin | benoxacor |
| 213. | propanil | benoxacor |
| 214. | terbuthylazine | benoxacor |
| 215. | paraquat-dichloride | benoxacor |
| 216. | flumioxazin | benoxacor |
| 217. | oxyfluorfen | benoxacor |
| 218. | sulfentrazone | benoxacor |
| 219. | 2-chloro-5-[3,6-dihydro-3-methyl-2,6- | benoxacor |
| | dioxo-4-(trifluoromethyl)-1(2H)-pyrimidin- | |
| | yl]-4-fluoro-N-[(isopropyl)methyl- | |
| | sulfamoyl]benzamide (CAS 372137-35-4) | |
| 220. | ethyl [3-[2-chloro-4-fluoro-5-(1-methyl-6- | benoxacor |
| | trifluoromethyl-2,4-dioxo-1,2,3,4-tetra- | |
| | hydropyrimidin-3-yl)phenoxy]-2-pyridyl- | |
| | oxy]acetate (CAS 353292-31-6) | |
| 221. | glyphosate | benoxacor |
| 222. | glyphosate-isopropylammonium | benoxacor |
| 223. | glyphosate-trimesium (sulfosate) | benoxacor |
| 224. | glufosinate | benoxacor |
| 225. | glufosinate-ammonium | benoxacor |
| 226. | pendimethalin | benoxacor |
| 227. | trifluralin | benoxacor |
| 228. | acetochlor | benoxacor |
| 229. | cafenstrole | benoxacor |
| 230. | dimethenamid-P | benoxacor |
| 231. | fentrazamide | benoxacor |
| 232. | flufenacet | benoxacor |
| 233. | mefenacet | benoxacor |
| 234. | metazachlor | benoxacor |
| 235. | metolachlor-S | benoxacor |
| 236. | pyroxasulfone | benoxacor |
| 237. | isoxaben | benoxacor |
| 238. | dymron | benoxacor |
| 239. | indanofan | benoxacor |
| 240. | oxaziclomefone | benoxacor |
| 241. | triaziflam | benoxacor |
| 242. | atrazine + 2-chloro-5-[3,6-dihydro-3- | benoxacor |
| | methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 243. | atrazine + glyphosate | benoxacor |
| 244. | atrazine + mesotrione | benoxacor |
| 245. | atrazine + nicosulfuron | benoxacor |
| 246. | atrazine + tembotrione | benoxacor |
| 247. | atrazine + topramezone | benoxacor |
| 248. | clomazone + glyphosate | benoxacor |
| 249. | diflufenican + clodinafop-propargyl | benoxacor |
| 250. | diflufenican + fenoxaprop-P-ethyl | benoxacor |
| 251. | diflufenican + flupyrsulfuron-methyl- | benoxacor |
| | sodium | |
| 252. | diflufenican + glyphosate | benoxacor |
| 253. | diflufenican + mesosulfuron-methyl | benoxacor |
| 254. | diflufenican + pinoxaden | benoxacor |
| 255. | diflufenican + pyroxsulam | benoxacor |
| 256. | flumetsulam + glyphosate | benoxacor |
| 257. | flumioxazin + glyphosate | benoxacor |
| 258. | imazapic + glyphosate | benoxacor |
| 259. | imazethapyr + glyphosate | benoxacor |
| 260. | isoxaflutole + 2-chloro-5-[3,6-dihydro-3- | benoxacor |
| | methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 261. | isoxaflutole + glyphosate | benoxacor |
| 262. | metazachlor + 2-chloro-5-[3,6-dihydro-3- | benoxacor |
| | methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 263. | metazachlor + glyphosate | benoxacor |
| 264. | metazachlor + mesotrione | benoxacor |
| 265. | metazachlor + nicosulfuron | benoxacor |
| 266. | metazachlor + terbuthylazine | benoxacor |
| 267. | metazachlor + topramezone | benoxacor |
| 268. | metribuzin + glyphosate | benoxacor |
| 269. | pendimethalin + 2-chloro-5-[3,6-dihydro- | benoxacor |
| | 3-methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 270. | pendimethalin + clodinafop-propargyl | benoxacor |
| 271. | pendimethalin + fenoxaprop-P-ethyl | benoxacor |
| 272. | pendimethalin + flupyrsulfuron-methyl- | benoxacor |
| | sodium | |
| 273. | pendimethalin + glyphosate | benoxacor |
| 274. | pendimethalin + mesosulfuron-methyl | benoxacor |
| 275. | pendimethalin + mesotrione | benoxacor |
| 276. | pendimethalin + nicosulfuron | benoxacor |
| 277. | pendimethalin + pinoxaden | benoxacor |
| 278. | pendimethalin + pyroxsulam | benoxacor |
| 279. | pendimethalin + tembotrione | benoxacor |
| 280. | pendimethalin + topramezone | benoxacor |
| 281. | pyroxasulfone + tembotrione | benoxacor |
| 282. | pyroxasulfone + topramezone | benoxacor |
| 283. | sulfentrazone + glyphosate | benoxacor |
| 284. | terbuthylazine + 2-chloro-5-[3,6-dihydro- | benoxacor |
| | 3-methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 285. | terbuthylazine + foramsulfuron | benoxacor |
| 286. | terbuthylazine + glyphosate | benoxacor |
| 287. | terbuthylazine + mesotrione | benoxacor |
| 288. | terbuthylazine + nicosulfuron | benoxacor |
| 289. | terbuthylazine + tembotrione | benoxacor |
| 290. | terbuthylazine + topramezone | benoxacor |
| 291. | trifluralin + glyphosate | benoxacor |
| 292. | clodinafop-propargyl | cloquintocet |
| 293. | cycloxydim | cloquintocet |
| 294. | cyhalofop-butyl | cloquintocet |
| 295. | fenoxaprop-P-ethyl | cloquintocet |
| 296. | pinoxaden | cloquintocet |
| 297. | profoxydim | cloquintocet |
| 298. | tepraloxydim | cloquintocet |
| 299. | tralkoxydim | cloquintocet |
| 300. | esprocarb | cloquintocet |
| 301. | prosulfocarb | cloquintocet |
| 302. | thiobencarb | cloquintocet |
| 303. | triallate | cloquintocet |
| 304. | bensulfuron-methyl | cloquintocet |
| 305. | bispyribac-sodium | cloquintocet |
| 306. | cyclosulfamuron | cloquintocet |
| 307. | flumetsulam | cloquintocet |
| 308. | flupyrsulfuron-methyl-sodium | cloquintocet |
| 309. | foramsulfuron | cloquintocet |
| 310. | imazamox | cloquintocet |
| 311. | imazapic | cloquintocet |
| 312. | imazapyr | cloquintocet |
| 313. | imazaquin | cloquintocet |
| 314. | imazethapyr | cloquintocet |
| 315. | imazosulfuron | cloquintocet |
| 316. | iodosulfuron-methyl-sodium | cloquintocet |
| 317. | mesosulfuron | cloquintocet |
| 318. | nicosulfuron | cloquintocet |
| 319. | penoxsulam | cloquintocet |
| 320. | propoxycarbazon-sodium | cloquintocet |
| 321. | pyrazosulfuron-ethyl | cloquintocet |
| 322. | pyroxsulam | cloquintocet |
| 323. | rimsulfuron | cloquintocet |
| 324. | sulfosulfuron | cloquintocet |
| 325. | thiencarbazone-methyl | cloquintocet |
| 326. | tritosulfuron | cloquintocet |
| 327. | 2,4-D and its salts and esters | cloquintocet |
| 328. | aminopyralid and its salts and esters | cloquintocet |
| 329. | clopyralid and its salts and esters | cloquintocet |
| 330. | dicamba and its salts and esters | cloquintocet |
| 331. | fluroxypyr-meptyl | cloquintocet |
| 332. | quinclorac | cloquintocet |
| 333. | quinmerac | cloquintocet |
| 334. | 5,6-dichloro-2-cyclopropyl-4-pyrimidine- | cloquintocet |
| | carboxylic acid (CAS 858956-08-8) | |
| 335. | diflufenzopyr | cloquintocet |
| 336. | diflufenzopyr-sodium | cloquintocet |
| 337. | clomazone | cloquintocet |
| 338. | diflufenican | cloquintocet |
| 339. | flurochloridone | cloquintocet |
| 340. | isoxaflutole | cloquintocet |
| 341. | mesotrione | cloquintocet |
| 342. | picolinafen | cloquintocet |
| 343. | sulcotrione | cloquintocet |
| 344. | tefuryltrione | cloquintocet |
| 345. | tembotrione | cloquintocet |
| 346. | topramezone | cloquintocet |
| 347. | 4-hydroxy-3-[[2-[(2-methoxyethoxy)- | cloquintocet |
| | methyl]-6-(trifluoromethyl)-3-pyridyl]- | |
| | carbonyl]bicyclo[3.2.1]oct-3-en-2-one | |
| | (CAS 352010-68-5) | |
| 348. | atrazine | cloquintocet |
| 349. | diuron | cloquintocet |
| 350. | fluometuron | cloquintocet |
| 351. | hexazinone | cloquintocet |
| 352. | isoproturon | cloquintocet |
| 353. | metribuzin | cloquintocet |
| 354. | propanil | cloquintocet |
| 355. | terbuthylazine | cloquintocet |
| 356. | paraquat-dichloride | cloquintocet |
| 357. | flumioxazin | cloquintocet |
| 358. | oxyfluorfen | cloquintocet |
| 359. | sulfentrazone | cloquintocet |
| 360. | 2-chloro-5-[3,6-dihydro-3-methyl-2,6- | cloquintocet |
| | dioxo-4-(trifluoromethyl)-1(2H)-pyrimidin- | |
| | yl]-4-fluoro-N-[(isopropyl)methyl- | |
| | sulfamoyl]benzamide (CAS 372137-35-4) | |
| 361. | ethyl [3-[2-chloro-4-fluoro-5-(1-methyl-6- | cloquintocet |
| | trifluoromethyl-2,4-dioxo-1,2,3,4-tetra- | |
| | hydropyrimidin-3-yl)phenoxy]-2- | |
| | pyridyloxy]acetate (CAS 353292-31-6) | |
| 362. | glyphosate | cloquintocet |
| 363. | glyphosate-isopropylammonium | cloquintocet |
| 364. | glyphosate-trimesium (sulfosate) | cloquintocet |
| 365. | glufosinate | cloquintocet |
| 366. | glufosinate-ammonium | cloquintocet |
| 367. | pendimethalin | cloquintocet |
| 368. | trifluralin | cloquintocet |
| 369. | acetochlor | cloquintocet |
| 370. | cafenstrole | cloquintocet |
| 371. | dimethenamid-P | cloquintocet |
| 372. | fentrazamide | cloquintocet |
| 373. | flufenacet | cloquintocet |
| 374. | mefenacet | cloquintocet |
| 375. | metazachlor | cloquintocet |
| 376. | metolachlor-S | cloquintocet |
| 377. | pyroxasulfone | cloquintocet |
| 378. | isoxaben | cloquintocet |
| 379. | dymron | cloquintocet |
| 380. | indanofan | cloquintocet |
| 381. | oxaziclomefone | cloquintocet |
| 382. | triaziflam | cloquintocet |
| 383. | atrazine + 2-chloro-5-[3,6-dihydro-3- | cloquintocet |
| | methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 384. | atrazine + glyphosate | cloquintocet |
| 385. | atrazine + mesotrione | cloquintocet |
| 386. | atrazine + nicosulfuron | cloquintocet |
| 387. | atrazine + tembotrione | cloquintocet |
| 388. | atrazine + topramezone | cloquintocet |
| 389. | clomazone + glyphosate | cloquintocet |
| 390. | diflufenican + clodinafop-propargyl | cloquintocet |
| 391. | diflufenican + fenoxaprop-P-ethyl | cloquintocet |
| 392. | diflufenican + flupyrsulfuron-methyl- | cloquintocet |
| | sodium | |
| 393. | diflufenican + glyphosate | cloquintocet |
| 394. | diflufenican + mesosulfuron-methyl | cloquintocet |
| 395. | diflufenican + pinoxaden | cloquintocet |
| 396. | diflufenican + pyroxsulam | cloquintocet |
| 397. | flumetsulam + glyphosate | cloquintocet |
| 398. | flumioxazin + glyphosate | cloquintocet |
| 399. | imazapic + glyphosate | cloquintocet |
| 400. | imazethapyr + glyphosate | cloquintocet |
| 401. | isoxaflutole + 2-chloro-5-[3,6-dihydro-3- | cloquintocet |
| | methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 402. | isoxaflutole + glyphosate | cloquintocet |
| 403. | metazachlor + 2-chloro-5-[3,6-dihydro-3- | cloquintocet |
| | methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 404. | metazachlor + glyphosate | cloquintocet |
| 405. | metazachlor + mesotrione | cloquintocet |
| 406. | metazachlor + nicosulfuron | cloquintocet |
| 407. | metazachlor + terbuthylazine | cloquintocet |
| 408. | metazachlor + topramezone | cloquintocet |
| 409. | metribuzin + glyphosate | cloquintocet |
| 410. | pendimethalin + 2-chloro-5-[3,6-dihydro- | cloquintocet |
| | 3-methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 411. | pendimethalin + clodinafop-propargyl | cloquintocet |
| 412. | pendimethalin + fenoxaprop-P-ethyl | cloquintocet |
| 413. | pendimethalin + flupyrsulfuron-methyl- | cloquintocet |
| | sodium | |
| 414. | pendimethalin + glyphosate | cloquintocet |
| 415. | pendimethalin + mesosulfuron-methyl | cloquintocet |
| 416. | pendimethalin + mesotrione | cloquintocet |
| 417. | pendimethalin + nicosulfuron | cloquintocet |
| 418. | pendimethalin + pinoxaden | cloquintocet |
| 419. | pendimethalin + pyroxsulam | cloquintocet |
| 420. | pendimethalin + tembotrione | cloquintocet |
| 421. | pendimethalin + topramezone | cloquintocet |
| 422. | pyroxasulfone + tembotrione | cloquintocet |
| 423. | pyroxasulfone + topramezone | cloquintocet |
| 424. | sulfentrazone + glyphosate | cloquintocet |
| 425. | terbuthylazine + 2-chloro-5-[3,6-dihydro- | cloquintocet |
| | 3-methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 426. | terbuthylazine + foramsulfuron | cloquintocet |
| 427. | terbuthylazine + glyphosate | cloquintocet |
| 428. | terbuthylazine + mesotrione | cloquintocet |
| 429. | terbuthylazine + nicosulfuron | cloquintocet |
| 430. | terbuthylazine + tembotrione | cloquintocet |
| 431. | terbuthylazine + topramezone | cloquintocet |
| 432. | trifluralin + glyphosate | cloquintocet |
| 433. | clodinafop-propargyl | dichlormid |
| 434. | cycloxydim | dichlormid |
| 435. | cyhalofop-butyl | dichlormid |
| 436. | fenoxaprop-P-ethyl | dichlormid |
| 437. | pinoxaden | dichlormid |
| 438. | profoxydim | dichlormid |
| 439. | tepraloxydim | dichlormid |
| 440. | tralkoxydim | dichlormid |
| 441. | esprocarb | dichlormid |
| 442. | prosulfocarb | dichlormid |
| 443. | thiobencarb | dichlormid |
| 444. | triallate | dichlormid |
| 445. | bensulfuron-methyl | dichlormid |
| 446. | bispyribac-sodium | dichlormid |
| 447. | cyclosulfamuron | dichlormid |
| 448. | flumetsulam | dichlormid |
| 449. | flupyrsulfuron-methyl-sodium | dichlormid |
| 450. | foramsulfuron | dichlormid |
| 451. | imazamox | dichlormid |
| 452. | imazapic | dichlormid |
| 453. | imazapyr | dichlormid |
| 454. | imazaquin | dichlormid |
| 455. | imazethapyr | dichlormid |
| 456. | imazosulfuron | dichlormid |
| 457. | iodosulfuron-methyl-sodium | dichlormid |
| 458. | mesosulfuron | dichlormid |
| 459. | nicosulfuron | dichlormid |
| 460. | penoxsulam | dichlormid |
| 461. | propoxycarbazon-sodium | dichlormid |
| 462. | pyrazosulfuron-ethyl | dichlormid |
| 463. | pyroxsulam | dichlormid |
| 464. | rimsulfuron | dichlormid |
| 465. | sulfosulfuron | dichlormid |
| 466. | thiencarbazone-methyl | dichlormid |
| 467. | tritosulfuron | dichlormid |
| 468. | 2,4-D and its salts and esters | dichlormid |
| 469. | aminopyralid and its salts and esters | dichlormid |
| 470. | clopyralid and its salts and esters | dichlormid |
| 471. | dicamba and its salts and esters | dichlormid |
| 472. | fluroxypyr-meptyl | dichlormid |
| 473. | quinclorac | dichlormid |
| 474. | quinmerac | dichlormid |
| 475. | 5,6-dichloro-2-cyclopropyl-4-pyrimidine- | dichlormid |
| | carboxylic acid (CAS 858956-08-8) | |
| 476. | diflufenzopyr | dichlormid |
| 477. | diflufenzopyr-sodium | dichlormid |
| 478. | clomazone | dichlormid |
| 479. | diflufenican | dichlormid |
| 480. | flurochloridone | dichlormid |
| 481. | isoxaflutole | dichlormid |
| 482. | mesotrione | dichlormid |
| 483. | picolinafen | dichlormid |
| 484. | sulcotrione | dichlormid |
| 485. | tefuryltrione | dichlormid |
| 486. | tembotrione | dichlormid |
| 487. | topramezone | dichlormid |
| 488. | 4-hydroxy-3-[[2-[(2-methoxyethoxy)- | dichlormid |
| | methyl]-6-(trifluoromethyl)-3-pyridyl]- | |
| | carbonyl]bicyclo[3.2.1]oct-3-en-2-one | |
| | (CAS 352010-68-5) | |
| 489. | atrazine | dichlormid |
| 490. | diuron | dichlormid |
| 491. | fluometuron | dichlormid |
| 492. | hexazinone | dichlormid |
| 493. | isoproturon | dichlormid |
| 494. | metribuzin | dichlormid |
| 495. | propanil | dichlormid |
| 496. | terbuthylazine | dichlormid |
| 497. | paraquat-dichloride | dichlormid |
| 498. | flumioxazin | dichlormid |
| 499. | oxyfluorfen | dichlormid |
| 500. | sulfentrazone | dichlormid |
| 501. | 2-chloro-5-[3,6-dihydro-3-methyl-2,6- | dichlormid |
| | dioxo-4-(trifluoromethyl)-1(2H)-pyrimidin- | |
| | yl]-4-fluoro-N-[(isopropyl)methyl- | |
| | sulfamoyl]benzamide (CAS 372137-35-4) | |
| 502. | ethyl [3-[2-chloro-4-fluoro-5-(1-methyl-6- | dichlormid |
| | trifluoromethyl-2,4-dioxo-1,2,3,4-tetra- | |
| | hydropyrimidin-3-yl)phenoxy]-2-pyridyl- | |
| | oxy]acetate (CAS 353292-31-6) | |
| 503. | glyphosate | dichlormid |
| 504. | glyphosate-isopropylammonium | dichlormid |
| 505. | glyphosate-trimesium (sulfosate) | dichlormid |
| 506. | glufosinate | dichlormid |
| 507. | glufosinate-ammonium | dichlormid |
| 508. | pendimethalin | dichlormid |
| 509. | trifluralin | dichlormid |
| 510. | acetochlor | dichlormid |
| 511. | cafenstrole | dichlormid |
| 512. | dimethenamid-P | dichlormid |
| 513. | fentrazamide | dichlormid |
| 514. | flufenacet | dichlormid |
| 515. | mefenacet | dichlormid |
| 516. | metazachlor | dichlormid |
| 517. | metolachlor-S | dichlormid |
| 518. | pyroxasulfone | dichlormid |
| 519. | isoxaben | dichlormid |
| 520. | dymron | dichlormid |
| 521. | indanofan | dichlormid |
| 522. | oxaziclomefone | dichlormid |
| 523. | triaziflam | dichlormid |
| 524. | atrazine + 2-chloro-5-[3,6-dihydro-3- | dichlormid |
| | methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 525. | atrazine + glyphosate | dichlormid |
| 526. | atrazine + mesotrione | dichlormid |
| 527. | atrazine + nicosulfuron | dichlormid |
| 528. | atrazine + tembotrione | dichlormid |
| 529. | atrazine + topramezone | dichlormid |
| 530. | clomazone + glyphosate | dichlormid |
| 531. | diflufenican + clodinafop-propargyl | dichlormid |
| 532. | diflufenican + fenoxaprop-P-ethyl | dichlormid |
| 533. | diflufenican + flupyrsulfuron-methyl- | dichlormid |
| | sodium | |
| 534. | diflufenican + glyphosate | dichlormid |
| 535. | diflufenican + mesosulfuron-methyl | dichlormid |
| 536. | diflufenican + pinoxaden | dichlormid |
| 537. | diflufenican + pyroxsulam | dichlormid |
| 538. | flumetsulam + glyphosate | dichlormid |
| 539. | flumioxazin + glyphosate | dichlormid |
| 540. | imazapic + glyphosate | dichlormid |
| 541. | imazethapyr + glyphosate | dichlormid |
| 542. | isoxaflutole + 2-chloro-5-[3,6-dihydro-3- | dichlormid |
| | methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 543. | isoxaflutole + glyphosate | dichlormid |
| 544. | metazachlor + 2-chloro-5-[3,6-dihydro-3- | dichlormid |
| | methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 545. | metazachlor + glyphosate | dichlormid |
| 546. | metazachlor + mesotrione | dichlormid |
| 547. | metazachlor + nicosulfuron | dichlormid |
| 548. | metazachlor + terbuthylazine | dichlormid |
| 549. | metazachlor + topramezone | dichlormid |
| 550. | metribuzin + glyphosate | dichlormid |
| 551. | pendimethalin + 2-chloro-5-[3,6-dihydro- | dichlormid |
| | 3-methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 552. | pendimethalin + clodinafop-propargyl | dichlormid |
| 553. | pendimethalin + fenoxaprop-P-ethyl | dichlormid |
| 554. | pendimethalin + flupyrsulfuron-methyl- | dichlormid |
| | sodium | |
| 555. | pendimethalin + glyphosate | dichlormid |
| 556. | pendimethalin + mesosulfuron-methyl | dichlormid |
| 557. | pendimethalin + mesotrione | dichlormid |
| 558. | pendimethalin + nicosulfuron | dichlormid |
| 559. | pendimethalin + pinoxaden | dichlormid |
| 560. | pendimethalin + pyroxsulam | dichlormid |
| 561. | pendimethalin + tembotrione | dichlormid |
| 562. | pendimethalin + topramezone | dichlormid |
| 563. | pyroxasulfone + tembotrione | dichlormid |
| 564. | pyroxasulfone + topramezone | dichlormid |
| 565. | sulfentrazone + glyphosate | dichlormid |
| 566. | terbuthylazine + 2-chloro-5-[3,6-dihydro- | dichlormid |
| | 3-methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 567. | terbuthylazine + foramsulfuron | dichlormid |
| 568. | terbuthylazine + glyphosate | dichlormid |
| 569. | terbuthylazine + mesotrione | dichlormid |
| 570. | terbuthylazine + nicosulfuron | dichlormid |
| 571. | terbuthylazine + tembotrione | dichlormid |
| 572. | terbuthylazine + topramezone | dichlormid |
| 573. | trifluralin + glyphosate | dichlormid |
| 574. | clodinafop-propargyl | fenchlorazole |
| 575. | cycloxydim | fenchlorazole |
| 576. | cyhalofop-butyl | fenchlorazole |
| 577. | fenoxaprop-P-ethyl | fenchlorazole |
| 578. | pinoxaden | fenchlorazole |
| 579. | profoxydim | fenchlorazole |
| 580. | tepraloxydim | fenchlorazole |
| 581. | tralkoxydim | fenchlorazole |
| 582. | esprocarb | fenchlorazole |
| 583. | prosulfocarb | fenchlorazole |
| 584. | thiobencarb | fenchlorazole |
| 585. | triallate | fenchlorazole |
| 586. | bensulfuron-methyl | fenchlorazole |
| 587. | bispyribac-sodium | fenchlorazole |
| 588. | cyclosulfamuron | fenchlorazole |
| 589. | flumetsulam | fenchlorazole |
| 590. | flupyrsulfuron-methyl-sodium | fenchlorazole |
| 591. | foramsulfuron | fenchlorazole |
| 592. | imazamox | fenchlorazole |
| 593. | imazapic | fenchlorazole |
| 594. | imazapyr | fenchlorazole |
| 595. | imazaquin | fenchlorazole |
| 596. | imazethapyr | fenchlorazole |
| 597. | imazosulfuron | fenchlorazole |
| 598. | iodosulfuron-methyl-sodium | fenchlorazole |
| 599. | mesosulfuron | fenchlorazole |
| 600. | nicosulfuron | fenchlorazole |
| 601. | penoxsulam | fenchlorazole |
| 602. | propoxycarbazon-sodium | fenchlorazole |
| 603. | pyrazosulfuron-ethyl | fenchlorazole |
| 604. | pyroxsulam | fenchlorazole |
| 605. | rimsulfuron | fenchlorazole |
| 606. | sulfosulfuron | fenchlorazole |
| 607. | thiencarbazone-methyl | fenchlorazole |
| 608. | tritosulfuron | fenchlorazole |
| 609. | 2,4-D and its salts and esters | fenchlorazole |
| 610. | aminopyralid and its salts and esters | fenchlorazole |
| 611. | clopyralid and its salts and esters | fenchlorazole |
| 612. | dicamba and its salts and esters | fenchlorazole |
| 613. | fluroxypyr-meptyl | fenchlorazole |
| 614. | quinclorac | fenchlorazole |
| 615. | quinmerac | fenchlorazole |
| 616. | 5,6-dichloro-2-cyclopropyl-4-pyrimidine- | fenchlorazole |
| | carboxylic acid (CAS 858956-08-8) | |
| 617. | diflufenzopyr | fenchlorazole |
| 618. | diflufenzopyr-sodium | fenchlorazole |
| 619. | clomazone | fenchlorazole |
| 620. | diflufenican | fenchlorazole |
| 621. | flurochloridone | fenchlorazole |
| 622. | isoxaflutole | fenchlorazole |
| 623. | mesotrione | fenchlorazole |
| 624. | picolinafen | fenchlorazole |
| 625. | sulcotrione | fenchlorazole |
| 626. | tefuryltrione | fenchlorazole |
| 627. | tembotrione | fenchlorazole |
| 628. | topramezone | fenchlorazole |
| 629. | 4-hydroxy-3-[[2-[(2-methoxyethoxy)- | fenchlorazole |
| | methyl]-6-(trifluoromethyl)-3-pyridyl]- | |
| | carbonyl]bicyclo[3.2.1]oct-3-en-2-one | |
| | (CAS 352010-68-5) | |
| 630. | atrazine | fenchlorazole |
| 631. | diuron | fenchlorazole |
| 632. | fluometuron | fenchlorazole |
| 633. | hexazinone | fenchlorazole |
| 634. | isoproturon | fenchlorazole |
| 635. | metribuzin | fenchlorazole |
| 636. | propanil | fenchlorazole |
| 637. | terbuthylazine | fenchlorazole |
| 638. | paraquat-dichloride | fenchlorazole |
| 639. | flumioxazin | fenchlorazole |
| 640. | oxyfluorfen | fenchlorazole |
| 641. | sulfentrazone | fenchlorazole |
| 642. | 2-chloro-5-[3,6-dihydro-3-methyl-2,6- | fenchlorazole |
| | dioxo-4-(trifluoromethyl)-1(2H)-pyrimidin- | |
| | yl]-4-fluoro-N-[(isopropyl)methyl- | |
| | sulfamoyl]benzamide (CAS 372137-35-4) | |
| 643. | ethyl [3-[2-chloro-4-fluoro-5-(1-methyl-6- | fenchlorazole |
| | trifluoromethyl-2,4-dioxo-1,2,3,4-tetra- | |
| | hydropyrimidin-3-yl)phenoxy]-2-pyridyl- | |
| | oxy]acetate (CAS 353292-31-6) | |
| 644. | glyphosate | fenchlorazole |
| 645. | glyphosate-isopropylammonium | fenchlorazole |
| 646. | glyphosate-trimesium (sulfosate) | fenchlorazole |
| 647. | glufosinate | fenchlorazole |
| 648. | glufosinate-ammonium | fenchlorazole |
| 649. | pendimethalin | fenchlorazole |
| 650. | trifluralin | fenchlorazole |
| 651. | acetochlor | fenchlorazole |
| 652. | cafenstrole | fenchlorazole |
| 653. | dimethenamid-P | fenchlorazole |
| 654. | fentrazamide | fenchlorazole |
| 655. | flufenacet | fenchlorazole |
| 656. | mefenacet | fenchlorazole |
| 657. | metazachlor | fenchlorazole |
| 658. | metolachlor-S | fenchlorazole |
| 659. | pyroxasulfone | fenchlorazole |
| 660. | isoxaben | fenchlorazole |
| 661. | dymron | fenchlorazole |
| 662. | indanofan | fenchlorazole |
| 663. | oxaziclomefone | fenchlorazole |
| 664. | triaziflam | fenchlorazole |
| 665. | atrazine + 2-chloro-5-[3,6-dihydro-3- | fenchlorazole |
| | methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 666. | atrazine + glyphosate | fenchlorazole |
| 667. | atrazine + mesotrione | fenchlorazole |
| 668. | atrazine + nicosulfuron | fenchlorazole |
| 669. | atrazine + tembotrione | fenchlorazole |
| 670. | atrazine + topramezone | fenchlorazole |
| 671. | clomazone + glyphosate | fenchlorazole |
| 672. | diflufenican + clodinafop-propargyl | fenchlorazole |
| 673. | diflufenican + fenoxaprop-P-ethyl | fenchlorazole |
| 674. | diflufenican + flupyrsulfuron-methyl- | fenchlorazole |
| | sodium | |
| 675. | diflufenican + glyphosate | fenchlorazole |
| 676. | diflufenican + mesosulfuron-methyl | fenchlorazole |
| 677. | diflufenican + pinoxaden | fenchlorazole |
| 678. | diflufenican + pyroxsulam | fenchlorazole |
| 679. | flumetsulam + glyphosate | fenchlorazole |
| 680. | flumioxazin + glyphosate | fenchlorazole |
| 681. | imazapic + glyphosate | fenchlorazole |
| 682. | imazethapyr + glyphosate | fenchlorazole |
| 683. | isoxaflutole + 2-chloro-5-[3,6-dihydro-3- | fenchlorazole |
| | methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 684. | isoxaflutole + glyphosate | fenchlorazole |
| 685. | metazachlor + 2-chloro-5-[3,6-dihydro-3- | fenchlorazole |
| | methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 686. | metazachlor + glyphosate | fenchlorazole |
| 687. | metazachlor + mesotrione | fenchlorazole |
| 688. | metazachlor + nicosulfuron | fenchlorazole |
| 689. | metazachlor + terbuthylazine | fenchlorazole |
| 690. | metazachlor + topramezone | fenchlorazole |
| 691. | metribuzin + glyphosate | fenchlorazole |
| 692. | pendimethalin + 2-chloro-5-[3,6-dihydro- | fenchlorazole |
| | 3-methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 693. | pendimethalin + clodinafop-propargyl | fenchlorazole |
| 694. | pendimethalin + fenoxaprop-P-ethyl | fenchlorazole |
| 695. | pendimethalin + flupyrsulfuron-methyl- | fenchlorazole |
| | sodium | |
| 696. | pendimethalin + glyphosate | fenchlorazole |
| 697. | pendimethalin + mesosulfuron-methyl | fenchlorazole |
| 698. | pendimethalin + mesotrione | fenchlorazole |
| 699. | pendimethalin + nicosulfuron | fenchlorazole |
| 700. | pendimethalin + pinoxaden | fenchlorazole |
| 701. | pendimethalin + pyroxsulam | fenchlorazole |
| 702. | pendimethalin + tembotrione | fenchlorazole |
| 703. | pendimethalin + topramezone | fenchlorazole |
| 704. | pyroxasulfone + tembotrione | fenchlorazole |
| 705. | pyroxasulfone + topramezone | fenchlorazole |
| 706. | sulfentrazone + glyphosate | fenchlorazole |
| 707. | terbuthylazine + 2-chloro-5-[3,6-dihydro- | fenchlorazole |
| | 3-methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 708. | terbuthylazine + foramsulfuron | fenchlorazole |
| 709. | terbuthylazine + glyphosate | fenchlorazole |
| 710. | terbuthylazine + mesotrione | fenchlorazole |
| 711. | terbuthylazine + nicosulfuron | fenchlorazole |
| 712. | terbuthylazine + tembotrione | fenchlorazole |
| 713. | terbuthylazine + topramezone | fenchlorazole |
| 714. | trifluralin + glyphosate | fenchlorazole |
| 715. | clodinafop-propargyl | isoxadifen |
| 716. | cycloxydim | isoxadifen |
| 717. | cyhalofop-butyl | isoxadifen |
| 718. | fenoxaprop-P-ethyl | isoxadifen |
| 719. | pinoxaden | isoxadifen |
| 720. | profoxydim | isoxadifen |
| 721. | tepraloxydim | isoxadifen |
| 722. | tralkoxydim | isoxadifen |
| 723. | esprocarb | isoxadifen |
| 724. | prosulfocarb | isoxadifen |
| 725. | thiobencarb | isoxadifen |
| 726. | triallate | isoxadifen |
| 727. | bensulfuron-methyl | isoxadifen |
| 728. | bispyribac-sodium | isoxadifen |
| 729. | cyclosulfamuron | isoxadifen |
| 730. | flumetsulam | isoxadifen |
| 731. | flupyrsulfuron-methyl-sodium | isoxadifen |
| 732. | foramsulfuron | isoxadifen |
| 733. | imazamox | isoxadifen |
| 734. | imazapic | isoxadifen |
| 735. | imazapyr | isoxadifen |
| 736. | imazaquin | isoxadifen |
| 737. | imazethapyr | isoxadifen |
| 738. | imazosulfuron | isoxadifen |
| 739. | iodosulfuron-methyl-sodium | isoxadifen |
| 740. | mesosulfuron | isoxadifen |
| 741. | nicosulfuron | isoxadifen |
| 742. | penoxsulam | isoxadifen |
| 743. | propoxycarbazon-sodium | isoxadifen |
| 744. | pyrazosulfuron-ethyl | isoxadifen |
| 745. | pyroxsulam | isoxadifen |
| 746. | rimsulfuron | isoxadifen |
| 747. | sulfosulfuron | isoxadifen |
| 748. | thiencarbazone-methyl | isoxadifen |
| 749. | tritosulfuron | isoxadifen |
| 750. | 2,4-D and its salts and esters | isoxadifen |
| 751. | aminopyralid and its salts and esters | isoxadifen |
| 752. | clopyralid and its salts and esters | isoxadifen |
| 753. | dicamba and its salts and esters | isoxadifen |
| 754. | fluroxypyr-meptyl | isoxadifen |
| 755. | quinclorac | isoxadifen |
| 756. | quinmerac | isoxadifen |
| 757. | 5,6-dichloro-2-cyclopropyl-4-pyrimidine- | isoxadifen |
| | carboxylic acid (CAS 858956-08-8) | |
| 758. | diflufenzopyr | isoxadifen |
| 759. | diflufenzopyr-sodium | isoxadifen |
| 760. | clomazone | isoxadifen |
| 761. | diflufenican | isoxadifen |
| 762. | flurochloridone | isoxadifen |
| 763. | isoxaflutole | isoxadifen |
| 764. | mesotrione | isoxadifen |
| 765. | picolinafen | isoxadifen |
| 766. | sulcotrione | isoxadifen |
| 767. | tefuryltrione | isoxadifen |
| 768. | tembotrione | isoxadifen |
| 769. | topramezone | isoxadifen |
| 770. | 4-hydroxy-3-[[2-[(2-methoxyethoxy)- | isoxadifen |
| | methyl]-6-(trifluoromethyl)-3-pyridyl]- | |
| | carbonyl]bicyclo[3.2.1]oct-3-en-2-one | |
| | (CAS 352010-68-5) | |
| 771. | atrazine | isoxadifen |
| 772. | diuron | isoxadifen |
| 773. | fluometuron | isoxadifen |
| 774. | hexazinone | isoxadifen |
| 775. | isoproturon | isoxadifen |
| 776. | metribuzin | isoxadifen |
| 777. | propanil | isoxadifen |
| 778. | terbuthylazine | isoxadifen |
| 779. | paraquat-dichloride | isoxadifen |
| 780. | flumioxazin | isoxadifen |
| 781. | oxyfluorfen | isoxadifen |
| 782. | sulfentrazone | isoxadifen |
| 783. | 2-chloro-5-[3,6-dihydro-3-methyl-2,6- | isoxadifen |
| | dioxo-4-(trifluoromethyl)-1(2H)-pyrimidin- | |
| | yl]-4-fluoro-N-[(isopropyl)methyl- | |
| | sulfamoyl]benzamide (CAS 372137-35-4) | |
| 784. | ethyl [3-[2-chloro-4-fluoro-5-(1-methyl-6- | isoxadifen |
| | trifluoromethyl-2,4-dioxo-1,2,3,4- | |
| | tetrahydropyrimidin-3-yl)phenoxy]-2- | |
| | pyridyloxy]acetate (CAS 353292-31-6) | |
| 785. | glyphosate | isoxadifen |
| 786. | glyphosate-isopropylammonium | isoxadifen |
| 787. | glyphosate-trimesium (sulfosate) | isoxadifen |
| 788. | glufosinate | isoxadifen |
| 789. | glufosinate-ammonium | isoxadifen |
| 790. | pendimethalin | isoxadifen |
| 791. | trifluralin | isoxadifen |
| 792. | acetochlor | isoxadifen |
| 793. | cafenstrole | isoxadifen |
| 794. | dimethenamid-P | isoxadifen |
| 795. | fentrazamide | isoxadifen |
| 796. | flufenacet | isoxadifen |
| 797. | mefenacet | isoxadifen |
| 798. | metazachlor | isoxadifen |
| 799. | metolachlor-S | isoxadifen |
| 800. | pyroxasulfone | isoxadifen |
| 801. | isoxaben | isoxadifen |
| 802. | dymron | isoxadifen |
| 803. | indanofan | isoxadifen |
| 804. | oxaziclomefone | isoxadifen |
| 805. | triaziflam | isoxadifen |
| 806. | atrazine + 2-chloro-5-[3,6-dihydro-3- | isoxadifen |
| | methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 807. | atrazine + glyphosate | isoxadifen |
| 808. | atrazine + mesotrione | isoxadifen |
| 809. | atrazine + nicosulfuron | isoxadifen |
| 810. | atrazine + tembotrione | isoxadifen |
| 811. | atrazine + topramezone | isoxadifen |
| 812. | clomazone + glyphosate | isoxadifen |
| 813. | diflufenican + clodinafop-propargyl | isoxadifen |
| 814. | diflufenican + fenoxaprop-P-ethyl | isoxadifen |
| 815. | diflufenican + flupyrsulfuron-methyl- | isoxadifen |
| | sodium | |
| 816. | diflufenican + glyphosate | isoxadifen |
| 817. | diflufenican + mesosulfuron-methyl | isoxadifen |
| 818. | diflufenican + pinoxaden | isoxadifen |
| 819. | diflufenican + pyroxsulam | isoxadifen |
| 820. | flumetsulam + glyphosate | isoxadifen |
| 821. | flumioxazin + glyphosate | isoxadifen |
| 822. | imazapic + glyphosate | isoxadifen |
| 823. | imazethapyr + glyphosate | isoxadifen |
| 824. | isoxaflutole + 2-chloro-5-[3,6-dihydro-3- | isoxadifen |
| | methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 825. | isoxaflutole + glyphosate | isoxadifen |
| 826. | metazachlor + 2-chloro-5-[3,6-dihydro-3- | isoxadifen |
| | methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 827. | metazachlor + glyphosate | isoxadifen |
| 828. | metazachlor + mesotrione | isoxadifen |
| 829. | metazachlor + nicosulfuron | isoxadifen |
| 830. | metazachlor + terbuthylazine | isoxadifen |
| 831. | metazachlor + topramezone | isoxadifen |
| 832. | metribuzin + glyphosate | isoxadifen |
| 833. | pendimethalin + 2-chloro-5-[3,6-dihydro- | isoxadifen |
| | 3-methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 834. | pendimethalin + clodinafop-propargyl | isoxadifen |
| 835. | pendimethalin + fenoxaprop-P-ethyl | isoxadifen |
| 836. | pendimethalin + flupyrsulfuron-methyl- | isoxadifen |
| | sodium | |
| 837. | pendimethalin + glyphosate | isoxadifen |
| 838. | pendimethalin + mesosulfuron-methyl | isoxadifen |
| 839. | pendimethalin + mesotrione | isoxadifen |
| 840. | pendimethalin + nicosulfuron | isoxadifen |
| 841. | pendimethalin + pinoxaden | isoxadifen |
| 842. | pendimethalin + pyroxsulam | isoxadifen |
| 843. | pendimethalin + tembotrione | isoxadifen |
| 844. | pendimethalin + topramezone | isoxadifen |
| 845. | pyroxasulfone + tembotrione | isoxadifen |
| 846. | pyroxasulfone + topramezone | isoxadifen |
| 847. | sulfentrazone + glyphosate | isoxadifen |
| 848. | terbuthylazine + 2-chloro-5-[3,6-dihydro- | isoxadifen |
| | 3-methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 849. | terbuthylazine + foramsulfuron | isoxadifen |
| 850. | terbuthylazine + glyphosate | isoxadifen |
| 851. | terbuthylazine + mesotrione | isoxadifen |
| 852. | terbuthylazine + nicosulfuron | isoxadifen |
| 853. | terbuthylazine + tembotrione | isoxadifen |
| 854. | terbuthylazine + topramezone | isoxadifen |
| 855. | trifluralin + glyphosate | isoxadifen |
| 856. | clodinafop-propargyl | mefenpyr |
| 857. | cycloxydim | mefenpyr |
| 858. | cyhalofop-butyl | mefenpyr |
| 859. | fenoxaprop-P-ethyl | mefenpyr |
| 860. | pinoxaden | mefenpyr |
| 861. | profoxydim | mefenpyr |
| 862. | tepraloxydim | mefenpyr |
| 863. | tralkoxydim | mefenpyr |
| 864. | esprocarb | mefenpyr |
| 865. | prosulfocarb | mefenpyr |
| 866. | thiobencarb | mefenpyr |
| 867. | triallate | mefenpyr |
| 868. | bensulfuron-methyl | mefenpyr |
| 869. | bispyribac-sodium | mefenpyr |
| 870. | cyclosulfamuron | mefenpyr |
| 871. | flumetsulam | mefenpyr |
| 872. | flupyrsulfuron-methyl-sodium | mefenpyr |
| 873. | foramsulfuron | mefenpyr |
| 874. | imazamox | mefenpyr |
| 875. | imazapic | mefenpyr |
| 876. | imazapyr | mefenpyr |
| 877. | imazaquin | mefenpyr |
| 878. | imazethapyr | mefenpyr |
| 879. | imazosulfuron | mefenpyr |
| 880. | iodosulfuron-methyl-sodium | mefenpyr |
| 881. | mesosulfuron | mefenpyr |
| 882. | nicosulfuron | mefenpyr |
| 883. | penoxsulam | mefenpyr |
| 884. | propoxycarbazon-sodium | mefenpyr |
| 885. | pyrazosulfuron-ethyl | mefenpyr |
| 886. | pyroxsulam | mefenpyr |
| 887. | rimsulfuron | mefenpyr |
| 888. | sulfosulfuron | mefenpyr |
| 889. | thiencarbazone-methyl | mefenpyr |
| 890. | tritosulfuron | mefenpyr |
| 891. | 2,4-D and its salts and esters | mefenpyr |
| 892. | aminopyralid and its salts and esters | mefenpyr |
| 893. | clopyralid and its salts and esters | mefenpyr |
| 894. | dicamba and its salts and esters | mefenpyr |
| 895. | fluroxypyr-meptyl | mefenpyr |
| 896. | quinclorac | mefenpyr |
| 897. | quinmerac | mefenpyr |
| 898. | 5,6-dichloro-2-cyclopropyl-4-pyrimidine- | mefenpyr |
| | carboxylic acid (CAS 858956-08-8) | |
| 899. | diflufenzopyr | mefenpyr |
| 900. | diflufenzopyr-sodium | mefenpyr |
| 901. | clomazone | mefenpyr |
| 902. | diflufenican | mefenpyr |
| 903. | flurochloridone | mefenpyr |
| 904. | isoxaflutole | mefenpyr |
| 905. | mesotrione | mefenpyr |
| 906. | picolinafen | mefenpyr |
| 907. | sulcotrione | mefenpyr |
| 908. | tefuryltrione | mefenpyr |
| 909. | tembotrione | mefenpyr |
| 910. | topramezone | mefenpyr |
| 911. | 4-hydroxy-3-[[2-[(2-methoxyethoxy)- | mefenpyr |
| | methyl]-6-(trifluoromethyl)-3-pyridyl]- | |
| | carbonyl]bicyclo[3.2.1]oct-3-en-2-one | |
| | (CAS 352010-68-5) | |
| 912. | atrazine | mefenpyr |
| 913. | diuron | mefenpyr |
| 914. | fluometuron | mefenpyr |
| 915. | hexazinone | mefenpyr |
| 916. | isoproturon | mefenpyr |
| 917. | metribuzin | mefenpyr |
| 918. | propanil | mefenpyr |
| 919. | terbuthylazine | mefenpyr |
| 920. | paraquat-dichloride | mefenpyr |
| 921. | flumioxazin | mefenpyr |
| 922. | oxyfluorfen | mefenpyr |
| 923. | sulfentrazone | mefenpyr |
| 924. | 2-chloro-5-[3,6-dihydro-3-methyl-2,6- | mefenpyr |
| | dioxo-4-(trifluoromethyl)-1(2H)-pyrimidin- | |
| | yl]-4-fluoro-N-[(isopropyl)methyl- | |
| | sulfamoyl]benzamide (CAS 372137-35-4) | |
| 925. | ethyl [3-[2-chloro-4-fluoro-5-(1-methyl-6- | mefenpyr |
| | trifluoromethyl-2,4-dioxo-1,2,3,4- | |
| | tetrahydropyrimidin-3-yl)phenoxy]-2- | |
| | pyridyloxy]acetate (CAS 353292-31-6) | |
| 926. | glyphosate | mefenpyr |
| 927. | glyphosate-isopropylammonium | mefenpyr |
| 928. | glyphosate-trimesium (sulfosate) | mefenpyr |
| 929. | glufosinate | mefenpyr |
| 930. | glufosinate-ammonium | mefenpyr |
| 931. | pendimethalin | mefenpyr |
| 932. | trifluralin | mefenpyr |
| 933. | acetochlor | mefenpyr |
| 934. | cafenstrole | mefenpyr |
| 935. | dimethenamid-P | mefenpyr |
| 936. | fentrazamide | mefenpyr |
| 937. | flufenacet | mefenpyr |
| 938. | mefenacet | mefenpyr |
| 939. | metazachlor | mefenpyr |
| 940. | metolachlor-S | mefenpyr |
| 941. | pyroxasulfone | mefenpyr |
| 942. | isoxaben | mefenpyr |
| 943. | dymron | mefenpyr |
| 944. | indanofan | mefenpyr |
| 945. | oxaziclomefone | mefenpyr |
| 946. | triaziflam | mefenpyr |
| 947. | atrazine + 2-chloro-5-[3,6-dihydro-3- | mefenpyr |
| | methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 948. | atrazine + glyphosate | mefenpyr |
| 949. | atrazine + mesotrione | mefenpyr |
| 950. | atrazine + nicosulfuron | mefenpyr |
| 951. | atrazine + tembotrione | mefenpyr |
| 952. | atrazine + topramezone | mefenpyr |
| 953. | clomazone + glyphosate | mefenpyr |
| 954. | diflufenican + clodinafop-propargyl | mefenpyr |
| 955. | diflufenican + fenoxaprop-P-ethyl | mefenpyr |
| 956. | diflufenican + flupyrsulfuron-methyl- | mefenpyr |
| | sodium | |
| 957. | diflufenican + glyphosate | mefenpyr |
| 958. | diflufenican + mesosulfuron-methyl | mefenpyr |
| 959. | diflufenican + pinoxaden | mefenpyr |
| 960. | diflufenican + pyroxsulam | mefenpyr |
| 961. | flumetsulam + glyphosate | mefenpyr |
| 962. | flumioxazin + glyphosate | mefenpyr |
| 963. | imazapic + glyphosate | mefenpyr |
| 964. | imazethapyr + glyphosate | mefenpyr |
| 965. | isoxaflutole + 2-chloro-5-[3,6-dihydro-3- | mefenpyr |
| | methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 966. | isoxaflutole + glyphosate | mefenpyr |
| 967. | metazachlor + 2-chloro-5-[3,6-dihydro-3- | mefenpyr |
| | methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 968. | metazachlor + glyphosate | mefenpyr |
| 969. | metazachlor + mesotrione | mefenpyr |
| 970. | metazachlor + nicosulfuron | mefenpyr |
| 971. | metazachlor + terbuthylazine | mefenpyr |
| 972. | metazachlor + topramezone | mefenpyr |
| 973. | metribuzin + glyphosate | mefenpyr |
| 974. | pendimethalin + 2-chloro-5-[3,6-dihydro- | mefenpyr |
| | 3-methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 975. | pendimethalin + clodinafop-propargyl | mefenpyr |
| 976. | pendimethalin + fenoxaprop-P-ethyl | mefenpyr |
| 977. | pendimethalin + flupyrsulfuron-methyl- | mefenpyr |
| | sodium | |
| 978. | pendimethalin + glyphosate | mefenpyr |
| 979. | pendimethalin + mesosulfuron-methyl | mefenpyr |
| 980. | pendimethalin + mesotrione | mefenpyr |
| 981. | pendimethalin + nicosulfuron | mefenpyr |
| 982. | pendimethalin + pinoxaden | mefenpyr |
| 983. | pendimethalin + pyroxsulam | mefenpyr |
| 984. | pendimethalin + tembotrione | mefenpyr |
| 985. | pendimethalin + topramezone | mefenpyr |
| 986. | pyroxasulfone + tembotrione | mefenpyr |
| 987. | pyroxasulfone + topramezone | mefenpyr |
| 988. | sulfentrazone + glyphosate | mefenpyr |
| 989. | terbuthylazine + 2-chloro-5-[3,6-dihydro- | mefenpyr |
| | 3-methyl-2,6-dioxo-4-(trifluoromethyl)- | |
| | 1(2H)-pyrimidinyl]-4-fluoro-N-[(isopropyl)- | |
| | methylsulfamoyl]benzamide (CAS | |
| | 372137-35-4) | |
| 990. | terbuthylazine + foramsulfuron | mefenpyr |
| 991. | terbuthylazine + glyphosate | mefenpyr |
| 992. | terbuthylazine + mesotrione | mefenpyr |
| 993. | terbuthylazine + nicosulfuron | mefenpyr |
| 994. | terbuthylazine + tembotrione | mefenpyr |
| 995. | terbuthylazine + topramezone | mefenpyr |
| 996. | trifluralin + glyphosate | mefenpyr |
| 997. | clodinafop-propargyl | 2,2,5-trimethyl-3-(dichloro- |
| | | acetyl)-1,3-oxazolidine |
| | | (R-29148, CAS 52836-31-4) |
| 998. | cycloxydim | 2,2,5-trimethyl-3-(dichloro- |
| | | acetyl)-1,3-oxazolidine |
| | | (R-29148, CAS 52836-31-4) |
| 999. | cyhalofop-butyl | 2,2,5-trimethyl-3-(dichloro- |
| | | acetyl)-1,3-oxazolidine |
| | | (R-29148, CAS 52836-31-4) |
| 1000. | fenoxaprop-P-ethyl | 2,2,5-trimethyl-3-(dichloro- |
| | | acetyl)-1,3-oxazolidine |
| | | (R-29148, CAS 52836-31-4) |
| 1001. | pinoxaden | 2,2,5-trimethyl-3-(dichloro- |
| | | acetyl)-1,3-oxazolidine |
| | | (R-29148, CAS 52836-31-4) |
| 1002. | profoxydim | 2,2,5-trimethyl-3-(dichloro- |
| | | acetyl)-1,3-oxazolidine |
| | | (R-29148, CAS 52836-31-4) |
| 1003. | tepraloxydim | 2,2,5-trimethyl-3-(dichloro- |
| | | acetyl)-1,3-oxazolidine |
| | | (R-29148, CAS 52836-31-4) |
| 1004. | tralkoxydim | 2,2,5-trimethyl-3-(dichloro- |
| | | acetyl)-1,3-oxazolidine |
| | | (R-29148, CAS 52836-31-4) |
| 1005. | esprocarb | 2,2,5-trimethyl-3-(dichloro- |
| | | acetyl)-1,3-oxazolidine |
| | | (R-29148, CAS 52836-31-4) |
| 1006. | prosulfocarb | 2,2,5-trimethyl-3-(dichloro- |
| | | acetyl)-1,3-oxazolidine |
| | | (R-29148, CAS 52836-31-4) |
| 1007. | thiobencarb | 2,2,5-trimethyl-3-(dichloro- |
| | | acetyl)-1,3-oxazolidine |
| | | (R-29148, CAS 52836-31-4) |
| 1008. | triallate | 2,2,5-trimethyl-3-(dichloro- |
| | | acetyl)-1,3-oxazolidine |
| | | (R-29148, CAS 52836-31-4) |
| 1009. | bensulfuron-methyl | 2,2,5-trimethyl-3-(dichloro- |
| | | acetyl)-1,3-oxazolidine |
| | | (R-29148, CAS 52836-31-4) |
| 1010. | bispyribac-sodium | 2,2,5-trimethyl-3-(dichloro- |
| | | acetyl)-1,3-oxazolidine |
| | | (R-29148, CAS 52836-31-4) |
| 1011. | cyclosulfamuron | 2,2,5-trimethyl-3-(dichloro- |
| | | acetyl)-1,3-oxazolidine |
| | | (R-29148, CAS 52836-31-4) |
| 1012. | flumetsulam | 2,2,5-trimethyl-3-(dichloro- |
| | | acetyl)-1,3-oxazolidine |
| | | (R-29148, CAS 52836-31-4) |
| 1013. | flupyrsulfuron-methyl-sodium | 2,2,5-trimethyl-3-(dichloro- |
| | | acetyl)-1,3-oxazolidine |
| | | (R-29148, CAS 52836-31-4) |
| 1014. | foramsulfuron | 2,2,5-trimethyl-3-(dichloro- |
| | | acetyl)-1,3-oxazolidine |
| | | (R-29148, CAS 52836-31-4) |
| 1015. | imazamox | 2,2,5-trimethyl-3-(dichloro- |
| | | acetyl)-1,3-oxazolidine |
| | | (R-29148, CAS 52836-31-4) |
| 1016. | imazapic | 2,2,5-trimethyl-3-(dichloro- |
| | | acetyl)-1,3-oxazolidine |
| | | (R-29148, CAS 52836-31-4) |
| 1017. | imazapyr | 2,2,5-trimethyl-3-(dichloro- |
| | | acetyl)-1,3-oxazolidine |
| | | (R-29148, CAS 52836-31-4) |
| 1018. | imazaquin | 2,2,5-trimethyl-3-(dichloro- |
| | | acetyl)-1,3-oxazolidine |
| | | (R-29148, CAS 52836-31-4) |
| 1019. | imazethapyr | 2,2,5-trimethyl-3-(dichloro- |
| | | acetyl)-1,3-oxazolidine |
| | | (R-29148, CAS 52836-31-4) |
| 1020. | imazosulfuron | 2,2,5-trimethyl-3-(dichloro- |
| | | acetyl)-1,3-oxazolidine |
| | | (R-29148, CAS 52836-31-4) |
| 1021. | iodosulfuron-methyl-sodium | 2,2,5-trimethyl-3-(dichloro- |
| | | acetyl)-1,3-oxazolidine |
| | | (R-29148, CAS 52836-31-4) |
| 1022. | mesosulfuron | 2,2,5-trimethyl-3-(dichloro- |
| | | acetyl)-1,3-oxazolidine |
| | | (R-29148, CAS 52836-31-4) |
| 1023. | nicosulfuron | 2,2,5-trimethyl-3-(dichloro- |
| | | acetyl)-1,3-oxazolidine |
| | | (R-29148, CAS 52836-31-4) |
| 1024. | penoxsulam | 2,2,5-trimethyl-3-(dichloro- |
| | | acetyl)-1,3-oxazolidine |
| | | (R-29148, CAS 52836-31-4) |
| 1025. | propoxycarbazon-sodium | 2,2,5-trimethyl-3-(dichloro- |
| | | acetyl)-1,3-oxazolidine |
| | | (R-29148, CAS 52836-31-4) |
| 1026. | pyrazosulfuron-ethyl | 2,2,5-trimethyl-3-(dichloro- |
| | | acetyl)-1,3-oxazolidine |
| | | (R-29148, CAS 52836-31-4) |
| 1027. | pyroxsulam | 2,2,5-trimethyl-3-(dichloro- |
| | | acetyl)-1,3-oxazolidine |
| | | (R-29148, CAS 52836-31-4) |
| 1028. | rimsulfuron | 2,2,5-trimethyl-3-(dichloro- |
| | | acetyl)-1,3-oxazolidine |
| | | (R-29148, CAS 52836-31-4) |
| 1029. | sulfosulfuron | 2,2,5-trimethyl-3-(dichloro- |
| | | acetyl)-1,3-oxazolidine |
| | | (R-29148, CAS 52836-31-4) |
| 1030. | thiencarbazone-methyl | 2,2,5-trimethyl-3-(dichloro- |
| | | acetyl)-1,3-oxazolidine |
| | | (R-29148, CAS 52836-31-4) |
| 1031. | tritosulfuron | 2,2,5-trimethyl-3-(dichloro- |
| | | acetyl)-1,3-oxazolidine |
| | | (R-29148, CAS 52836-31-4) |
| 1032. | 2,4-D and its salts and esters | 2,2,5-trimethyl-3-(dichloro- |
| | | acetyl)-1,3-oxazolidine |
| | | (R-29148, CAS 52836-31-4) |
| 1033. | aminopyralid and its salts and esters | 2,2,5-trimethyl-3-(dichloro- |
| | | acetyl)-1,3-oxazolidine |
| | | (R-29148, CAS 52836-31-4) |
| 1034. | clopyralid and its salts and esters | 2,2,5-trimethyl-3-(dichloro- |
| | | acetyl)-1,3-oxazolidine |
| | | (R-29148, CAS 52836-31-4) |
| 1035. | dicamba and its salts and esters | 2,2,5-trimethyl-3-(dichloro- |
| | | acetyl)-1,3-oxazolidine |
| | | (R-29148, CAS 52836-31-4) |
| 1036. | fluroxypyr-meptyl | 2,2,5-trimethyl-3-(dichloro- |
| | | acetyl)-1,3-oxazolidine |
| | | (R-29148, CAS 52836-31-4) |
| 1037. | quinclorac | 2,2,5-trimethyl-3-(dichloro- |
| | | acetyl)-1,3-oxazolidine |
| | | (R-29148, CAS 52836-31-4) |
| 1038. | quinmerac | 2,2,5-trimethyl-3-(dichloro- |
| | | acetyl)-1,3-oxazolidine |
| | | (R-29148, CAS 52836-31-4) |
| 1039. | 5,6-dichloro-2-cyclopropyl-4-pyrimidine- | 2,2,5-trimethyl-3-(dichloro- |
| | carboxylic acid (CAS 858956-08-8) | acetyl)-1,3-oxazolidine |
| | | (R-29148, CAS 52836-31-4) |
| 1040. | diflufenzopyr | 2,2,5-trimethyl-3-(dichloro- |
| | | acetyl)-1,3-oxazolidine |
| | | (R-29148, CAS 52836-31-4) |
| 1041. | diflufenzopyr-sodium | 2,2,5-trimethyl-3-(dichloro- |
| | | acetyl)-1,3-oxazolidine |
| | | (R-29148, CAS 52836-31-4) |
| 1042. | clomazone | 2,2,5-trimethyl-3-(dichloro- |
| | | acetyl)-1,3-oxazolidine |
| | | (R-29148, CAS 52836-31-4) |
| 1043. | diflufenican | 2,2,5-trimethyl-3-(dichloro- |
| | | acetyl)-1,3-oxazolidine |
| | | (R-29148, CAS 52836-31-4) |
| 1044. | flurochloridone | 2,2,5-trimethyl-3-(dichloro- |
| | | acetyl)-1,3-oxazolidine |
| | | (R-29148, CAS 52836-31-4) |
| 1045. | isoxaflutole | 2,2,5-trimethyl-3-(dichloro- |
| | | acetyl)-1,3-oxazolidine |
| | | (R-29148, CAS 52836-31-4) |
| 1046. | mesotrione | 2,2,5-trimethyl-3-(dichloro- |
| | | acetyl)-1,3-oxazolidine |
| | | (R-29148, CAS 52836-31-4) |
| 1047. | picolinafen | 2,2,5-trimethyl-3-(dichloro- |
| | | acetyl)-1,3-oxazolidine |
| | | (R-29148, CAS 52836-31-4) |
| 1048. | sulcotrione | 2,2,5-trimethyl-3-(dichloro- |
| | | acetyl)-1,3-oxazolidine |
| | | (R-29148, CAS 52836-31-4) |
| 1049. | tefuryltrione | 2,2,5-trimethyl-3-(dichloro- |
| | | acetyl)-1,3-oxazolidine |
| | | (R-29148, CAS 52836-31-4) |
| 1050. | tembotrione | 2,2,5-trimethyl-3-(dichloro- |
| | | acetyl)-1,3-oxazolidine |
| | | (R-29148, CAS 52836-31-4) |
| 1051. | topramezone | 2,2,5-trimethyl-3-(dichloro- |
| | | acetyl)-1,3-oxazolidine |
| | | (R-29148, CAS 52836-31-4) |
| 1052. | 4-hydroxy-3-[[2-[(2-methoxyethoxy)- | 2,2,5-trimethyl-3-(dichloro- |
| | methyl]-6-(trifluoromethyl)-3-pyridyl]- | acetyl)-1,3-oxazolidine |
| | carbonyl]bicyclo[3.2.1]oct-3-en-2-one | (R-29148, CAS 52836-31-4) |
| | (CAS 352010-68-5) | |
| 1053. | atrazine | 2,2,5-trimethyl-3-(dichloro- |
| | | acetyl)-1,3-oxazolidine |
| | | (R-29148, CAS 52836-31-4) |
| 1054. | diuron | 2,2,5-trimethyl-3-(dichloro- |
| | | acetyl)-1,3-oxazolidine |
| | | (R-29148, CAS 52836-31-4) |
| 1055. | fluometuron | 2,2,5-trimethyl-3-(dichloro- |
| | | acetyl)-1,3-oxazolidine |
| | | (R-29148, CAS 52836-31-4) |
| 1056. | hexazinone | 2,2,5-trimethyl-3-(dichloro- |
| | | acetyl)-1,3-oxazolidine |
| | | (R-29148, CAS 52836-31-4) |
| 1057. | isoproturon | 2,2,5-trimethyl-3-(dichloro- |
| | | acetyl)-1,3-oxazolidine |
| | | (R-29148, CAS 52836-31-4) |
| 1058. | metribuzin | 2,2,5-trimethyl-3-(dichloro- |
| | | acetyl)-1,3-oxazolidine |
| | | (R-29148, CAS 52836-31-4) |
| 1059. | propanil | 2,2,5-trimethyl-3-(dichloro- |
| | | acetyl)-1,3-oxazolidine |
| | | (R-29148, CAS 52836-31-4) |
| 1060. | terbuthylazine | 2,2,5-trimethyl-3-(dichloro- |
| | | acetyl)-1,3-oxazolidine |
| | | (R-29148, CAS 52836-31-4) |
| 1061. | paraquat-dichloride | 2,2,5-trimethyl-3-(dichloro- |
| | | acetyl)-1,3-oxazolidine |
| | | (R-29148, CAS 52836-31-4) |
| 1062. | flumioxazin | 2,2,5-trimethyl-3-(dichloro- |
| | | acetyl)-1,3-oxazolidine |
| | | (R-29148, CAS 52836-31-4) |
| 1063. | oxyfluorfen | 2,2,5-trimethyl-3-(dichloro- |
| | | acetyl)-1,3-oxazolidine |
| | | (R-29148, CAS 52836-31-4) |
| 1064. | sulfentrazone | 2,2,5-trimethyl-3-(dichloro- |
| | | acetyl)-1,3-oxazolidine |
| | | (R-29148, CAS 52836-31-4) |
| 1065. | 2-chloro-5-[3,6-dihydro-3-methyl-2,6- | 2,2,5-trimethyl-3-(dichloro- |
| | dioxo-4-(trifluoromethyl)-1(2H)-pyrimidin- | acetyl)-1,3-oxazolidine |
| | yl]-4-fluoro-N-[(isopropyl)methyl- | (R-29148, CAS 52836-31-4) |
| | sulfamoyl]benzamide (CAS 372137-35-4) | |
| 1066. | ethyl [3-[2-chloro-4-fluoro-5-(1-methyl-6- | 2,2,5-trimethyl-3-(dichloro- |
| | trifluoromethyl-2,4-dioxo-1,2,3,4- | acetyl)-1,3-oxazolidine |
| | tetrahydropyrimidin-3-yl)phenoxy]-2- | (R-29148, CAS 52836-31-4) |
| | pyridyloxy]acetate (CAS 353292-31-6) | |
| 1067. | glyphosate | 2,2,5-trimethyl-3-(dichloro- |
| | | acetyl)-1,3-oxazolidine |
| | | (R-29148, CAS 52836-31-4) |
| 1068. | glyphosate-isopropylammonium | 2,2,5-trimethyl-3-(dichloro- |
| | | acetyl)-1,3-oxazolidine |
| | | (R-29148, CAS 52836-31-4) |
| 1069. | glyphosate-trimesium (sulfosate) | 2,2,5-trimethyl-3-(dichloro- |
| | | acetyl)-1,3-oxazolidine |
| | | (R-29148, CAS 52836-31-4) |
| 1070. | glufosinate | 2,2,5-trimethyl-3-(dichloro- |
| | | acetyl)-1,3-oxazolidine |
| | | (R-29148, CAS 52836-31-4) |
| 1071. | glufosinate-ammonium | 2,2,5-trimethyl-3-(dichloro- |
| | | acetyl)-1,3-oxazolidine |
| | | (R-29148, CAS 52836-31-4) |
| 1072. | pendimethalin | 2,2,5-trimethyl-3-(dichloro- |
| | | acetyl)-1,3-oxazolidine |
| | | (R-29148, CAS 52836-31-4) |
| 1073. | trifluralin | 2,2,5-trimethyl-3-(dichloro- |
| | | acetyl)-1,3-oxazolidine |
| | | (R-29148, CAS 52836-31-4) |
| 1074. | acetochlor | 2,2,5-trimethyl-3-(dichloro- |
| | | acetyl)-1,3-oxazolidine |
| | | (R-29148, CAS 52836-31-4) |
| 1075. | cafenstrole | 2,2,5-trimethyl-3-(dichloro- |
| | | acetyl)-1,3-oxazolidine |
| | | (R-29148, CAS 52836-31-4) |
| 1076. | dimethenamid-P | 2,2,5-trimethyl-3-(dichloro- |
| | | acetyl)-1,3-oxazolidine |
| | | (R-29148, CAS 52836-31-4) |
| 1077. | fentrazamide | 2,2,5-trimethyl-3-(dichloro- |
| | | acetyl)-1,3-oxazolidine |
| | | (R-29148, CAS 52836-31-4) |
| 1078. | flufenacet | 2,2,5-trimethyl-3-(dichloro- |
| | | acetyl)-1,3-oxazolidine |
| | | (R-29148, CAS 52836-31-4) |
| 1079. | mefenacet | 2,2,5-trimethyl-3-(dichloro- |
| | | acetyl)-1,3-oxazolidine |
| | | (R-29148, CAS 52836-31-4) |
| 1080. | metazachlor | 2,2,5-trimethyl-3-(dichloro- |
| | | acetyl)-1,3-oxazolidine |
| | | (R-29148, CAS 52836-31-4) |
| 1081. | metolachlor-S | 2,2,5-trimethyl-3-(dichloro- |
| | | acetyl)-1,3-oxazolidine |
| | | (R-29148, CAS 52836-31-4) |
| 1082. | pyroxasulfone | 2,2,5-trimethyl-3-(dichloro- |
| | | acetyl)-1,3-oxazolidine |
| | | (R-29148, CAS 52836-31-4) |
| 1083. | isoxaben | 2,2,5-trimethyl-3-(dichloro- |
| | | acetyl)-1,3-oxazolidine |
| | | (R-29148, CAS 52836-31-4) |
| 1084. | dymron | 2,2,5-trimethyl-3-(dichloro- |
| | | acetyl)-1,3-oxazolidine |
| | | (R-29148, CAS 52836-31-4) |
| 1085. | indanofan | 2,2,5-trimethyl-3-(dichloro- |
| | | acetyl)-1,3-oxazolidine |
| | | (R-29148, CAS 52836-31-4) |
| 1086. | oxaziclomefone | 2,2,5-trimethyl-3-(dichloro- |
| | | acetyl)-1,3-oxazolidine |
| | | (R-29148, CAS 52836-31-4) |
| 1087. | triaziflam | 2,2,5-trimethyl-3-(dichloro- |
| | | acetyl)-1,3-oxazolidine |
| | | (R-29148, CAS 52836-31-4) |
| 1088. | atrazine + 2-chloro-5-[3,6-dihydro-3- | 2,2,5-trimethyl-3-(dichloro- |
| | methyl-2,6-dioxo-4-(trifluoromethyl)- | acetyl)-1,3-oxazolidine |
| | 1(2H)-pyrimidinyl]-4-fluoro-N-[(isopropyl)- | (R-29148, CAS 52836-31-4) |
| | methylsulfamoyl]benzamide (CAS | |
| | 372137-35-4) | |
| 1089. | atrazine + glyphosate | 2,2,5-trimethyl-3-(dichloro- |
| | | acetyl)-1,3-oxazolidine |
| | | (R-29148, CAS 52836-31-4) |
| 1090. | atrazine + mesotrione | 2,2,5-trimethyl-3-(dichloro- |
| | | acetyl)-1,3-oxazolidine |
| | | (R-29148, CAS 52836-31-4) |
| 1091. | atrazine + nicosulfuron | 2,2,5-trimethyl-3-(dichloro- |
| | | acetyl)-1,3-oxazolidine |
| | | (R-29148, CAS 52836-31-4) |
| 1092. | atrazine + tembotrione | 2,2,5-trimethyl-3-(dichloro- |
| | | acetyl)-1,3-oxazolidine |
| | | (R-29148, CAS 52836-31-4) |
| 1093. | atrazine + topramezone | 2,2,5-trimethyl-3-(dichloro- |
| | | acetyl)-1,3-oxazolidine |
| | | (R-29148, CAS 52836-31-4) |
| 1094. | clomazone + glyphosate | 2,2,5-trimethyl-3-(dichloro- |
| | | acetyl)-1,3-oxazolidine |
| | | (R-29148, CAS 52836-31-4) |
| 1095. | diflufenican + clodinafop-propargyl | 2,2,5-trimethyl-3-(dichloro- |
| | | acetyl)-1,3-oxazolidine |
| | | (R-29148, CAS 52836-31-4) |
| 1096. | diflufenican + fenoxaprop-P-ethyl | 2,2,5-trimethyl-3-(dichloro- |
| | | acetyl)-1,3-oxazolidine |
| | | (R-29148, CAS 52836-31-4) |
| 1097. | diflufenican + flupyrsulfuron-methyl- | 2,2,5-trimethyl-3-(dichloro- |
| | sodium | acetyl)-1,3-oxazolidine |
| | | (R-29148, CAS 52836-31-4) |
| 1098. | diflufenican + glyphosate | 2,2,5-trimethyl-3-(dichloro- |
| | | acetyl)-1,3-oxazolidine |
| | | (R-29148, CAS 52836-31-4) |
| 1099. | diflufenican + mesosulfuron-methyl | 2,2,5-trimethyl-3-(dichloro- |
| | | acetyl)-1,3-oxazolidine |
| | | (R-29148, CAS 52836-31-4) |
| 1100. | diflufenican + pinoxaden | 2,2,5-trimethyl-3-(dichloro- |
| | | acetyl)-1,3-oxazolidine |
| | | (R-29148, CAS 52836-31-4) |
| 1101. | diflufenican + pyroxsulam | 2,2,5-trimethyl-3-(dichloro- |
| | | acetyl)-1,3-oxazolidine |
| | | (R-29148, CAS 52836-31-4) |
| 1102. | flumetsulam + glyphosate | 2,2,5-trimethyl-3-(dichloro- |
| | | acetyl)-1,3-oxazolidine |
| | | (R-29148, CAS 52836-31-4) |
| 1103. | flumioxazin + glyphosate | 2,2,5-trimethyl-3-(dichloro- |
| | | acetyl)-1,3-oxazolidine |
| | | (R-29148, CAS 52836-31-4) |
| 1104. | imazapic + glyphosate | 2,2,5-trimethyl-3-(dichloro- |
| | | acetyl)-1,3-oxazolidine |
| | | (R-29148, CAS 52836-31-4) |
| 1105. | imazethapyr + glyphosate | 2,2,5-trimethyl-3-(dichloro- |
| | | acetyl)-1,3-oxazolidine |
| | | (R-29148, CAS 52836-31-4) |
| 1106. | isoxaflutole + 2-chloro-5-[3,6-dihydro-3- | 2,2,5-trimethyl-3-(dichloro- |
| | methyl-2,6-dioxo-4-(trifluoromethyl)- | acetyl)-1,3-oxazolidine |
| | 1(2H)-pyrimidinyl]-4-fluoro-N-[(isopropyl)- | (R-29148, CAS 52836-31-4) |
| | methylsulfamoyl]benzamide (CAS | |
| | 372137-35-4) | |
| 1107. | isoxaflutole + glyphosate | 2,2,5-trimethyl-3-(dichloro- |
| | | acetyl)-1,3-oxazolidine |
| | | (R-29148, CAS 52836-31-4) |
| 1108. | metazachlor + 2-chloro-5-[3,6-dihydro-3- | 2,2,5-trimethyl-3-(dichloro- |
| | methyl-2,6-dioxo-4-(trifluoromethyl)- | acetyl)-1,3-oxazolidine |
| | 1(2H)-pyrimidinyl]-4-fluoro-N-[(isopropyl)- | (R-29148, CAS 52836-31-4) |
| | methylsulfamoyl]benzamide (CAS | |
| | 372137-35-4) | |
| 1109. | metazachlor + glyphosate | 2,2,5-trimethyl-3-(dichloro- |
| | | acetyl)-1,3-oxazolidine |
| | | (R-29148, CAS 52836-31-4) |
| 1110. | metazachlor + mesotrione | 2,2,5-trimethyl-3-(dichloro- |
| | | acetyl)-1,3-oxazolidine |
| | | (R-29148, CAS 52836-31-4) |
| 1111. | metazachlor + nicosulfuron | 2,2,5-trimethyl-3-(dichloro- |
| | | acetyl)-1,3-oxazolidine |
| | | (R-29148, CAS 52836-31-4) |
| 1112. | metazachlor + terbuthylazine | 2,2,5-trimethyl-3-(dichloro- |
| | | acetyl)-1,3-oxazolidine |
| | | (R-29148, CAS 52836-31-4) |
| 1113. | metazachlor + topramezone | 2,2,5-trimethyl-3-(dichloro- |
| | | acetyl)-1,3-oxazolidine |
| | | (R-29148, CAS 52836-31-4) |
| 1114. | metribuzin + glyphosate | 2,2,5-trimethyl-3-(dichloro- |
| | | acetyl)-1,3-oxazolidine |
| | | (R-29148, CAS 52836-31-4) |
| 1115. | pendimethalin + 2-chloro-5-[3,6-dihydro- | 2,2,5-trimethyl-3-(dichloro- |
| | 3-methyl-2,6-dioxo-4-(trifluoromethyl)- | acetyl)-1,3-oxazolidine |
| | 1(2H)-pyrimidinyl]-4-fluoro-N-[(isopropyl)- | (R-29148, CAS 52836-31-4) |
| | methylsulfamoyl]benzamide (CAS | |
| | 372137-35-4) | |
| 1116. | pendimethalin + clodinafop-propargyl | 2,2,5-trimethyl-3-(dichloro- |
| | | acetyl)-1,3-oxazolidine |
| | | (R-29148, CAS 52836-31-4) |
| 1117. | pendimethalin + fenoxaprop-P-ethyl | 2,2,5-trimethyl-3-(dichloro- |
| | | acetyl)-1,3-oxazolidine |
| | | (R-29148, CAS 52836-31-4) |
| 1118. | pendimethalin + flupyrsulfuron-methyl- | 2,2,5-trimethyl-3-(dichloro- |
| | sodium | acetyl)-1,3-oxazolidine |
| | | (R-29148, CAS 52836-31-4) |
| 1119. | pendimethalin + glyphosate | 2,2,5-trimethyl-3-(dichloro- |
| | | acetyl)-1,3-oxazolidine |
| | | (R-29148, CAS 52836-31-4) |
| 1120. | pendimethalin + mesosulfuron-methyl | 2,2,5-trimethyl-3-(dichloro- |
| | | acetyl)-1,3-oxazolidine |
| | | (R-29148, CAS 52836-31-4) |
| 1121. | pendimethalin + mesotrione | 2,2,5-trimethyl-3-(dichloro- |
| | | acetyl)-1,3-oxazolidine |
| | | (R-29148, CAS 52836-31-4) |
| 1122. | pendimethalin + nicosulfuron | 2,2,5-trimethyl-3-(dichloro- |
| | | acetyl)-1,3-oxazolidine |
| | | (R-29148, CAS 52836-31-4) |
| 1123. | pendimethalin + pinoxaden | 2,2,5-trimethyl-3-(dichloro- |
| | | acetyl)-1,3-oxazolidine |
| | | (R-29148, CAS 52836-31-4) |
| 1124. | pendimethalin + pyroxsulam | 2,2,5-trimethyl-3-(dichloro- |
| | | acetyl)-1,3-oxazolidine |
| | | (R-29148, CAS 52836-31-4) |
| 1125. | pendimethalin + tembotrione | 2,2,5-trimethyl-3-(dichloro- |
| | | acetyl)-1,3-oxazolidine |
| | | (R-29148, CAS 52836-31-4) |
| 1126. | pendimethalin + topramezone | 2,2,5-trimethyl-3-(dichloro- |
| | | acetyl)-1,3-oxazolidine |
| | | (R-29148, CAS 52836-31-4) |
| 1127. | pyroxasulfone + tembotrione | 2,2,5-trimethyl-3-(dichloro- |
| | | acetyl)-1,3-oxazolidine |
| | | (R-29148, CAS 52836-31-4) |
| 1128. | pyroxasulfone + topramezone | 2,2,5-trimethyl-3-(dichloro- |
| | | acetyl)-1,3-oxazolidine |
| | | (R-29148, CAS 52836-31-4) |
| 1129. | sulfentrazone + glyphosate | 2,2,5-trimethyl-3-(dichloro- |
| | | acetyl)-1,3-oxazolidine |
| | | (R-29148, CAS 52836-31-4) |
| 1130. | terbuthylazine + 2-chloro-5-[3,6-dihydro- | 2,2,5-trimethyl-3-(dichloro- |
| | 3-methyl-2,6-dioxo-4-(trifluoromethyl)- | acetyl)-1,3-oxazolidine |
| | 1(2H)-pyrimidinyl]-4-fluoro-N-[(isopropyl)- | (R-29148, CAS 52836-31-4) |
| | methylsulfamoyl]benzamide (CAS | |
| | 372137-35-4) | |
| 1131. | terbuthylazine + foramsulfuron | 2,2,5-trimethyl-3-(dichloro- |
| | | acetyl)-1,3-oxazolidine |
| | | (R-29148, CAS 52836-31-4) |
| 1132. | terbuthylazine + glyphosate | 2,2,5-trimethyl-3-(dichloro- |
| | | acetyl)-1,3-oxazolidine |
| | | (R-29148, CAS 52836-31-4) |
| 1133. | terbuthylazine + mesotrione | 2,2,5-trimethyl-3-(dichloro- |
| | | acetyl)-1,3-oxazolidine |
| | | (R-29148, CAS 52836-31-4) |
| 1134. | terbuthylazine + nicosulfuron | 2,2,5-trimethyl-3-(dichloro- |
| | | acetyl)-1,3-oxazolidine |
| | | (R-29148, CAS 52836-31-4) |
| 1135. | terbuthylazine + tembotrione | 2,2,5-trimethyl-3-(dichloro- |
| | | acetyl)-1,3-oxazolidine |
| | | (R-29148, CAS 52836-31-4) |
| 1136. | terbuthylazine + topramezone | 2,2,5-trimethyl-3-(dichloro- |
| | | acetyl)-1,3-oxazolidine |
| | | (R-29148, CAS 52836-31-4) |
| 1137. | trifluralin + glyphosate | 2,2,5-trimethyl-3-(dichloro- |
| | | acetyl)-1,3-oxazolidine |
| | | (R-29148, CAS 52836-31-4) |
| 1138. | II.1 | — |
| 1139. | II.2 | — |
| 1140. | II.3 | — |
| 1141. | II.4 | — |
| 1142. | II.5 | — |
| 1143. | II.6 | — |
| 1144. | II.7 | — |
| 1145. | II.8 | — |
| 1146. | II.9 | — |
| 1147. | II.1 | benoxacor |
| 1148. | II.2 | benoxacor |
| 1149. | II.3 | benoxacor |
| 1150. | II.4 | benoxacor |
| 1151. | II.5 | benoxacor |
| 1152. | II.6 | benoxacor |
| 1153. | II.7 | benoxacor |
| 1154. | II.8 | benoxacor |
| 1155. | II.9 | benoxacor |
| 1156. | II.1 | cloquintocet |
| 1157. | II.2 | cloquintocet |
| 1158. | II.3 | cloquintocet |
| 1159. | II.4 | cloquintocet |
| 1160. | II.5 | cloquintocet |
| 1161. | II.6 | cloquintocet |
| 1162. | II.7 | cloquintocet |
| 1163. | II.8 | cloquintocet |
| 1164. | II.9 | cloquintocet |
| 1165. | II.1 | cyprosulfamide |
| 1166. | II.2 | cyprosulfamide |
| 1167. | II.3 | cyprosulfamide |
| 1168. | II.4 | cyprosulfamide |
| 1169. | II.5 | cyprosulfamide |
| 1170. | II.6 | cyprosulfamide |
| 1171. | II.7 | cyprosulfamide |
| 1172. | II.8 | cyprosulfamide |
| 1173. | II.9 | cyprosulfamide |
| 1174. | II.1 | dichlormid |
| 1175. | II.2 | dichlormid |
| 1176. | II.3 | dichlormid |
| 1177. | II.4 | dichlormid |
| 1178. | II.5 | dichlormid |
| 1179. | II.6 | dichlormid |
| 1180. | II.7 | dichlormid |
| 1181. | II.8 | dichlormid |
| 1182. | II.9 | dichlormid |
| 1183. | II.1 | fenchlorazole |
| 1184. | II.2 | fenchlorazole |
| 1185. | II.3 | fenchlorazole |
| 1186. | II.4 | fenchlorazole |
| 1187. | II.5 | fenchlorazole |
| 1188. | II.6 | fenchlorazole |
| 1189. | II.7 | fenchlorazole |
| 1190. | II.8 | fenchlorazole |
| 1191. | II.9 | fenchlorazole |
| 1192. | II.1 | isoxadifen |
| 1193. | II.2 | isoxadifen |
| 1194. | II.3 | isoxadifen |
| 1195. | II.4 | isoxadifen |
| 1196. | II.5 | isoxadifen |
| 1197. | II.6 | isoxadifen |
| 1198. | II.7 | isoxadifen |
| 1199. | II.8 | isoxadifen |
| 1200. | II.9 | isoxadifen |
| 1201. | II.1 | mefenpyr |
| 1202. | II.2 | mefenpyr |
| 1203. | II.3 | mefenpyr |
| 1204. | II.4 | mefenpyr |
| 1205. | II.5 | mefenpyr |
| 1206. | II.6 | mefenpyr |
| 1207. | II.7 | mefenpyr |
| 1208. | II.8 | mefenpyr |
| 1209. | II.9 | mefenpyr |
| 1210. | II.1 | 4-(dichloroacetyl)-1-oxa-4- |
| | | azaspiro[4.5]decane |
| | | (MON4660, CAS 71526-07-3) |
| 1211. | II.2 | 4-(dichloroacetyl)-1-oxa-4- |
| | | azaspiro[4.5]decane |
| | | (MON4660, CAS 71526-07-3) |
| 1212. | II.3 | 4-(dichloroacetyl)-1-oxa-4- |
| | | azaspiro[4.5]decane |
| | | (MON4660, CAS 71526-07-3) |
| 1213. | II.4 | 4-(dichloroacetyl)-1-oxa-4- |
| | | azaspiro[4.5]decane |
| | | (MON4660, CAS 71526-07-3) |
| 1214. | II.5 | 4-(dichloroacetyl)-1-oxa-4- |
| | | azaspiro[4.5]decane |
| | | (MON4660, CAS 71526-07-3) |
| 1215. | II.6 | 4-(dichloroacetyl)-1-oxa-4- |
| | | azaspiro[4.5]decane |
| | | (MON4660, CAS 71526-07-3) |
| 1216. | II.7 | 4-(dichloroacetyl)-1-oxa-4- |
| | | azaspiro[4.5]decane |
| | | (MON4660, CAS 71526-07-3) |
| 1217. | II.8 | 4-(dichloroacetyl)-1-oxa-4- |
| | | azaspiro[4.5]decane |
| | | (MON4660, CAS 71526-07-3) |
| 1218. | II.9 | 4-(dichloroacetyl)-1-oxa-4- |
| | | azaspiro[4.5]decane |
| | | (MON4660, CAS 71526-07-3) |
| 1219. | II.1 | 2,2,5-trimethyl-3- |
| | | (dichloroacetyl)-1,3-oxazolidine |
| | | (R-29148, CAS 52836-31-4) |
| 1220. | II.2 | 2,2,5-trimethyl-3- |
| | | (dichloroacetyl)-1,3-oxazolidine |
| | | (R-29148, CAS 52836-31-4) |
| 1221. | II.3 | 2,2,5-trimethyl-3- |
| | | (dichloroacetyl)-1,3-oxazolidine |
| | | (R-29148, CAS 52836-31-4) |
| 1222. | II.4 | 2,2,5-trimethyl-3- |
| | | (dichloroacetyl)-1,3-oxazolidine |
| | | (R-29148, CAS 52836-31-4) |
| 1223. | II.5 | 2,2,5-trimethyl-3- |
| | | (dichloroacetyl)-1,3-oxazolidine |
| | | (R-29148, CAS 52836-31-4) |
| 1224. | II.6 | 2,2,5-trimethyl-3- |
| | | (dichloroacetyl)-1,3-oxazolidine |
| | | (R-29148, CAS 52836-31-4) |
| 1225. | II.7 | 2,2,5-trimethyl-3- |
| | | (dichloroacetyl)-1,3-oxazolidine |
| | | (R-29148, CAS 52836-31-4) |
| 1226. | II.8 | 2,2,5-trimethyl-3- |
| | | (dichloroacetyl)-1,3-oxazolidine |
| | | (R-29148, CAS 52836-31-4) |
| 1227. | II.9 | 2,2,5-trimethyl-3- |
| | | (dichloroacetyl)-1,3-oxazolidine |
| | | (R-29148, CAS 52836-31-4) |

Examples of particularly preferred mixtures are given in tables 1 to 146a below.

Table 1: Compositions comprising as active compound A) the piperazine compound I-1 and as further active compound the substance(s) given in one row of table A (compositions 1.1 to 1.1227). The weight ratios of the individual components in the compositions 1.1 to 1.1227 are within the limits given above, in particular within the preferred limits.

Table 1a: Compositions 1.1a to 1.1227a which differ from the corresponding compositions 1.1-1.1227 only in that they comprise the Z isomer of the compound I-1 as the active compound A).

Table 2: Compositions 2.1 to 2.1227 which differ from the corresponding compositions 1.1-1.1227 only in that they comprise the compound I-2 as the active compound A).

Table 2a: Compositions 2.1a to 2.1227a which differ from the corresponding compositions 2.1-2.1227 only in that they comprise the Z isomer of the compound I-2 as the active compound A).

Table 3: Compositions 3.1 to 3.1227 which differ from the corresponding compositions 1.1-1.1227 only in that they comprise the compound I-3 as the active compound A).

Table 3a: Compositions 3.1a to 3.1227a which differ from the corresponding compositions 3.1-3.1227 only in that they comprise the Z isomer of the compound I-3 as the active compound A).

Table 4: Compositions 4.1 to 4.1227 which differ from the corresponding compositions 1.1-1.1227 only in that they comprise the compound I-4 as the active compound A).

Table 4a: Compositions 4.1a to 4.1227a which differ from the corresponding compositions 4.1-4.1227 only in that they comprise the Z isomer of the compound I-4 as the active compound A).

Table 5: Compositions 5.1 to 5.1227 which differ from the corresponding compositions 1.1-1.1227 only in that they comprise the compound I-5 as the active compound A).

Table 5a: Compositions 5.1a to 5.1227a which differ from the corresponding compositions 5.1-5.1227 only in that they comprise the Z isomer of the compound I-5 as the active compound A).

Table 6: Compositions 6.1 to 6.1227 which differ from the corresponding compositions 1.1-1.1227 only in that they comprise the compound I-6 as the active compound A).

Table 6a: Compositions 6.1a to 6.1227a which differ from the corresponding compositions 6.1-6.1227 only in that they comprise the Z isomer of the compound I-6 as the active compound A).

Table 7: Compositions 7.1 to 7.1227 which differ from the corresponding compositions 1.1-1.1227 only in that they comprise the compound I-7 as the active compound A).

Table 7a: Compositions 7.1a to 7.1227a which differ from the corresponding compositions 7.1-7.1227 only in that they comprise the Z isomer of the compound I-7 as the active compound A).

Table 8: Compositions 8.1 to 8.1227 which differ from the corresponding compositions 1.1-1.1227 only in that they comprise the compound I-8 as the active compound A).

Table 8a: Compositions 8.1a to 8.1227a which differ from the corresponding compositions 8.1-8.1227 only in that they comprise the Z isomer of the compound I-8 as the active compound A).

Table 9: Compositions 9.1 to 9.1227 which differ from the corresponding compositions 1.1-1.1227 only in that they comprise the compound I-9 as the active compound A).

Table 9a: Compositions 9.1a to 9.1227a which differ from the corresponding compositions 9.1-9.1227 only in that they comprise the Z isomer of the compound I-9 as the active compound A).

Table 10: Compositions 10.1 to 10.1227 which differ from the corresponding compositions 1.1-1.1227 only in that they comprise the compound I-10 as the active compound A).

Table 10a: Compositions 10.1a to 10.1227a which differ from the corresponding compositions 10.1-10.1227 only in that they comprise the Z isomer of the compound I-10 as the active compound A).

Table 11: Compositions 11.1 to 11.1227 which differ from the corresponding compositions 1.1-1.1227 only in that they comprise the compound I-11 as the active compound A).

Table 11a: Compositions 11.1a to 11.1227a which differ from the corresponding compositions 11.1-11.1227 only in that they comprise the Z isomer of the compound I-11 as the active compound A).

Table 12: Compositions 12.1 to 12.1227 which differ from the corresponding compositions 1.1-1.1227 only in that they comprise the compound I-12 as the active compound A).

Table 12a: Compositions 12.1a to 12.1227a which differ from the corresponding compositions 12.1-12.1227 only in that they comprise the Z isomer of the compound I-12 as the active compound A).

Table 13: Compositions 13.1 to 13.1227 which differ from the corresponding compositions 1.1-1.1227 only in that they comprise the compound I-13 as the active compound A).

Table 13a: Compositions 13.1a to 13.1227a which differ from the corresponding compositions 13.1-13.1227 only in that they comprise the Z isomer of the compound I-13 as the active compound A).

Table 14: Compositions 14.1 to 14.1227 which differ from the corresponding compositions 1.1-1.1227 only in that they comprise the compound I-14 as the active compound A).

Table 14a: Compositions 14.1a to 14.1227a which differ from the corresponding compositions 14.1-14.1227 only in that they comprise the Z isomer of the compound I-14 as the active compound A).

Table 15: Compositions 15.1 to 15.1227 which differ from the corresponding compositions 1.1-1.1227 only in that they comprise the compound I-15 as the active compound A).

Table 15a: Compositions 15.1a to 15.1227a which differ from the corresponding compositions 15.1-15.1227 only in that they comprise the Z isomer of the compound I-15 as the active compound A).

Table 16: Compositions 16.1 to 16.1227 which differ from the corresponding compositions 1.1-1.1227 only in that they comprise the compound I-16 as the active compound A).

Table 16a: Compositions 16.1a to 16.1227a which differ from the corresponding compositions 16.1-16.1227 only in that they comprise the Z isomer of the compound I-16 as the active compound A).

Table 17: Compositions 17.1 to 17.1227 which differ from the corresponding compositions 1.1-1.1227 only in that they comprise the compound I-17 as the active compound A).

Table 17a: Compositions 17.1a to 17.1227a which differ from the corresponding compositions 17.1-17.1227 only in that they comprise the Z isomer of the compound I-17 as the active compound A).

Table 18: Compositions 18.1 to 18.1227 which differ from the corresponding compositions 1.1-1.1227 only in that they comprise the compound I-18 as the active compound A).

Table 18a: Compositions 18.1a to 18.1227a which differ from the corresponding compositions 18.1-18.1227 only in that they comprise the Z isomer of the compound I-18 as the active compound A).

Table 19: Compositions 19.1 to 19.1227 which differ from the corresponding compositions 1.1-1.1227 only in that they comprise the compound I-19 as the active compound A).

Table 19a: Compositions 19.1a to 19.1227a which differ from the corresponding compositions 19.1-19.1227 only in that they comprise the Z isomer of the compound I-19 as the active compound A).

Table 20: Compositions 20.1 to 20.1227 which differ from the corresponding compositions 1.1-1.1227 only in that they comprise the compound I-20 as the active compound A).

Table 20a: Compositions 20.1a to 20.1227a which differ from the corresponding compositions 20.1-20.1227 only in that they comprise the Z isomer of the compound I-20 as the active compound A).

Table 21: Compositions 21.1 to 21.1227 which differ from the corresponding compositions 1.1-1.1227 only in that they comprise the compound I-21 as the active compound A).

Table 21a: Compositions 21.1a to 21.1227a which differ from the corresponding compositions 21.1-21.1227 only in that they comprise the Z isomer of the compound I-21 as the active compound A).

Table 22: Compositions 22.1 to 22.1227 which differ from the corresponding compositions 1.1-1.1227 only in that they comprise the compound I-22 as the active compound A).

Table 22a: Compositions 22.1a to 22.1227a which differ from the corresponding compositions 22.1-22.1227 only in that they comprise the Z isomer of the compound I-22 as the active compound A).

Table 23: Compositions 23.1 to 23.1227 which differ from the corresponding compositions 1.1-1.1227 only in that they comprise the compound I-23 as the active compound A).

Table 23a: Compositions 23.1a to 23.1227a which differ from the corresponding compositions 23.1-23.1227 only in that they comprise the Z isomer of the compound I-23 as the active compound A).

Table 24: Compositions 24.1 to 24.1227 which differ from the corresponding compositions 1.1-1.1227 only in that they comprise the compound I-24 as the active compound A).

Table 24a: Compositions 24.1a bis 24.1227a which differ from the corresponding compositions 24.1-24.1227 only in that they comprise the Z isomer of the compound I-24 as the active compound A).

Table 25: Compositions 25.1 to 25.1227 which differ from the corresponding compositions 1.1-1.1227 only in that they comprise the compound I-25 as the active compound A).

Table 25a: Compositions 25.1a to 25.1227a which differ from the corresponding compositions 25.1-25.1227 only in that they comprise the Z isomer of the compound I-25 as the active compound A).

Table 26: Compositions 26.1 to 26.1227 which differ from the corresponding compositions 1.1-1.1227 only in that they comprise the compound I-26 as the active compound A).

Table 26a: Compositions 26.1a to 26.1227a which differ from the corresponding compositions 26.1-26.1227 only in that they comprise the Z isomer of the compound I-26 as the active compound A).

Table 27: Compositions 27.1 to 27.1227 which differ from the corresponding compositions 1.1-1.1227 only in that they comprise the compound I-27 as the active compound A).

Table 27a: Compositions 27.1a to 27.1227a which differ from the corresponding compositions 27.1-27.1227 only in that they comprise the Z isomer of the compound I-27 as the active compound A).

Table 28: Compositions 28.1 to 28.1227 which differ from the corresponding compositions 1.1-1.1227 only in that they comprise the compound I-28 as the active compound A).

Table 28a: Compositions 28.1a to 28.1227a which differ from the corresponding compositions 28.1-28.1227 only in that they comprise the Z isomer of the compound I-28.

Table 29: Compositions 29.1 to 29.1227 which differ from the corresponding compositions 1.1-1.1227 only in that they comprise the compound I-29 as the active compound A).

Table 29a: Compositions 29.1a to 29.1227a which differ from the corresponding compositions 29.1-29.1227 only in that they comprise the Z isomer of the compound I-29 as the active compound A).

Table 30: Compositions 30.1 to 30.1227 which differ from the corresponding compositions 1.1-1.1227 only in that they comprise the compound I-30 as the active compound A).

Table 30a: Compositions 30.1a to 30.1227a which differ from the corresponding compositions 30.1-30.1227 only in that they comprise the Z isomer of the compound I-30 as the active compound A).

Table 31: Compositions 31.1 to 31.1227 which differ from the corresponding compositions 1.1-1.1227 only in that they comprise the compound I-31 as the active compound A).

Table 31a: Compositions 31.1a to 31.1227a which differ from the corresponding compositions 31.1-31.1227 only in that they comprise the Z isomer of the compound I-31 as the active compound A).

Table 32: Compositions 32.1 to 32.1227 which differ from the corresponding compositions 1.1-1.1227 only in that they comprise the compound I-32 as the active compound A).

Table 32a: Compositions 32.1a to 32.1227a which differ from the corresponding compositions 32.1-32.1227 only in that they comprise the Z isomer of the compound I-32 as the active compound A).

Table 33: Compositions 33.1 to 33.1227 which differ from the corresponding compositions 1.1-1.1227 only in that they comprise the compound I-33 as the active compound A).

Table 33a: Compositions 33.1a to 33.1227a which differ from the corresponding compositions 33.1-33.1227 only in that they comprise the Z isomer of the compound I-33 as the active compound A).

Table 34: Compositions 34.1 to 34.1227 which differ from the corresponding compositions 1.1-1.1227 only in that they comprise the compound I-34 as the active compound A).

Table 34a: Compositions 34.1a to 34.1227a which differ from the corresponding compositions 34.1-34.1227 only in that they comprise the Z isomer of the compound I-34 as the active compound A).

Table 35: Compositions 35.1 to 35.1227 which differ from the corresponding compositions 1.1-1.1227 only in that they comprise the compound I-35 as the active compound A).

Table 35a: Compositions 35.1a to 35.1227a which differ from the corresponding compositions 35.1-35.1227 only in that they comprise the Z isomer of the compound I-35 as the active compound A).

Table 36: Compositions 36.1 to 36.1227 which differ from the corresponding compositions 1.1-1.1227 only in that they comprise the compound I-36 as the active compound A).

Table 36a: Compositions 36.1a to 36.1227a which differ from the corresponding compositions 36.1-36.1227 only in that they comprise the Z isomer of the compound I-36 as the active compound A).

Table 37: Compositions 37.1 to 37.1227 which differ from the corresponding compositions 1.1-1.1227 only in that they comprise the compound I-37 as the active compound A).

Table 37a: Compositions 37.1a to 37.1227a which differ from the corresponding compositions 37.1-37.1227 only in that they comprise the Z isomer of the compound I-37 as the active compound A).

Table 38: Compositions 38.1 to 38.1227 which differ from the corresponding compositions 1.1-1.1227 only in that they comprise the compound I-38 as the active compound A).

Table 38a: Compositions 38.1a to 38.1227a which differ from the corresponding compositions 38.1-38.1227 only in that they comprise the Z isomer of the compound I-38 as the active compound A).

Table 39: Compositions 39.1 to 39.1227 which differ from the corresponding compositions 1.1-1.1227 only in that they comprise the compound I-39 as the active compound A).

Table 39a: Compositions 39.1a to 39.1227a which differ from the corresponding compositions 39.1-39.1227 only in that they comprise the Z isomer of the compound I-39 as the active compound A).

Table 40: Compositions 40.1 to 40.1227 which differ from the corresponding compositions 1.1-1.1227 only in that they comprise the compound I-40 as the active compound A).

Table 40a: Compositions 40.1a to 40.1227a which differ from the corresponding compositions 40.1-40.1227 only in that they comprise the Z isomer of the compound I-40 as the active compound A).

Table 41: Compositions 41.1 to 41.1227 which differ from the corresponding compositions 1.1-1.1227 only in that they comprise the compound I-41 as the active compound A).

Table 41a: Compositions 41.1a to 41.1227a which differ from the corresponding compositions 41.1-41.1227 only in that they comprise the Z isomer of the compound I-41 as the active compound A).

Table 42: Compositions 42.1 to 42.1227 which differ from the corresponding compositions 1.1-1.1227 only in that they comprise the compound I-42 as the active compound A).

Table 42a: Compositions 42.1a to 42.1227a which differ from the corresponding compositions 42.1-42.1227 only in that they comprise the Z isomer of the compound I-42 as the active compound A).

Table 43: Compositions 43.1 to 43.1227 which differ from the corresponding compositions 1.1-1.1227 only in that they comprise the compound I-43 as the active compound A).

Table 43a: Compositions 43.1a to 43.1227a which differ from the corresponding compositions 43.1-43.1227 only in that they comprise the Z isomer of the compound I-43 as the active compound A).

Table 44: Compositions 44.1 to 44.1227 which differ from the corresponding compositions 1.1-1.1227 only in that they comprise the compound I-44 as the active compound A).

Table 44a: Compositions 44.1a to 44.1227a which differ from the corresponding compositions 44.1-44.1227 only in that they comprise the Z isomer of the compound I-44 as the active compound A).

Table 45: Compositions 45.1 to 45.1227 which differ from the corresponding compositions 1.1-1.1227 only in that they comprise the compound I-45 as the active compound A).

Table 45a: Compositions 45.1a to 45.1227a which differ from the corresponding compositions 45.1-45.1227 only in that they comprise the Z isomer of the compound I-45.

Table 46: Compositions 46.1 to 46.1227 which differ from the corresponding compositions 1.1-1.1227 only in that they comprise the compound I-46 as the active compound A).

Table 46a: Compositions 46.1a to 46.1227a which differ from the corresponding compositions 46.1-46.1227 only in that they comprise the Z isomer of the compound I-46 as the active compound A).

Table 47: Compositions 47.1 to 47.1227 which differ from the corresponding compositions 1.1-1.1227 only in that they comprise the compound I-47 as the active compound A).

Table 47a: Compositions 47.1a to 47.1227a which differ from the corresponding compositions 47.1-47.1227 only in that they comprise the Z isomer of the compound I-47 as the active compound A).

Table 48: Compositions 48.1 to 48.1227 which differ from the corresponding compositions 1.1-1.1227 only in that they comprise the compound I-48 as the active compound A).

Table 48a: Compositions 48.1a to 48.1227a which differ from the corresponding compositions 48.1-48.1227 only in that they comprise the Z isomer of the compound I-48 as the active compound A).

Table 49: Compositions 49.1 to 49.1227 which differ from the corresponding compositions 1.1-1.1227 only in that they comprise the compound I-49 as the active compound A).

Table 49a: Compositions 49.1a to 49.1227a which differ from the corresponding compositions 49.1-49.1227 only in that they comprise the Z isomer of the compound I-49 as the active compound A).

Table 50: Compositions 50.1 to 50.1227 which differ from the corresponding compositions 1.1-1.1227 only in that they comprise the compound I-50 as the active compound A).

Table 50a: Compositions 50.1a to 50.1227a which differ from the corresponding compositions 50.1-50.1227 only in that they comprise the Z isomer of the compound I-50 as the active compound A).

Table 51: Compositions 51.1 to 51.1227 which differ from the corresponding compositions 1.1-1.1227 only in that they comprise the compound I-51 as the active compound A).

Table 51a: Compositions 51.1a to 51.1227a which differ from the corresponding compositions 51.1-51.1227 only in that they comprise the Z isomer of the compound I-51 as the active compound A).

Table 52: Compositions 52.1 to 52.1227 which differ from the corresponding compositions 1.1-1.1227 only in that they comprise the compound I-52 as the active compound A).

Table 52a: Compositions 52.1a to 52.1227a which differ from the corresponding compositions 52.1-52.1227 only in that they comprise the Z isomer of the compound I-52 as the active compound A).

Table 53: Compositions 53.1 to 53.1227 which differ from the corresponding compositions 1.1-1.1227 only in that they comprise the compound I-53.

Table 53a: Compositions 53.1a to 53.1227a which differ from the corresponding compositions 53.1-53.1227 only in that they comprise the Z isomer of the compound I-53.

Table 54: Compositions 54.1 to 54.1227 which differ from the corresponding compositions 1.1-1.1227 only in that they comprise the compound I-54 as the active compound A).

Table 54a: Compositions 54.1a to 54.1227a which differ from the corresponding compositions 54.1-54.1227 only in that they comprise the Z isomer of the compound I-54 as the active compound A).

Table 55: Compositions 55.1 to 55.1227 which differ from the corresponding compositions 1.1-1.1227 only in that they comprise the compound I-55 as the active compound A).

Table 55a: Compositions 55.1a to 55.1227a which differ from the corresponding compositions 55.1-55.1227 only in that they comprise the Z isomer of the compound I-55.

Table 56: Compositions 56.1 to 56.1227 which differ from the corresponding compositions 1.1-1.1227 only in that they comprise the compound I-56 as the active compound A).

Table 56a: Compositions 56.1a to 56.1227a which differ from the corresponding compositions 56.1-56.1227 only in that they comprise the Z isomer of the compound I-56 as the active compound A).

Table 57: Compositions 57.1 to 57.1227 which differ from the corresponding compositions 1.1-1.1227 only in that they comprise the compound I-57 as the active compound A).

Table 57a: Compositions 57.1a to 57.1227a which differ from the corresponding compositions 57.1-57.1227 only in that they comprise the Z isomer of the compound I-57 as the active compound A).

Table 58: Compositions 58.1 to 58.1227 which differ from the corresponding compositions 1.1-1.1227 only in that they comprise the compound I-58 as the active compound A).

Table 58a: Compositions 58.1a to 58.1227a which differ from the corresponding compositions 58.1-58.1227 only in that they comprise the Z isomer of the compound I-58 as the active compound A).

Table 59: Compositions 59.1 to 59.1227 which differ from the corresponding compositions 1.1-1.1227 only in that they comprise the compound I-59 as the active compound A).

Table 59a: Compositions 59.1a to 59.1227a which differ from the corresponding compositions 59.1-59.1227 only in that they comprise the Z isomer of the compound I-59 as the active compound A).

Table 60: Compositions 60.1 to 60.1227 which differ from the corresponding compositions 1.1-1.1227 only in that they comprise the compound I-60 as the active compound A).

Table 60a: Compositions 60.1a to 60.1227a which differ from the corresponding compositions 60.1-60.1227 only in that they comprise the Z isomer of the compound I-60 as the active compound A).

Table 61: Compositions 61.1 to 61.1227 which differ from the corresponding compositions 1.1-1.1227 only in that they comprise the compound I-61 as the active compound A).

Table 61a: Compositions 61.1a to 61.1227a which differ from the corresponding compositions 61.1-61.1227 only in that they comprise the Z isomer of the compound I-61 as the active compound A).

Table 62: Compositions 62.1 to 62.1227 which differ from the corresponding compositions 1.1-1.1227 only in that they comprise the compound I-62 as the active compound A).

Table 62a: Compositions 62.1a to 62.1227a which differ from the corresponding compositions 62.1-62.1227 only in that they comprise the Z isomer of the compound I-62 as the active compound A).

Table 63: Compositions 63.1 to 63.1227 which differ from the corresponding compositions 1.1-1.1227 only in that they comprise the compound I-63 as the active compound A).

Table 63a: Compositions 63.1a to 63.1227a which differ from the corresponding compositions 63.1-63.1227 only in that they comprise the Z isomer of the compound I-63 as the active compound A).

Table 64: Compositions 64.1 to 64.1227 which differ from the corresponding compositions 1.1-1.1227 only in that they comprise the compound I-64 as the active compound A).

Table 64a: Compositions 64.1a to 64.1227a which differ from the corresponding compositions 64.1-64.1227 only in that they comprise the Z isomer of the compound I-64 as the active compound A).

Table 65: Compositions 65.1 to 65.1227 which differ from the corresponding compositions 1.1-1.1227 only in that they comprise the compound I-65 as the active compound A).

Table 65a: Compositions 65.1a to 65.1227a which differ from the corresponding compositions 65.1-65.1227 only in that they comprise the Z isomer of the compound I-65 as the active compound A).

Table 66: Compositions 66.1 to 66.1227 which differ from the corresponding compositions 1.1-1.1227 only in that they comprise the compound I-66 as the active compound A).

Table 66a: Compositions 66.1a to 66.1227a which differ from the corresponding compositions 66.1-66.1227 only in that they comprise the Z isomer of the compound I-66 as the active compound A).

Table 67: Compositions 67.1 to 67.1227 which differ from the corresponding compositions 1.1-1.1227 only in that they comprise the compound I-67 as the active compound A).

Table 67a: Compositions 67.1a to 67.1227a which differ from the corresponding compositions 67.1-67.1227 only in that they comprise the Z isomer of the compound I-67 as the active compound A).

Table 68: Compositions 68.1 to 68.1227 which differ from the corresponding compositions 1.1-1.1227 only in that they comprise the compound I-68 as the active compound A).

Table 68a: Compositions 68.1a to 68.1227a which differ from the corresponding compositions 68.1-68.1227 only in that they comprise the Z isomer of the compound I-68 as the active compound A).

Table 69: Compositions 69.1 to 69.1227 which differ from the corresponding compositions 1.1-1.1227 only in that they comprise the compound I-69 as the active compound A).

Table 69a: Compositions 69.1a to 69.1227a which differ from the corresponding compositions 69.1-69.1227 only in that they comprise the Z isomer of the compound I-69 as the active compound A).

Table 70: Compositions 70.1 to 70.1227 which differ from the corresponding compositions 1.1-1.1227 only in that they comprise the compound I-70 as the active compound A).

Table 70a: Compositions 70.1a to 70.1227a which differ from the corresponding compositions 70.1-70.1227 only in that they comprise the Z isomer of the compound I-70 as the active compound A).

Table 71: Compositions 71.1 to 71.1227 which differ from the corresponding compositions 1.1-1.1227 only in that they comprise the compound I-71 as the active compound A).

Table 71a: Compositions 71.1a to 71.1227a which differ from the corresponding compositions 71.1-71.1227 only in that they comprise the Z isomer of the compound I-71 as the active compound A).

Table 72: Compositions 72.1 to 72.1227 which differ from the corresponding compositions 1.1-1.1227 only in that they comprise the compound I-72 as the active compound A).

Table 72a: Compositions 72.1a to 72.1227a which differ from the corresponding compositions 72.1-72.1227 only in that they comprise the Z isomer of the compound I-72 as the active compound A).

Table 73: Compositions 73.1 to 73.1227 which differ from the corresponding compositions 1.1-1.1227 only in that they comprise the compound I-73 as the active compound A).

Table 73a: Compositions 73.1a to 73.1227a which differ from the corresponding compositions 73.1-73.1227 only in that they comprise the Z isomer of the compound I-73 as the active compound A).

Table 74: Compositions 74.1 to 74.1227 which differ from the corresponding compositions 1.1-1.1227 only in that they comprise the compound I-74 as the active compound A).

Table 74a: Compositions 74.1a to 74.1227a which differ from the corresponding compositions 74.1-74.1227 only in that they comprise the Z isomer of the compound I-74 as the active compound A).

Table 75: Compositions 75.1 to 75.1227 which differ from the corresponding compositions 1.1-1.1227 only in that they comprise the compound I-75 as the active compound A).

Table 75a: Compositions 75.1a to 75.1227a which differ from the corresponding compositions 75.1-75.1227 only in that they comprise the Z isomer of the compound I-75 as the active compound A).

Table 76: Compositions 76.1 to 76.1227 which differ from the corresponding compositions 1.1-1.1227 only in that they comprise the compound I-76 as the active compound A).

Table 76a: Compositions 76.1a to 76.1227a which differ from the corresponding compositions 76.1-76.1227 only in that they comprise the Z isomer of the compound I-76 as the active compound A).

Table 77: Compositions 77.1 to 77.1227 which differ from the corresponding compositions 1.1-1.1227 only in that they comprise the compound I-77 as the active compound A).

Table 77a: Compositions 77.1a to 77.1227a which differ from the corresponding compositions 77.1-77.1227 only in that they comprise the Z isomer of the compound I-77 as the active compound A).

Table 78: Compositions 78.1 to 78.1227 which differ from the corresponding compositions 1.1-1.1227 only in that they comprise the compound I-78 as the active compound A).

Table 78a: Compositions 78.1a to 78.1227a which differ from the corresponding compositions 78.1-78.1227 only in that they comprise the Z isomer of the compound I-78 as the active compound A).

Table 79: Compositions 79.1 to 79.1227 which differ from the corresponding compositions 1.1-1.1227 only in that they comprise the compound I-79 as the active compound A).

Table 79a: Compositions 79.1a to 79.1227a which differ from the corresponding compositions 79.1-79.1227 only in that they comprise the Z isomer of the compound I-79 as the active compound A).

Table 80: Compositions 80.1 to 80.1227, which differ from the corresponding compositions 1.1-1.1227 only in that they comprise the compound I-80 as the active compound A).

Table 80a: Compositions 80.1a to 80.1227a which differ from the corresponding compositions 80.1-80.1227 only in that they comprise the Z isomer of the compound I-80 as the active compound A).

Table 81: Compositions 81.1 to 81.1227 which differ from the corresponding compositions 1.1-1.1227 only in that they comprise the compound I-81 as the active compound A).

Table 81a: Compositions 81.1a to 81.1227a which differ from the corresponding compositions 81.1-81.1227 only in that they comprise the Z isomer of the compound I-81 as the active compound A).

Table 82: Compositions 82.1 to 82.1227 which differ from the corresponding compositions 1.1-1.1227 only in that they comprise the compound I-82 as the active compound A).

Table 82a: Compositions 82.1a to 82.1227a which differ from the corresponding compositions 82.1-82.1227 only in that they comprise the Z isomer of the compound I-82 as the active compound A).

Table 83: Compositions 83.1 to 83.1227 which differ from the corresponding compositions 1.1-1.1227 only in that they comprise the compound I-83 as the active compound A).

Table 83a: Compositions 83.1a to 83.1227a which differ from the corresponding compositions 83.1-83.1227 only in that they comprise the Z isomer of the compound I-83 as the active compound A).

Table 84: Compositions 84.1 to 84.1227 which differ from the corresponding compositions 1.1-1.1227 only in that they comprise the compound I-84 as the active compound A).

Table 84a: Compositions 84.1a to 84.1227a which differ from the corresponding compositions 84.1-84.1227 only in that they comprise the Z isomer of the compound I-84 as the active compound A).

Table 85: Compositions 85.1 to 85.1227 which differ from the corresponding compositions 1.1-1.1227 only in that they comprise the compound I-85.

Table 85a: Compositions 85.1a to 85.1227a which differ from the corresponding compositions 85.1-85.1227 only in that they comprise the Z isomer of the compound I-85 as the active compound A).

Table 86: Compositions 86.1 to 86.1227 which differ from the corresponding compositions 1.1-1.1227 only in that they comprise the compound I-86 as the active compound A).

Table 86a: Compositions 86.1a to 86.1227a which differ from the corresponding compositions 86.1-86.1227 only in that they comprise the Z isomer of the compound I-86 as the active compound A).

Table 87: Compositions 87.1 to 87.1227 which differ from the corresponding compositions 1.1-1.1227 only in that they comprise the compound I-87 as the active compound A).

Table 87a: Compositions 87.1a to 87.1227a which differ from the corresponding compositions 87.1-87.1227 only in that they comprise the Z isomer of the compound I-87 as the active compound A).

Table 88: Compositions 88.1 to 88.1227 which differ from the corresponding compositions 1.1-1.1227 only in that they comprise the compound I-88 as the active compound A).

Table 88a: Compositions 88.1a to 88.1227a which differ from the corresponding compositions 88.1-88.1227 only in that they comprise the Z isomer of the compound I-88 as the active compound A).

Table 89: Compositions 89.1 to 89.1227 which differ from the corresponding compositions 1.1-1.1227 only in that they comprise the compound I-89 as the active compound A).

Table 89a: Compositions 89.1a to 89.1227a which differ from the corresponding compositions 89.1-89.1227 only in that they comprise the Z isomer of the compound I-89 as the active compound A).

Table 90: Compositions 90.1 to 90.1227 which differ from the corresponding compositions 1.1-1.1227 only in that they comprise the compound I-90 as the active compound A).

Table 90a: Compositions 90.1a to 90.1227a which differ from the corresponding compositions 90.1-90.1227 only in that they comprise the Z isomer of the compound I-90 as the active compound A).

Table 91: Compositions 91.1 to 91.1227 which differ from the corresponding compositions 1.1-1.1227 only in that they comprise the compound I-91 as the active compound A).

Table 91a: Compositions 91.1a to 91.1227a which differ from the corresponding compositions 91.1-91.1227 only in that they comprise the Z isomer of the compound I-91 as the active compound A).

Table 92: Compositions 92.1 to 92.1227 which differ from the corresponding compositions 1.1-1.1227 only in that they comprise the compound I-92 as the active compound A).

Table 92a: Compositions 92.1a to 92.1227a which differ from the corresponding compositions 92.1-92.1227 only in that they comprise the Z isomer of the compound I-92 as the active compound A).

Table 93: Compositions 93.1 to 93.1227 which differ from the corresponding compositions 1.1-1.1227 only in that they comprise the compound I-93 as the active compound A).

Table 93a: Compositions 93.1a to 93.1227a which differ from the corresponding compositions 93.1-93.1227 only in that they comprise the Z isomer of the compound I-93 as the active compound A).

Table 94: Compositions 94.1 to 94.1227 which differ from the corresponding compositions 1.1-1.1227 only in that they comprise the compound I-94 as the active compound A).

Table 94a: Compositions 94.1a to 94.1227a which differ from the corresponding compositions 94.1-94.1227 only in that they comprise the Z isomer of the compound I-94 as the active compound A).

Table 95: Compositions 95.1 to 95.1227 which differ from the corresponding compositions 1.1-1.1227 only in that they comprise the compound I-95 as the active compound A).

Table 95a: Compositions 95.1a to 95.1227a which differ from the corresponding compositions 95.1-95.1227 only in that they comprise the Z isomer of the compound I-95 as the active compound A).

Table 96: Compositions 96.1 to 96.1227 which differ from the corresponding compositions 1.1-1.1227 only in that they comprise the compound I-96 as the active compound A).

Table 96a: Compositions 96.1a to 96.1227a which differ from the corresponding compositions 96.1-96.1227 only in that they comprise the Z isomer of the compound I-96 as the active compound A).

Table 97: Compositions 97.1 to 97.1227 which differ from the corresponding compositions 1.1-1.1227 only in that they comprise the compound I-97 as the active compound A).

Table 97a: Compositions 97.1a to 97.1227a which differ from the corresponding compositions 97.1-97.1227 only in that they comprise the Z isomer of the compound I-97 as the active compound A).

Table 98: Compositions 98.1 to 98.1227 which differ from the corresponding compositions 1.1-1.1227 only in that they comprise the compound I-98 as the active compound A).

Table 98a: Compositions 98.1a to 98.1227a which differ from the corresponding compositions 98.1-98.1227 only in that they comprise the Z isomer of the compound I-98 as the active compound A).

Table 99: Compositions 99.1 to 99.1227 which differ from the corresponding compositions 1.1-1.1227 only in that they comprise the compound I-99 as the active compound A).

Table 99a: Compositions 99.1a to 99.1227a which differ from the corresponding compositions 99.1-99.1227 only in that they comprise the Z isomer of the compound I-99 as the active compound A).

Table 100: Compositions 100.1 to 100.1227 which differ from the corresponding compositions 1.1-1.1227 only in that they comprise the compound I-100 as the active compound A).

Table 100a: Compositions 100.1a to 100.1227a which differ from the corresponding compositions 100.1-100.1227 only in that they comprise the Z isomer of the compound I-100 as the active compound A).

Table 101: Compositions 101.1 to 101.1227 which differ from the corresponding compositions 1.1-1.1227 only in that they comprise the compound I-101 as the active compound A).

Table 101a: Compositions 101.1a to 101.1227a which differ from the corresponding compositions 101.1-101.1227 only in that they comprise the Z isomer of the compound I-101 as the active compound A).

Table 102: Compositions 102.1 to 102.1227 which differ from the corresponding compositions 1.1-1.1227 only in that they comprise the compound I-102 as the active compound A).

Table 102a: Compositions 102.1a to 102.1227a which differ from the corresponding compositions 102.1-102.1227 only in that they comprise the Z isomer of the compound I-102 as the active compound A).

Table 103: Compositions 103.1 to 103.1227 which differ from the corresponding compositions 1.1-1.1227 only in that they comprise the compound I-103 as the active compound A).

Table 103a: Compositions 103.1a to 103.1227a which differ from the corresponding compositions 103.1-103.1227 only in that they comprise the cis-isomer of the compound I-103 as the active compound A).

Table 104: Compositions 104.1 to 104.1227 which differ from the corresponding compositions 1.1-1.1227 only in that they comprise the compound I-104 as the active compound A).

Table 104a: Compositions 104.1a to 104.1227a which differ from the corresponding compositions 104.1-104.1227 only in that they comprise the cis-isomer of the compound I-104 as the active compound A).

Table 105: Compositions 105.1 to 105.1227 which differ from the corresponding compositions 1.1-1.1227 only in that they comprise the compound I-105 as the active compound A).

Table 105a: Compositions 105.1a to 105.1227a which differ from the corresponding compositions 105.1-105.1227 only in that they comprise the cis-isomer of the compound I-105 as the active compound A).

Table 106: Compositions 106.1 to 106.1227 which differ from the corresponding compositions 1.1-1.1227 only in that they comprise the compound I-106 as the active compound A).

Table 106a: Compositions 106.1a to 106.1227a which differ from the corresponding compositions 106.1-106.1227 only in that they comprise the cis-isomer of the compound I-106 as the active compound A).

Table 107: Compositions 107.1 to 107.1227 which differ from the corresponding compositions 1.1-1.1227 only in that they comprise the compound I-107 as the active compound A).

Table 107a: Compositions 107.1a to 107.1227a which differ from the corresponding compositions 107.1-107.1227 only in that they comprise the cis-isomer of the compound I-107 as the active compound A).

Table 108: Compositions 108.1 to 108.1227 which differ from the corresponding compositions 1.1-1.1227 only in that they comprise the compound I-108 as the active compound A).

Table 108a: Compositions 108.1a to 108.1227a which differ from the corresponding compositions 108.1-108.1227 only in that they comprise the cis-isomer of the compound I-108 as the active compound A).

Table 109: Compositions 109.1 to 109.1227 which differ from the corresponding compositions 1.1-1.1227 only in that they comprise the compound I-109 as the active compound A).

Table 109a: Compositions 109.1a to 109.1227a which differ from the corresponding compositions 109.1-109.1227 only in that they comprise the cis-isomer of the compound I-109 as the active compound A).

Table 110: Compositions 110.1 to 110.1227 which differ from the corresponding compositions 1.1-1.1227 only in that they comprise the compound I-110 as the active compound A).

Table 110a: Compositions 110.1a to 110.1227a which differ from the corresponding compositions 110.1-110.1227 only in that they comprise the cis-isomer of the compound I-110 as the active compound A).

Table 111: Compositions 111.1 to 111.1227 which differ from the corresponding compositions 1.1-1.1227 only in that they comprise the compound I-111 as the active compound A).

Table 111a: Compositions 111.1a to 111.1227a which differ from the corresponding compositions 111.1-111.1227 only in that they comprise the cis-isomer of the compound I-111 as the active compound A).

Table 112: Compositions 112.1 to 112.1227 which differ from the corresponding compositions 1.1-1.1227 only in that they comprise the compound I-112 as the active compound A).

Table 112a: Compositions 112.1a to 112.1227a which differ from the corresponding compositions 112.1-112.1227 only in that they comprise the cis-isomer of the compound I-112 as the active compound A).

Table 113: Compositions 113.1 to 113.1227 which differ from the corresponding compositions 1.1-1.1227 only in that they comprise the compound I-113 as the active compound A).

Table 113a: Compositions 113.1a to 113.1227a which differ from the corresponding compositions 113.1-113.1227 only in that they comprise the cis-isomer of the compound I-113 as the active compound A).

Table 114: Compositions 114.1 to 114.1227 which differ from the corresponding compositions 1.1-1.1227 only in that they comprise the compound I-114 as the active compound A).

Table 114a: Compositions 114.1a to 114.1227a which differ from the corresponding compositions 114.1-114.1227 only in that they comprise the cis-isomer of the compound I-114 as the active compound A).

Table 115: Compositions 115.1 to 115.1227 which differ from the corresponding compositions 1.1-1.1227 only in that they comprise the compound I-115 as the active compound A).

Table 115a: Compositions 115.1a to 115.1227a which differ from the corresponding compositions 115.1-115.1227 only in that they comprise the cis-isomer of the compound I-115 as the active compound A).

Table 116: Compositions 116.1 to 116.1227 which differ from the corresponding compositions 1.1-1.1227 only in that they comprise the compound I-116 as the active compound A).

Table 116a: Compositions 116.1a to 116.1227a which differ from the corresponding compositions 116.1-116.1227 only in that they comprise the cis-isomer of the compound I-116 as the active compound A).

Table 117: Compositions 117.1 to 117.1227 which differ from the corresponding compositions 1.1-1.1227 only in that they comprise the compound I-117 as the active compound A).

Table 117a: Compositions 117.1a to 117.1227a which differ from the corresponding compositions 117.1-117.1227 only in that they comprise the cis-isomer of the compound I-117 as the active compound A).

Table 118: Compositions 118.1 to 118.1227 which differ from the corresponding compositions 1.1-1.1227 only in that they comprise the compound I-118 as the active compound A).

Table 118a: Compositions 118.1a to 118.1227a which differ from the corresponding compositions 118.1-118.1227 only in that they comprise the cis-isomer of the compound I-118 as the active compound A).

Table 119: Compositions 119.1 to 119.1227 which differ from the corresponding compositions 1.1-1.1227 only in that they comprise the compound I-119 as the active compound A).

Table 119a: Compositions 119.1a to 119.1227a which differ from the corresponding compositions 119.1-119.1227 only in that they comprise the cis-isomer of the compound I-119 as the active compound A).

Table 120: Compositions 120.1 to 120.1227 which differ from the corresponding compositions 1.1-1.1227 only in that they comprise the compound I-120 as the active compound A).

Table 120a: Compositions 120.1a to 120.1227a which differ from the corresponding compositions 120.1-120.1227 only in that they comprise the cis-isomer of the compound I-120 as the active compound A).

Table 121: Compositions 121.1 to 121.1227 which differ from the corresponding compositions 1.1-1.1227 only in that they comprise the compound I-121 as the active compound A).

Table 121a: Compositions 121.1a to 121.1227a which differ from the corresponding compositions 121.1-121.1227 only in that they comprise the cis-isomer of the compound I-121 as the active compound A).

Table 122: Compositions 122.1 to 122.1227 which differ from the corresponding compositions 1.1-1.1227 only in that they comprise the compound I-122 as the active compound A).

Table 122a: Compositions 122.1a to 122.1227a which differ from the corresponding compositions 122.1-122.1227 only in that they comprise the cis-isomer of the compound I-122 as the active compound A).

Table 123: Compositions 123.1 to 123.1227 which differ from the corresponding compositions 1.1-1.1227 only in that they comprise the compound I-123 as the active compound A).

Table 123a: Compositions 123.1a to 123.1227a which differ from the corresponding compositions 123.1-123.1227 only in that they comprise the cis-isomer of the compound I-123 as the active compound A).

Table 124: Compositions 124.1 to 124.1227 which differ from the corresponding compositions 1.1-1.1227 only in that they comprise the compound I-124 as the active compound A).

Table 124a: Compositions 124.1a to 124.1227a which differ from the corresponding compositions 124.1-124.1227 only in that they comprise the cis-isomer of the compound I-124 as the active compound A).

Table 125: Compositions 125.1 to 125.1227 which differ from the corresponding compositions 1.1-1.1227 only in that they comprise the compound I-125 as the active compound A).

Table 125a: Compositions 125.1a to 125.1227a which differ from the corresponding compositions 125.1-125.1227 only in that they comprise the cis-isomer of the compound I-125 as the active compound A).

Table 126: Compositions 126.1 to 126.1227 which differ from the corresponding compositions 1.1-1.1227 only in that they comprise the compound I-126 as the active compound A).

Table 126a: Compositions 126.1a to 126.1227a which differ from the corresponding compositions 126.1-126.1227 only in that they comprise the cis-isomer of the compound I-126 as the active compound A).

Table 127: Compositions 127.1 to 127.1227 which differ from the corresponding compositions 1.1-1.1227 only in that they comprise the compound I-127 as the active compound A).

Table 127a: Compositions 127.1a to 127.1227a which differ from the corresponding compositions 127.1-127.1227 only in that they comprise the cis-isomer of the compound I-127 as the active compound A).

Table 128: Compositions 128.1 to 128.1227 which differ from the corresponding compositions 1.1-1.1227 only in that they comprise the compound I-128 as the active compound A).

Table 128a: Compositions 128.1a to 128.1227a which differ from the corresponding compositions 128.1-128.1227 only in that they comprise the cis-isomer of the compound I-128 as the active compound A).

Table 129: Compositions 129.1 to 129.1227 which differ from the corresponding compositions 1.1-1.1227 only in that they comprise the compound I-129 as the active compound A).

Table 129a: Compositions 129.1a to 129.1227a which differ from the corresponding compositions 129.1-129.1227 only in that they comprise the cis-isomer of the compound I-129 as the active compound A).

Table 130: Compositions 130.1 to 130.1227 which differ from the corresponding compositions 1.1-1.1227 only in that they comprise the compound I-130 as the active compound A).

Table 130a: Compositions 130.1a to 130.1227a which differ from the corresponding compositions 130.1-130.1227 only in that they comprise the cis-isomer of the compound I-130 as the active compound A).

Table 131: Compositions 131.1 to 131.1227 which differ from the corresponding compositions 1.1-1.1227 only in that they comprise the compound I-131 as the active compound A).

Table 131a: Compositions 131.1a to 131.1227a which differ from the corresponding compositions 131.1-131.1227 only in that they comprise the cis-isomer of the compound I-131 as the active compound A).

Table 132: Compositions 132.1 to 132.1227 which differ from the corresponding compositions 1.1-1.1227 only in that they comprise the compound I-132 as the active compound A).

Table 132a: Compositions 132.1a to 132.1227a which differ from the corresponding compositions 132.1-132.1227 only in that they comprise the cis-isomer of the compound I-132 as the active compound A).

Table 133: Compositions 133.1 to 133.1227 which differ from the corresponding compositions 1.1-1.1227 only in that they comprise the compound I-133 as the active compound A).

Table 133a: Compositions 133.1a to 133.1227a which differ from the corresponding compositions 133.1-133.1227 only in that they comprise the cis-isomer of the compound I-133 as the active compound A).

Table 134: Compositions 134.1 to 134.1227 which differ from the corresponding compositions 1.1-1.1227 only in that they comprise the compound I-134 as the active compound A).

Table 134a: Compositions 134.1a to 134.1227a which differ from the corresponding compositions 134.1-134.1227 only in that they comprise the cis-isomer of the compound I-134 as the active compound A).

Table 135: Compositions 135.1 to 135.1227 which differ from the corresponding compositions 1.1-1.1227 only in that they comprise the compound I-135 as the active compound A).

Table 135a: Compositions 135.1a to 135.1227a which differ from the corresponding compositions 135.1-135.1227 only in that they comprise the cis-isomer of the compound I-135 as the active compound A).

Table 136: Compositions 136.1 to 136.1227 which differ from the corresponding compositions 1.1-1.1227 only in that they comprise the compound I-136 as the active compound A).

Table 136a: Compositions 136.1a to 136.1227a which differ from the corresponding compositions 136.1-136.1227 only in that they comprise the cis-isomer of the compound I-136 as the active compound A).

Table 137: Compositions 137.1 to 137.1227 which differ from the corresponding compositions 1.1-1.1227 only in that they comprise the compound I-137 as the active compound A).

Table 137a: Compositions 137.1a to 137.1227a which differ from the corresponding compositions 137.1-137.1227 only in that they comprise the cis-isomer of the compound I-137 as the active compound A).

Table 138: Compositions 138.1 to 138.1227 which differ from the corresponding compositions 1.1-1.1227 only in that they comprise the compound I-138 as the active compound A).

Table 138a: Compositions 138.1a to 138.1227a which differ from the corresponding compositions 138.1-138.1227 only in that they comprise the cis-isomer of the compound I-138 as the active compound A).

Table 139: Compositions 139.1 to 139.1227 which differ from the corresponding compositions 1.1-1.1227 only in that they comprise the compound I-139 as the active compound A).

Table 139a: Compositions 139.1a to 139.1227a which differ from the corresponding compositions 139.1-139.1227 only in that they comprise the cis-isomer of the compound I-139 as the active compound A).

Table 140: Compositions 140.1 to 140.1227 which differ from the corresponding compositions 1.1-1.1227 only in that they comprise the compound I-140 as the active compound A).

Table 140a: Compositions 140.1a to 140.1227a which differ from the corresponding compositions 140.1-140.1227 only in that they comprise the cis-isomer of the compound I-140 as the active compound A).

Table 141: Compositions 141.1 to 141.1227 which differ from the corresponding compositions 1.1-1.1227 only in that they comprise the compound I-141 as the active compound A).

Table 141a: Compositions 141.1a to 141.1227a which differ from the corresponding compositions 141.1-141.1227 only in that they comprise the cis-isomer of the compound I-141 as the active compound A).

Table 142: Compositions 142.1 to 142.1227 which differ from the corresponding compositions 1.1-1.1227 only in that they comprise the compound I-142 as the active compound A).

Table 142a: Compositions 142.1a to 142.1227a which differ from the corresponding compositions 142.1-142.1227 only in that they comprise the cis-isomer of the compound I-142 as the active compound A).

Table 143: Compositions 143.1 to 143.1227 which differ from the corresponding compositions 1.1-1.1227 only in that they comprise the compound I-143 as the active compound A).

Table 143a: Compositions 143.1a to 143.1227a which differ from the corresponding compositions 143.1-143.1227 only in that they comprise the cis-isomer of the compound I-143 as the active compound A).

Table 144: Compositions 144.1 to 144.1227 which differ from the corresponding compositions 1.1-1.1227 only in that they comprise the compound I-144 as the active compound A).

Table 144a: Compositions 144.1a to 144.1227a which differ from the corresponding compositions 144.1-144.1227 only in that they comprise the cis-isomer of the compound I-144 as the active compound A).

Table 145: Compositions 145.1 to 145.1227 which differ from the corresponding compositions 1.1-1.1227 only in that they comprise the compound I-145 as the active compound A).

Table 145a: Compositions 145.1a to 145.1227a which differ from the corresponding compositions 145.1-145.1227 only in that they comprise the cis-isomer of the compound I-145 as the active compound A).

Table 146: Compositions 146.1 to 146.1227 which differ from the corresponding compositions 1.1-1.1227 only in that they comprise the compound I-146 as the active compound A).

Table 146a: Compositions 146.1a to 146.1227a which differ from the corresponding compositions 146.1-146.1227 only in that they comprise the cis-isomer of the compound I-146 as the active compound A).

The compositions according to the invention are suitable as herbicides. They are suitable as such or as an appropriately formulated composition. The compositions according to the invention control vegetation on non-crop areas very efficiently, especially at high rates of application. They act against broad-leafed weeds and grass weeds in crops such as wheat, rice, corn, soybeans and cotton without causing any significant damage to the crop plants. This effect is mainly observed at low rates of application.

Depending on the application method in question, the compositions according to the invention can additionally be employed in a further number of crop plants for eliminating undesirable plants. Examples of suitable crops are the following:

Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera, Zea mays.

The following crops are preferably suitable: Arachis hypogaea, Beta vulgaris spec. altissima, Brassica napus var. napus, Brassica oleracea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N. rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (s. vulgare), Triticale, Triticum aestivum, Triticum durum, Vicia faba, Vitis vinifera and Zea mays.

In addition, the compositions according to the invention may also be used in crops which tolerate the action of herbicides owing to breeding, including genetic engineering methods.

In addition, the compositions according to the invention can also be used in crops which tolerate insects or fungal attack as the result of breeding, including genetic engineering methods.

Furthermore, it has been found that the compositions according to the invention are also suitable for the defoliation and/or desiccation of plant parts, for which crop plants such as cotton, potato, oilseed rape, sunflower, soybean or field beans, in particular cotton, are suitable. In this regard, there have been found compositions for the desiccation and/or defoliation of plants, processes for preparing these compositions and methods for desiccating and/or defoliating plants using the compositions according to the invention.

As desiccants, the compositions according to the invention are suitable in particular for desiccating the above-ground parts of crop plants such as potato, oilseed rape, sunflower and soybean, but also cereals. This makes possible the fully mechanical harvesting of these important crop plants.

Also of economic interest is the facilitation of harvesting, which is made possible by concentrating within a certain period of time the dehiscence, or reduction of adhesion to the tree, in citrus fruit, olives and other species and varieties of pomaceous fruit, stone fruit and nuts. The same mechanism, i.e. the promotion of the development of abscission tissue between fruit part or leaf part and shoot part of the plants is also essential for the controlled defoliation of useful plants, in particular cotton. Moreover, a shortening of the time interval in which the individual cotton plants mature leads to an increased fiber quality after harvesting.

The compositions according to the invention or the crop protection compositions comprising them or formulated therefrom can be used, for example, in the form of ready-to-spray aqueous solutions, powders, suspensions, also highly concentrated aqueous, oily or other suspensions or dispersions, emulsions, oil dispersions, pastes, dusts, materials for broadcasting, or granules, by means of spraying, atomizing, dusting, broadcasting or watering or treatment of the seed or mixing with the seed. The use forms depend on the intended purpose; in any case, they should ensure the finest possible distribution of the active compounds according to the invention.

The crop protection compositions comprise a herbicidally effective amount of the composition according to the invention, i.e. at least one compound I or an agriculturally useful salt of I and at least one further active compound, selected from herbicides B and the abovementioned safeners C, and also auxiliaries customary for formulating crop protection agents.

Examples of auxiliaries customary for the formulation of crop protection agents are inert auxilaries, solid or liquid carriers, surfactants (such as dispersants, protective colloids, emulsifiers, wetting agents and tackifiers), organic and inorganic thickeners, bactericides, antifreeze agents, antifoams, optionally colorants and, for seed formulations, adhesives.

Examples of thickeners (i.e. compounds which impart to the formulation modified flow properties, i.e. high viscosity in the state of rest and low viscosity in motion) are polysaccharides, such as xanthan gum (Kelzan® from Kelco), Rhodopol® 23 (Rhone Poulenc) or Veegum® (from R.T. Vanderbilt), and also organic and inorganic sheet minerals, such as Attaclay® (from Engelhardt).

Examples of antifoams are silicone emulsions (such as, for example, Silikon® SRE, Wacker or Rhodorsil® from Rhodia), long-chain alcohols, fatty acids, salts of fatty acids, organofluorine compounds and mixtures thereof.

Bactericides can be added for stabilizing the aqueous herbicidal formulations. Examples of bactericides are bactericides based on dichlorophen and benzyl alcohol hemiformal (Proxel® from ICI or Acticide® RS from Thor Chemie and Kathon® MK from Rohm & Haas), and also isothiazolinone derivates, such as alkylisothiazolinones and benzisothiazolinones (Acticide MBS from Thor Chemie).

Examples of antifreeze agents are ethylene glycol, propylene glycol, urea or glycerol.

Examples of colorants are both sparingly water-soluble pigments and water-soluble dyes. Examples which may be mentioned are the dyes known under the names Rhodamin B, C.I. Pigment Red 112 and C.I. Solvent Red 1, and also pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples of adhesives are polyvinylpyrrolidone, polyvinyl acetate, polyvinyl alcohol and tylose.

Suitable inert auxiliaries are in particular liquid or solid carriers. Examples of liquid carriers are: mineral oil fractions of medium to high boiling point, such as kerosene and diesel oil, furthermore coal tar oils and oils of vegetable or animal origin, aliphatic, cyclic and aromatic hydrocarbons, for example paraffin, tetrahydronaphthalene, alkylated naphthalenes and their derivatives, alkylated benzenes and their derivatives, alcohols such as methanol, ethanol, propanol, butanol and cyclohexanol, ketones such as cyclohexanone, strongly polar solvents, for example amines such as N-methylpyrrolidone, and water. Solid carriers are for example mineral earths such as silicas, silica gels, silicates, talc, kaolin, limestone, lime, chalk, bole, loess, clay, dolomite, diatomaceous earth, calcium sulfate, magnesium sulfate and magnesium oxide, ground synthetic materials, fertilizers such as ammonium sulfate, ammonium phosphate, ammonium nitrate and ureas, and products of vegetable origin, such as cereal meal, tree bark meal, wood meal and nutshell meal, cellulose powders, or other solid carriers.

Suitable surfactants (adjuvants, wetting agents, tackifiers, dispersants and also emulsifiers) are the alkali metal salts, alkaline earth metal salts and ammonium salts of aromatic sulfonic acids, for example lignosulfonic acids (e.g. Borrespers-types, Borregaard), phenolsulfonic acids, naphthalenesulfonic acids (Morwet types, Akzo Nobel) and dibutylnaphthalenesulfonic acid (Nekal types, BASF AG), and of fatty acids, alkyl- and alkylarylsulfonates, alkyl sulfates, lauryl ether sulfates and fatty alcohol sulfates, and salts of sulfated hexa-, hepta- and octadecanols, and also of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl or tributylphenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors and proteins, denaturated proteins, polysaccharides (e.g. methylcellulose), hydrophobically modified starches, polyvinyl alcohol (Mowiol types Clariant), polycarboxylates (BASF AG, Sokalan types), polyalkoxylates, polyvinylamine (BASF AG, Lupamine types), polyethyleneimine (BASF AG, Lupasol types), polyvinylpyrrolidone and copolymers thereof.

Powders, materials for broadcasting and dusts can be prepared by mixing or grinding the active ingredients together with a solid carrier.

Granules, for example coated granules, impregnated granules and homogeneous granules, can be prepared by binding the active ingredients to solid carriers.

Aqueous use forms can be prepared from emulsion concentrates, suspensions, pastes, wettable powders or water-dispersible granules by adding water. To prepare emulsions, pastes or oil dispersions, the compounds of the formula I, specifically I.a and I.b, either as such or dissolved in an oil or solvent, can be homogenized in water by means of a wetting agent, tackifier, dispersant or emulsifier. Alternatively, it is also possible to prepare concentrates comprising active compound, wetting agent, tackifier, dispersant or emulsifier and, if desired, solvent or oil, which are suitable for dilution with water.

The concentrations of the active compounds in the ready-to-use preparations can be varied within wide ranges. In general, the formulations comprise from 0.001 to 98% by weight, preferably 0.01 to 95% by weight of at least one active compound. The active compounds are employed in a purity of from 90% to 100%, preferably 95% to 100% (according to NMR spectrum).

The compositions of the invention can for example be formulated as follows:

1. Products for dilution with water

A Water-soluble concentrates
10 parts by weight of active compound are dissolved in 90 parts by weight of water or a water-soluble solvent. As an alternative, wetters or other adjuvants are added. The active compound dissolves upon dilution with water. This gives a formulation with an active compound content of 10% by weight.

B Dispersible concentrates
20 parts by weight of active compound are dissolved in 70 parts by weight of cyclohexanone with addition of 10 parts by weight of a dispersant, for example polyvinylpyrrolidone. Dilution with water gives a dispersion. The active compound content is 20% by weight

C Emulsifiable concentrates
15 parts by weight of active compound are dissolved in 75 parts by weight of an organic solvent (eg. alkylaromatics) with addition of calcium dodecylbenzenesulfonate and castor oil ethoxylate (in each case 5 parts by weight). Dilution with water gives an emulsion. The formulation has an active compound content of 15% by weight.

D Emulsions
25 parts by weight of active compound are dissolved in 35 parts by weight of an organic solvent (eg. alkylaromatics) with addition of calcium dodecylbenzenesulfonate and castor oil ethoxylate (in each case 5 parts by weight). This mixture is introduced into 30 parts by weight of water by means of an emulsifier (e.g. Ultraturrax) and made into a homogeneous emulsion. Dilution with water gives an emulsion. The formulation has an active compound content of 25% by weight.

E Suspensions
In an agitated ball mill, 20 parts by weight of active compound are comminuted with addition of 10 parts by weight of dispersants and wetters and 70 parts by weight of water or an organic solvent to give a fine active compound suspension. Dilution with water gives a stable suspension of the active compound. The active compound content in the formulation is 20% by weight.

F Water-dispersible granules and water-soluble granules
50 parts by weight of active compound are ground finely with addition of 50 parts by weight of dispersants and wetters and made into water-dispersible or water-soluble granules by means of technical appliances (for example extrusion, spray tower, fluidized bed). Dilution with water gives a stable dispersion or solution of the active compound. The formulation has an active compound content of 50% by weight.

G Water-dispersible powders and water-soluble powders
75 parts by weight of active compound are ground in a rotor-stator mill with addition of 25 parts by weight of dispersants, wetters and silica gel. Dilution with water gives a stable dispersion or solution of the active compound. The active compound content of the formulation is 75% by weight.

H Gel formulations
In a ball mill, 20 parts by weight of active compound, 10 parts by weight of dispersant, 1 part by weight of gelling agent and 70 parts by weight of water or of an organic solvent are mixed to give a fine suspension. Dilution with water gives a stable suspension with active compound content of 20% by weight.

2. Products to be applied undiluted

I Dusts
5 parts by weight of active compound are ground finely and mixed intimately with 95 parts by weight of finely divided kaolin. This gives a dusting powder with an active compound content of 5% by weight.

J Granules (GR, FG, GG, MG)
0.5 parts by weight of active compound are ground finely and associated with 99.5 parts by weight of carriers. Current methods here are extrusion, spray-drying or the fluidized bed. This gives granules to be applied undiluted with an active compound content of 0.5% by weight.

K ULV solutions (UL)
10 parts by weight of active compound are dissolved in 90 parts by weight of an organic solvent, for example xylene. This gives a product to be applied undiluted with an active compound content of 10% by weight.

In the ready-to-use preparations, i.e. in the compositions according to the invention in the form of crop protection compositions, the components A and B and/or C can be present formulated jointly or separately in suspended, emulsified or dissolved form. The use forms depend entirely on the intended applications.

Accordingly, a first embodiment of the invention relates to compositions in the form of a crop protection composition formulated as a 1-component composition comprising the at least one active compound of the formula I (active compound A) and at least one further active compound selected from the herbicides B and the safeners C and also a solid or liquid carrier and, if appropriate, one or more surfactants.

Accordingly, a second embodiment of the invention relates to compositions in the form of a crop protection composition formulated as a 2-component composition comprising a first formulation (component) comprising the at least one active compound A, a solid or liquid carrier and, if appropriate, one or more surfactants, and a second component comprising at least one further active compound selected from the herbicides B and safeners C, a solid or liquid carrier and, if appropriate, one or more surfactants.

The active compound A and the at least one further active compound B and/or C can be applied jointly or separately, simultaneously or in succession, before, during or after the emergence of the plants. The order of the application of the active compounds A, B and/or C is of minor importance. The only thing that is important is that the at least one active compound A and the at least one further active compound B and/or C are present simultaneously at the site of action, i.e. are at the same time in contact with or taken up by the plant to be controlled.

The required application rate of pure active compound composition, i.e. A and B and, if appropriate, C without formulation auxiliaries depends on the composition of the plant stand, on the development stage of the plants, on the climatic conditions at the site of use and on the application technique. In general, the application rate of A and B and, if appropriate, C, is from 0.001 to 3 kg/ha, preferably from 0.005 to 2.5 kg/ha and in particular from 0.01 to 2 kg/ha of active substance (a.s.).

The required application rates of compounds I are generally in the range of from 0.0005 kg/ha to 2.5 kg/ha and preferably in the range of from 0.005 kg/ha to 2 kg/ha or 0.01 kg/ha to 1.5 kg/h of a.s.

The required application rates of compounds B are generally in the range of from 0.0005 kg/ha to 2.5 kg/ha and preferably in the range of from 0.005 kg/ha to 2 kg/ha or 0.01 kg/ha to 1.5 kg/h of a.s.

The required application rates of compounds C are generally in the range of from 0.0005 kg/ha to 2.5 kg/ha and preferably in the range of from 0.005 kg/ha to 2 kg/ha or 0.01 kg/ha to 1.5 kg/h of a.s.

The compositions are applied to the plants mainly by spraying the leaves. Here, the application can be carried out using, for example, water as carrier by customary spraying techniques using spray liquor amounts of from about 100 to 1000 I/ha (for example from 300 to 400 I/ha). The herbicidal compositions may also be applied by the low-volume or the ultra-low-volume method, or in the form of microgranules.

The compounds I or the herbicidal compositions comprising them can be applied pre- or post-emergence, or together with the seed of a crop plant. It is also possible to apply the compositions by applying seed, pretreated with a composition of the invention, of a crop plant. If the active compounds A and B and, if appropriate C, are less well tolerated by certain crop plants, application techniques may be used in which the herbicidal compositions are sprayed, with the aid of the spraying equipment, in such a way that as far as possible they do not come into contact with the leaves of the sensitive crop plants, while the active compounds reach the leaves of undesirable plants growing underneath, or the bare soil surface (post-directed, lay-by).

In a further embodiment, the composition can be applied by treating seed.

The treatment of seed comprises essentially all procedures familiar to the person skilled in the art (seed dressing, seed coating, seed dusting, seed soaking, seed film coating, seed multilayer coating, seed encrusting, seed dripping and seed pelleting) based on the compounds of the formula I according to the invention or the compositions prepared therefrom. Here, the herbicidal compositions can be applied diluted or undiluted.

The term seed comprises seed of all types, such as, for example, corns, seeds, fruits, tubers, seedlings and similar forms. Here, preferably, the term seed describes corns and seeds.

The seed used can be seed of the useful plants mentioned above, but also the seed of transgenic plants or plants obtained by customary breeding methods.

The rates of application of the active compound are from 0.001 to 3.0, preferably 0.01 to 1.0, kg/ha of active substance (a.s.), depending on the control target, the season, the target plants and the growth stage. To treat the seed, the compounds I are generally employed in amounts of from 0.001 to 10 kg per 100 kg of seed.

Moreover, it may be advantageous to apply the compounds I on their own or jointly in combination with other crop protection agents, for example with agents for controlling pests or phytopathogenic fungi or bacteria or with groups of active compounds which regulate growth. Also of interest is the miscibility with mineral salt solutions which are employed for treating nutritional and trace element deficiencies. Non-phytotoxic oils and oil concentrates can also be added.

The following examples serve to illustrate the invention.

### A PREPARATION EXAMPLES

The products were characterized by their retention time RT (in min) in HPLC/MS (high performance liquid chromatography-coupled mass spectrometry), by NMR or by their melting point (m.p.).

HPLC column: RP-18 column (Chromolith Speed ROD from Merck KgaA, Germany)
Mobile phase: acetonitrile+0.1% trifluoroacetic acid (TFA)/water+0.1% TFA in a gradient of from 5:95 to 95:5 over 5 minutes at 40° C., flow rate 1.8 ml/min.
MS: Quadrupole electrospray ionization, 80 V (positive mode)

### Example 1

### 3-Benzyl-6-[1-(2-nitrophenyl)methylidene]-1,4-dimethylpiperazine-2,5-dione

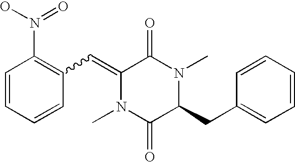

### 1.1 Ethyl 2-(tert-butoxycarbonylmethylamino)-3-(2-nitrophenyl)-3-trimethylsilanyloxy-propionate

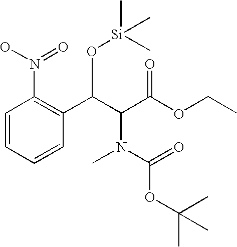

At −78° C., lithium diisopropylamide solution (2 M in tetrahydrofuran/n-heptane, 46 ml, 92 mmol) was slowly added dropwise to ethyl (tert-butoxycarbonylmethyl-amino)acetate (20 g, 92 mmol) in tetrahydrofuran (THF) (abs., 50 ml). The mixture was stirred at this temperature for 3 h. 2-Nitrobenzaldehyde (13.6 g, 90 mmol) in THF (tetrahydrofuran, absolute, 30 ml) was then slowly added dropwise. The mixture was stirred at −78° C. for 1.5 h, and trimethylsilyl chloride (10 g, 92 mmol) was then added dropwise. The reaction solution was slowly (12 h) warmed to room temperature and then concentrated on a rotary evaporator. The residue was taken up in ethyl acetate, washed, dried and concentrated. The residue obtained in this manner was then purified by column chromatography (SiO₂, hexane/ethyl acetate). This gave 7.1 g (18%) of an unpolar isomer which was reacted further in the next step.

M+Na (m/z): 463.

### 1.2 Ethyl 3-hydroxy-2-methylamino-3-(2-nitrophenyl)propionate

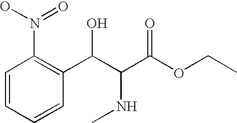

Trifluoroacetic acid (20 ml) was added to ethyl 2-(tert-butoxycarbonylmethyl-amino)-3-(2-nitrophenyl)-3-trimethylsilanyloxypropionate (8.6 g, 19.5 mmol) in CH₂Cl₂ (100 ml), and the mixture was stirred at room temperature for 12 h. The mixture was then neutralized with NaHCO₃ solution (saturated), the phases were separated and the organic phase was concentrated. The residue obtained in this manner was purified by column chromatography (SiO₂, hexane/ethyl acetate). This gave 1.7 g (32%) of the target compound as a light-yellow solid.

M+1 (m/z): 269.

### 1.3 Ethyl 2-{([2-(tert-butoxycarbonylmethylamino)-3-phenylpropionyl]methylamino}-3-hydroxy-3-(2-nitrophenyl)propionate

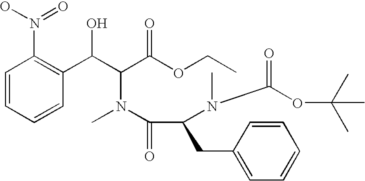

Ethyl 3-hydroxy-2-methylamino-3-(2-nitrophenyl)propionate (1.7 g, 6.3 mmol), 2-(tert-butoxycarbonylmethylamino)-3-phenylpropionic acid (2 g, 7 mmol), N-ethyldiisopropylamine (4.5 g, 35 mmol) and EDAC (3 g, 15.6 mmol) were stirred in THF (abs., 50 ml) for 3 days. The reaction solution was concentrated on a rotary evaporator. The residue was taken up in ethyl acetate, and the solution obtained was washed, dried and concentrated. This gave 2.1 g (63%) of the target compound as a light-yellow oil.

M+1 (m/z): 530.

### 1.4 Ethyl 3-hydroxy-2-[methyl-(2-methylamino-3-phenylpropionyl)amino]-3-(2-nitro-phenyl)propionate

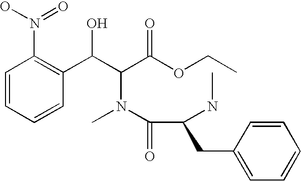

Trifluoroacetic acid (10 ml) was added to ethyl 2-{[2-(tert-butoxycarbonylmethyl-amino)-3-phenylpropionyl]methylamino}-3-hydroxy-3-(2-nitrophenyl)propionate (2.1 g, 3.9 mmol) in CH₂Cl₂(20 ml), and the mixture was stirred at room temperature for 2 h and then concentrated on a rotary evaporator. In the subsequent step, the residue obtained in this manner was reacted as crude product.

### 1.5 3-Benzyl-6-[hydroxy-(2-nitrophenyl)methyl]-1,4-dimethylpiperazine-2,5-dione

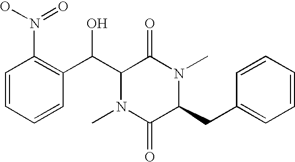

The residue obtained under 1.4 was taken up in THF (50 ml), and NH₄OH (25% in H₂O, 10 ml) was added. The mixture was stirred at room temperature for 12 h. After addition of H₂O (100 ml), the mixture was extracted with methyl tert-butyl ether and the organic phase was dried and concentrated. The residue obtained in this manner was purified by column chromatography (SiO₂, hexane/ethyl acetate). This gave 0.57 g (38%) of a polar isomer which was reacted further in the next step.

M+1 (m/z): 384.

### 1.6 (5-Benzyl-1,4-dimethyl-3,6-dioxopiperazin-2-yl)-(2-nitrophenyl)methyl methanesulfonate

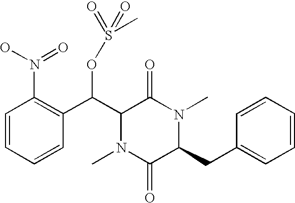

DMAP (1.8 g, 14.7 mmol) and methanesulfonyl chloride (30 ml) were added to 3-benzyl-6-[hydroxy-(2-nitrophenyl)methyl]-1,4-dimethylpiperazine-2,5-dione (5.5 g, 14.3 mmol) in pyridine (100 ml), and the mixture was stirred at room temperature for 12 h and then concentrated on a rotary evaporator. After addition of H₂O and CH₂Cl₂, the insoluble black resins were filtered off over a notch, the phases were separated and the organic phase was concentrated. The residue obtained in this manner was purified by column chromatography (SiO₂, hexane/ethyl acetate). This gave 5.1 g (77%) of the target compound as a light-yellow foam.

M+1 (m/z): 462.

### 1.7 3-Benzyl-6-[1-(2-nitrophenyl)methylidene]-1,4-dimethylpiperazine-2,5-dione

At 0° C., (1,8-diazabicyclo[5,4,0]undec-7-ene, DBU 1.4 g, 9 mmol) was slowly added dropwise to (5-benzyl-1,4-dimethyl-3,6-dioxopiperazin-2-yl)-(2-nitrophenyl)methyl methanesulfonate (4.25 g, 9 mmol) in THF (100 ml), and the mixture was stirred at 0° C. for 4 h. At this temperature, the pH was then adjusted to 7 using citric acid (10%), and the mixture was then allowed to warm slowly to room temperature. After addition of H₂O and ethyl acetate, the phases were separated and the organic phase was concentrated. The residue obtained in this manner was purified by column chromatography (SiO₂, methyl tert-butyl ether/ethyl acetate). This gave 2.5 g (76%) of the target compound as a yellow foam.

The Z:E isomer mixture obtained in this manner was separated by preparative MPLC (silica gel: Merck Lichroprep RP-18 (40-63 μm), CH₃OH:H₂O=60:40). ¹H-NMR (CDCl₃) of the separated isomers:

### a) δ=2.62 (s, 3H), 3.09 (s, 3H), 3.23 (m, 2H), 4.39 (m, 1H), 6.39 (d, 1H), 7.13 (s, 1H), 7.17 (m, 1H), 7.24 (m, 1H), 7.32 (m, 2H), 7.44 (m, 1H), 7.49 (m, 1H), 8.05 (d, 2H).

### b) δ=2.91 (s, 3H), 3.15 (dm, 1H), 3.33 (s, 3H), 3.29 (dm, 1H), 4.32 (m, 1H), 6.28 (s, 1H), 6.75 (m, 1H), 7.08 (m, 2H), 7.32 (m, 3H), 7.39 (m, 1H), 7.47 (m, 1H), 8.04 (d, 1H).

### Example 15

### 2-[5-Benzyl-1,4-dimethyl-3,6-dioxopiperazin-2-ylidenemethyl]-3,4-difluoro-benzonitrile

In a reaction vessel, 2.0 g of 2-[5-benzyl-1,4-dimethyl-3,6-dioxopiperazin-2-ylidene-methyl]-3,4-difluoro-1-bromobenzene (prepared analogously to example 1) were reacted under an atmosphere of argon at 155° C. with 1.7 g of copper(I) cyanide in 50 ml of N-methylpyrrolidone for 18 h. The reaction mixture was concentrated under reduced pressure, the residue was taken up in ethyl acetate and the solution obtained was washed 3 times with water, dried and again concentrated under reduced pressure. The residue was chromatographed on silica gel using hexane/ethyl acetate (1:1 v/v). This gave 331 mg of the Z isomer as a light-yellow solid of melting point 175° C. and 310 mg of the E isomer as a beige solid of melting point 205° C.

### Example 20

### 2-[5-Benzyl-1,4,5-trimethyl-3,6-dioxopiperazin-2-ylidenemethyl]benzo-nitrile

CuCN (0.7 g, 7.8 mmol) was added to a solution of 3-benzyl-6-(2-bromobenzylidene)-1,3,4-trimethylpiperazine-2,5-dione (prepared analogously to example 1) (1.5 g, 3.6 mmol) in N-methylpyrrolidine (NMP, 25 ml). The reaction mixture was stirred at 155° C. for 16 h and, after cooling to room temperature, introduced into ethyl acetate. The reaction mixture was diluted with methyl tert-butyl ether. The organic phase obtained in this manner was washed with water, dried over Na₂SO₄, filtered and freed from the solvent under reduced pressure. Purification by column chromatography gave 2-[5-benzyl-1,4,5-trimethyl-3,6-dioxopiperazin-2-ylidenemethyl]benzonitrile in an amount of 0.79 g (yield 61%).

HPLC-MS [m/z]: 360.5 [M+1]⁺.

### Example 20a

### Alternative preparation of 3-benzyl-6-(2-bromobenzylidene)-1,3,4-trimethylpiperazin-2,5-dione

### 20a.1 Preparation of methyl (2-tert-butoxycarbonylamino-3-phenylpropionylamino)-acetate

At 0° C., ethyldiisopropylamine (259 g, 2.0 mol), N-tert-butoxycarbonyl-L-phenylalanine (212 g, 0.8 mol) and 1-ethyl-3-(3′-dimethylaminopropyl)carbodiimide (EDAC, 230 g, 1.2 mol) were added to a solution of glycine methyl ester hydrochloride (100 g, 0.8 mol) in tetrahydrofuran (THF, 1000 ml). The reaction mixture was then stirred at room temperature for 24 h. The reaction mixture obtained was freed from volatile components under reduced pressure, and the residue obtained in this manner was taken up in water (1000 ml). The aqueous phase was extracted repeatedly with CH₂Cl₂. The organic phases obtained in this manner were combined, washed with water, dried over Na₂SO₄, filtered and freed from the solvent under reduced pressure. Methyl (2-tert-butoxycarbonylamino-3-phenylpropionylamino)acetate was obtained as a yellow oil in an amount of 300 g. The crude product obtained was reacted further without further purification.

### 20a.2 Preparation of 3-benzylpiperazine-2,5-dione

At room temperature, trifluoroacetic acid (342 g, 3 mol) was added dropwise to a solution of methyl (2-tert-butoxycarbonylamino-3-phenylpropionylamino)acetate (300 g, about 0.8 mol) in CH₂Cl₂. The reaction mixture obtained was stirred at room temperature for 24 h and then concentrated under reduced pressure. The residue obtained was taken up in THF (500 ml), and an aqueous ammonia solution (25% strength, 500 ml) was added slowly. The reaction mixture was stirred at room temperature for another 72 h. The precipitated solid was isolated by filtration and washed with water. 3-Benzylpiperazine-2,5-dione was obtained in an amount of 88 g (yield 54%).

### 20a.3 Preparation of 1,4-diacetyl-3-benzylpiperazine-2,5-dione

A solution of 3-benzylpiperazine-2,5-dione (20.4 g, 0.1 mol) in acetic anhydride (200 ml) was stirred under reflux conditions for 4 h. The reaction mixture obtained was concentrated under reduced pressure. The residue was taken up in CH₂Cl₂, washed successively with an aqueous NaHCO₃ solution and water, dried over Na₂SO₄, filtered and freed from the solvent under reduced pressure. 1,4-Diacetyl-3-benzylpiperazine-2,5-dione was obtained as a yellow oil in an amount of 28.5 g (quantitative) and reacted further as crude product.

HPLC-MS [m/z]: 289.1 [M+1]⁺.

### 20a.4 Preparation of 1-acetyl-6-benzyl-3-(2-bromobenzylidene)piperazine-2,5-dione

Bromobenzaldehyde (5.55 g, 0.03 mol) and Cs₂CO₃ (9.8 g, 0.03 mol) were added to a solution of 1,4-diacetyl-3-benzylpiperazine-2,5-dione (17.4 g, 0.06 mol) in dimethylformamide (DMF, 100 ml). The reaction mixture was stirred at room temperature for 36 h, water (500 ml) and citric acid (10 g) were then added and the mixture was extracted repeatedly with CH₂Cl₂. The organic phases obtained in this manner were combined, washed with water, dried over Na₂SO₄, filtered and freed from the solvent under reduced pressure. After purification by column chromatography (mobile phase: CH₂Cl₂), 1-acetyl-6-benzyl-3-(2-bromo-benzylidene)piperazine-2,5-dione was obtained as a yellow oil in an amount of 12 g (yield 48%).

HPLC-MS [m/z]: 413.9 [M+1]⁺.

### 20a.5 Preparation of 3-benzyl-6-(2-bromobenzylidene)piperazine-2,5-dione

Dilute aqueous HCl solution (5% strength, 250 ml) was added to a solution of 1-acetyl-6-benzyl-3-(2-bromobenzylidene)piperazine-2,5-dione (12 g, 0.03 mol) in THF (50 ml). The reaction mixture was stirred under reflux conditions for 8 h. After cooling of the reaction solution, the precipitated solid was isolated by filtration. The solid obtained in this manner was washed with water and THF. 3-Benzyl-6-(2-bromobenzylidene)piperazine-2,5-dione was obtained as a colorless solid in an amount of 8.3 g (yield 75%).

HPLC-MS [m/z]: 371.2 [M]⁺.

### 20a.6 Preparation of 3-benzyl-6-(2-bromobenzylidene)-1,3,4-trimethylpiperazine-2,5-dione

At 0° C., NaH (0.85 g, 60%, 21 mmol) was added to a solution of 3-benzyl-6-(2-bromobenzylidene)piperazine-2,5-dione (2.00 g, 5.4 mmol) in DMF (50 ml). The reaction mixture was stirred at 0° C. for 2 h, and MeI (5.0 g, 35 mmol) was then added. The reaction mixture was stirred at room temperature for a further 18 h, and water was then added. The mixture was extracted repeatedly with methyl tert-butyl ether. The organic phases obtained in this manner were combined, washed with water, dried over Na₂SO₄, filtered and freed from the solvent under reduced pressure. After purification by column chromatography, 3-benzyl-6-(2-bromobenzylidene)-1,3,4-trimethylpiperazine-2,5-dione was obtained in an amount of 1.6 g (yield 72%).

HPLC-MS [m/z]: 413.0 [M]⁺.

The compounds I.a listed in table B below were prepared in an analogous manner.

TABLE B

| | |
|---|---|
| | (I.a) |
| 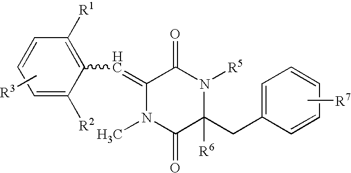 | |

| | | | | | | | RT HPLC/MS | |
|---|---|---|---|---|---|---|---|---|
| Ex. No. | R¹ | R² | R³ | R⁵ | R⁶ | R⁷ | or m.p. | Isomer* |
| 1 | NO₂ | H | H | CH₃ | H | H | 2.831 min | n.d. |
| | | | | | | | m/z = 366.0 | |
| | | | | | | | [M + H]⁺ | |
| 2 | NO₂ | H | H | H | H | H | 2.724 min | isomer 1 |
| | | | | | | | m/z = 352.4 | |
| | | | | | | | [M + H]⁺ | |
| 3 | NO₂ | H | H | H | H | H | 2.773 min | isomer 2 |
| | | | | | | | m/z = 352.4 | |
| | | | | | | | [M + H]⁺ | |
| 4 | NO₂ | CH₃ | H | CH₃ | H | H | 3.088 min | isomer 1 |
| | | | | | | | m/z = 380.0 | |
| | | | | | | | [M + H]⁺ | |
| 5 | NO₂ | CH₃ | H | CH₃ | H | H | 3.091 min | isomer 2 |
| | | | | | | | m/z = 380.0 | |
| | | | | | | | [M + H]⁺ | |
| 6 | CN | H | H | CH₃ | H | H | 2.721 min | n.d. |
| | | | | | | | m/z = 346.1 | |
| | | | | | | | [M + H]⁺; | |
| | | | | | | | 143° C. | |
| 7 | NO₂ | H | 5-F | CH₃ | H | H | 2.973 min | isomer 1 |
| | | | | | | | m/z = 384.4 | |
| | | | | | | | [M + H]⁺ | |
| 8 | NO₂ | H | 5-F | CH₃ | H | H | 3.037 min | isomer 2 |
| | | | | | | | m/z = 384.4 | |
| | | | | | | | [M + H]⁺ | |
| 9 | CN | F | H | CH₃ | H | H | 3.033 min | n.d. |
| | | | | | | | m/z = 364.1 | |
| | | | | | | | [M + H]⁺ | |
| | | | | | | | 138° C. | |
| 10 | CN | H | H | H | H | H | 2.656 min | n.d. |
| | | | | | | | m/z = 332.1 | |
| | | | | | | | [M + H]⁺; | |
| | | | | | | | 158° C. | |
| 11 | CN | H | 5-F | CH₃ | H | H | 2.939 min | isomer 1 |
| | | | | | | | m/z = 364.4 | |
| | | | | | | | [M + H]⁺ | |
| 12 | CN | H | 5-F | CH₃ | H | H | 2.950 min | isomer 2 |
| | | | | | | | m/z = 364.1 | |
| | | | | | | | [M + H]⁺ | |
| | | | | | | | 128° C. | |
| 13 | CN | H | 4-F | CH₃ | H | H | 2.848 min | n.d. |
| | | | | | | | m/z = 386.1 | |
| | | | | | | | [M + Na]⁺ | |
| 14 | CN | H | H | CH₃ | H | H | 2.816 min | n.d. |
| | | | | | | | m/z = 346.4 | |
| | | | | | | | [M + H]⁺ | |
| | | | | | | | 209° C. | |
| 15 | CN | F | 5-F | CH₃ | H | H | 3.153 min | n.d. |
| | | | | | | | m/z = 382.1 | |
| | | | | | | | [M + H]⁺; | |
| | | | | | | | 175° C. | |
| 16 | CN | CH═CH₂ | H | CH₃ | H | H | 3.143 min | isomer 1 |
| | | | | | | | m/z = 372.1 | |
| | | | | | | | [M + H]⁺ | |
| 17 | CN | CH═CH₂ | H | CH₃ | H | H | 3.261 min | isomer 2 |
| | | | | | | | m/z = 372.0 | |
| | | | | | | | [M + H]⁺ | |
| 18 | NO₂ | CH═CH₂ | H | CH₃ | H | H | m/z = 392.3 | isomer 1 |
| | | | | | | | [M + H]⁺ | |
| 19 | NO₂ | CH═CH₂ | H | CH₃ | H | H | m/z = 392.3 | isomer 2 |
| | | | | | | | [M + H]⁺ | |
| 20 | CN | H | H | CH₃ | CH₃ | H | 3.014 min | Z |
| | | | | | | | m/z = 360.5 | |
| | | | | | | | [M + H]⁺ | |
| | | | | | | | 160-162° C. | |
| 20a** | CN | H | H | CH₃ | CH₃ | H | 136° C. | Z |
| 21 | CN | H | H | CH₃ | CH₃ | H | 2.871 min | E |
| | | | | | | | m/z = 360.0 | |
| | | | | | | | [M + H]⁺ | |
| 22 | CN | F | H | CH₃ | CH₃ | H | 3.092 min | Z |
| | | | | | | | m/z = 378.3 | |
| | | | | | | | [M + H]⁺ | |
| | | | | | | | 88-90° C. | |
| 23 | CN | CH₃ | H | CH₃ | CH₃ | H | 3.110 min | Z |
| | | | | | | | m/z = 374.4 | |
| | | | | | | | [M + H]⁺ | |
| 24 | CN | CH₃ | H | CH₃ | CH₃ | H | 3.204 min | E |
| | | | | | | | m/z = 374.4 | |
| | | | | | | | [M + H]⁺ | |
| 25 | CN | F | 5-F | CH₃ | CH₃ | H | 3.170 min | Z |
| | | | | | | | m/z = 396.0 | |
| | | | | | | | [M + H]⁺; | |
| | | | | | | | 58° C. | |
| 26 | NO₂ | H | H | CH₃ | CH₃ | H | 2.980 min | Z:E = |
| | | | | | | | m/z = 379.9 | 60:40 |
| | | | | | | | [M + H]⁺ | |
| 26a | NO₂ | H | H | CH₃ | CH₃ | H | 152° C. | Z |
| 26b** | NO₂ | H | H | CH₃ | CH₃ | H | 106° C. | Z:E = |
| | | | | | | | | 9:1 |
| 27 | CN | ethyl | H | CH₃ | CH₃ | H | 3.315 min | Z |
| | | | | | | | m/z = 388.0 | |
| | | | | | | | [M + H]⁺ | |
| | | | | | | | 74-76° C. | |
| 28 | CN | H | H | H | CH₃ | H | 2.752 min | Z |
| | | | | | | | m/z = 346.4 | |
| | | | | | | | [M + H]⁺ | |
| | | | | | | | 133° C. | |
| 29** | CN | H | H | H | CH₃ | H | 65° C. | Z |
| 30 | NO₂ | H | H | H | CH₃ | H | 2.900 min | Z |
| | | | | | | | m/z = 366.1 | |
| | | | | | | | [M + H]⁺; | |
| | | | | | | | 150° C. | |
| 31 | NO₂ | H | H | CH₂CH₃ | CH₃ | H | 3.290 min | Z |
| | | | | | | | m/z = 394.1 | |
| | | | | | | | [M + H]⁺; | |
| | | | | | | | 123° C. | |
| 32 | CN | H | H | CH₃ | CH₃ | 4-Cl | 3.193 min | Z |
| | | | | | | | m/z = 394.4 | |
| | | | | | | | [M + H]⁺; | |
| | | | | | | | 163° C. | |
| 33 | CN | H | H | CH₃ | CH₃ | 4-F | 2.934 min | Z |
| | | | | | | | m/z = 377.9 | |
| | | | | | | | [M + H]⁺ | |

| | |
|---|---|
| Ex. No. | example number |
| RT | retention time |
| m.p. | melting point |
| n.d. | not determined |

*) These data refer to the stereochemistry of the double bond on the piperazine skeleton
Except for the compounds marked **, the compounds are in each case racemic
compounds with respect to the stereocenter at the piperazine skeleton. The compounds
marked **) are derived from L-phenylalanine, thus having the S configuration at this
stereocenter. Isomer 1 and/or isomer 2 is an essentially pure isomer without assigning
the configuration.

### Example 34

### 2-(5-Benzyl-3,6-dioxo-5-methylpiperazin-2-ylmethyl)benzonitrile

### 34.1 N-(Diphenylmethylene)ethylglycinate

Ethylglycinate hydrochloride (37 g, 0.27 mol) was dissolved in a solution of K₂CO₃ (74.4 g, 0.54 mol) in water (186 ml). The solution was stirred for 15 min and then extracted with dichloromethane (10×150 ml). The organic phases obtained in this manner were combined, dried over MgSO₄ and freed from the solvent under reduced pressure (500 mbar) (yield ˜50%). The residue (9.5 g, 0.092 mol) was dissolved together with benzophenone (14.03 g, 0.077 mol) in xylene (76 ml). After addition of a few drops of BF₃*Et₂O, the reaction mixture was stirred under reflux conditions on a water separator for 5 h. After cooling of the reaction mixture to room temperature, the solvent was removed under reduced pressure. N-(Diphenylmethylene)ethylglycinate was isolated from the residue obtained by distillation (80° C. at 5.5*10⁻² mbar) in a yield of 48%.

### 34.2 N-(Diphenylmethylene)-α-(2-cyanophenyl)ethylalaninate

Aqueous sodium hydroxide solution NaOH (10% strength, 40 ml) was added to a solution of N-(diphenylmethylene)ethylglycinate (5 g, 18.7 mmol), 2-cyanobenzyl bromide (4.1 g, 20.7 mmol) and tetrabutylammonium sulfate (320 mg, 0.9 mmol) in dichloromethane (40 ml), and the mixture was stirred at room temperature overnight. The phases were separated, and the aqueous phase was then extracted with dichloromethane (2*50 ml). The organic phases obtained were combined, washed with water until the wash phase remained neutral, dried over MgSO₄, filtered and freed from the solvent under reduced pressure. N-(Diphenyl-methylene)-α-(2-cyanophenyl)ethylalaninate was isolated from the residue obtained by flash chromatography (SiO₂; cyclohexane/ethyl acetate) in a yield of 83%.

### 34.3 α-(2-Cyanophenyl)ethylalaninate hydrochloride

Aqueous HCl (1M, 95 ml) was added to a solution of N-(diphenylmethylene)-α-(2-cyanophenyl)ethylalaninate (11.4 g, 29.8 mmol) in acetone (95 ml). The mixture was stirred at room temperature for 3 h and then freed from the solvent under reduced pressure. Diethyl ether (2×50 ml) was added to the residue obtained. The supernatant was decanted off. The solid that remained is α-(2-cyanophenyl)-ethylalaninate hydrochloride which can be used without further purification in the subsequent step (yield 87%).

### 34.4 N-(tert-Butoxycarbonyl)-α-methylphenylalanine

Aqueous sodium hydroxide solution (1M, 170 ml) was added to a suspension of α-methylphenylalanine (20 g, 0.11 mol) in dioxane/water (2:1, 300 ml). At a temperature of 0° C., a solution of di-tert-butyl dicarbonate (29.2 g, 0.134 mol) in dioxane (50 ml) was slowly added dropwise to this reaction mixture. After the addition had ended, the reaction mixture was stirred at room temperature overnight. The reaction was monitored by LC-MS analysis. In each case half an equivalent of di-tert-butyl dicarbonate was added until no more starting material could be detected. In each case, the pH was adjusted to 9 using aqueous sodium hydroxide solution NaOH (1M). Using 10% strength aqueous hydrochloric acid, the reaction mixture was then adjusted to a pH of 2 and extracted with ethyl acetate. The organic phases obtained were combined, washed with water, dried over MgSO₄, filtered and freed from the solvent under reduced pressure. The N-(tert-butoxycarbonyl)-α-methylphenylalanine obtained as residue in a yield of 88% can be used without further purification for the next step.

### 34.5 Preparation of (N-Boc-α-CH₃-Phe)-(o-CN-Phe)-OC₂H₅

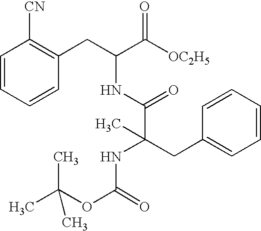

At 0° C. and under an N₂ atmosphere, a solution of N-(tert-butoxycarbonyl)-α-methylphenylalanine (6.3 g, 22.6 mmol) in tetrahydrofuran (THF, 13 ml) was added to a suspension of N,N′-carbonyldiimidazole (CDI, 3.7 g, 27.1 mmol) in THF (34 ml). The reaction mixture was stirred at room temperature for 8 h. α-(2-Cyanophenyl)ethylalaninate hydrochloride (8.6 g, 33.8 mmol) was then added a little at a time, followed by diisopropylethylamine (DIPEA, 8.7 g, 67.6 mmol). The reaction mixture was stirred at 45° C. overnight and then under reflux conditions for 2 h. The reaction mixture was poured into aqueous 5% strength citric acid and then extracted with ethyl acetate. The organic phases obtained were combined, washed with saturated aqueous NaHCO₃ solution, dried over MgSO₄, filtered and freed from the solvent under reduced pressure. (N-Boc-α-CH₃-Phe)-(o-CN-Phe)-OC₂H₅ was obtained from the residue by flash chromatography (SiO₂, cyclohexane/ethyl acetate) in a yield of about 40%.

### 34.6 Preparation of (α-CH₃-Phe)-(o-CN-Phe)-OH

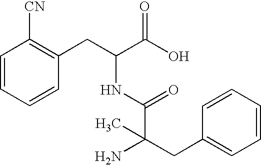

Trifluoroacetic acid (TFA, 8.20 g, 71.9 mmol) was added to a solution of (N-Boc-α-CH₃-Phe)-(o-CN-Phe)-OC₂H₅ (4.1 g, 8.5 mmol) in dichloromethane (14 ml). The reaction mixture was stirred at room temperature for 2 h and then freed from volatile components under reduced pressure. The residue was taken up in chloroform. The reaction mixture was washed with saturated aqueous Na₂CO₃ solution. The organic phase was dried over MgSO₄, filtered and freed from the solvent under reduced pressure. The residue obtained (˜1 g) was, at a temperature of 0° C., taken up in a mixture of tetrahydrofuran/aqueous sodium hydroxide solution (2M) (1:1, 10 ml). The mixture was stirred at this temperature for 2 h. The pH was then adjusted to 7 using hydrochloric acid (10% strength). The mixture was washed with ethyl acetate. The aqueous phase obtained was dried under reduced pressure. The residue consisted of (α-CH₃-Phe)-(o-CN-Phe)-OH and salts originating from the neutralization. Yield: 1.2 g (<40%).

### 34.7 Preparation of 2-(5-benzyl-3,6-dioxo-5-methylpiperazin-2-ylmethyl)benzonitrile

At room temperature and under an N₂ atmosphere, a suspension of (α-CHₛ-Phe)-(o-CN-Phe)-OH (0.92 g, 2.6 mmol) and di(N-succinimidyl)carbonate (0.8 g, 3.1 mmol) in dry acetonitrile (35 ml) was stirred for 12 h. Diisopropylethylamine (DIPEA, 0.47 ml, 2.6 mmol) was then added to the reaction mixture. The reaction mixture was stirred at room temperature for a further 12 h. The solvent was removed under reduced pressure. The residue was taken up in water (2×5 ml) and stirred. The precipitated solid was isolated by filtration. 2-(5-Benzyl-3,6-dioxo-5-methylpiperazin-2-ylmethyl)benzonitrile was isolated from the solid by preparative HPLC chromatography (RP; mobile phase: water/acetonitrile) in an amount of 315 mg (yield 36%).

### Example 35

### 2-(5-Benzyl-1,4,5-trimethyl-3,6-dioxopiperazin-2-ylmethyl)benzonitrile

At 0° C. and under an atmosphere of N₂, NaH (144 mg, 3.6 mmol) was added to a solution of 2-(5-benzyl-3,6-dioxo-5-methylpiperazin-2-ylmethyl)benzonitrile (0.3 g, 0.9 mmol; from example 34) in dry dimethylformamide (DMF), and the mixture was stirred at this temperature for 1 h. Methyl iodide (0.77 g, 5.4 mmol) was then added. The reaction mixture was stirred at room temperature for one hour, and the solvent was then removed under reduced pressure. The residue obtained was separated by preparative HPLC chromatography (RP; mobile phase: water/acetonitrile). 2-(5-Benzyl-1,4,5-trimethyl-3,6-dioxopiperazin-2-ylmethyl)benzonitrile was obtained in an amount of 77 mg as a mixture of two diastereomers. The diastereomers were isolated by preparative thin-layer chromatography (SiO₂, cyclohexane/ethyl acetate 1:3). The first diastereomer was obtained in an amount of 6 mg (R_{f}=0.25). The second diastereomer was obtained in an amount of 24 mg (R_{f}=0.12). This corresponds to a yield of 10%.

### Example 35a

### Alternative preparation of 2-(5-benzyl-1,4,5-trimethyl-3,6-dioxopiperazin-2-ylmethyl)benzonitrile

Under nitrogen, Pd on activated carbon (0.1 g) as a suspension in methanol (2 ml) was added to a solution of 2-(5-benzyl-1,4,5-trimethyl-3,6-dioxopiperazin-2-ylidenemethyl)benzonitrile (0.5 g, 1.4 mmol; from example 20) in methanol (40 ml). The suspension obtained was hydrogenated under an H₂ atmosphere for 7 h. The resulting reaction mixture was filtered through Celite. The filtrate was freed from the solvent under reduced pressure. The crude product obtained in this manner was purified by column chromatography. This gave 2 isomers, which were examined by HPLC-MS.

Main isomer: HPLC-MS: [m/z]=362.1 [M+H]⁺; RT=2.834 min;

minor isomer: HPLC-MS: [m/z]=362.1 [M+H]⁺; RT=2.657 min.

The compounds I.b listed in table C below were prepared in an analogous manner.

TABLE C

| | |
|---|---|
| | (I.b) |
| 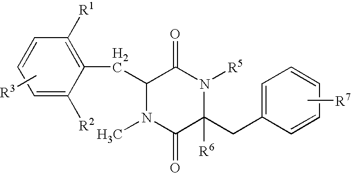 | |

| Ex. | | | | | | | RT HPLC/MS | |
|---|---|---|---|---|---|---|---|---|
| No. | R¹ | R² | R³ | R⁵ | R⁶ | R⁷ | or m.p. | Diastereomer |
| 36 | NO₂ | H | 4-F | CH₃ | H | H | 2.716 min | diast. 1 |
| | | | | | | | m/z = 386.0 | |
| | | | | | | | [M + H]⁺ | |
| 37 | NO₂ | H | 4-F | CH₃ | H | H | 2.808 min | diast. 2 |
| | | | | | | | m/z = 386.0 | |
| | | | | | | | [M + H]⁺ | |
| 38 | NO₂ | H | H | H | H | H | 2.579 min | diast. 1 |
| | | | | | | | m/z = 354.0 | |
| | | | | | | | [M + H]⁺ | |
| 39 | NO₂ | H | H | H | H | H | 2.651 min | diast. 2 |
| | | | | | | | m/z = 354.0 | |
| | | | | | | | [M + H]⁺ | |
| 40 | NO₂ | H | H | CH₃ | H | H | 2.536 min | diast. 1 |
| | | | | | | | m/z = 368.0 | |
| | | | | | | | [M + H]⁺ | |
| 41 | NO₂ | H | H | CH₃ | H | H | 2.640 min | diast. 2 |
| | | | | | | | m/z = 368.0 | |
| | | | | | | | [M + H]⁺ | |
| 42 | NO₂ | H | H | H | H | 2-F | 2.468 min | diast. 1 |
| | | | | | | | m/z = 371.9 | |
| | | | | | | | [M + H]⁺ | |
| 43 | NO₂ | H | H | H | H | 2-F | 2.496 min | diast. 2 |
| | | | | | | | m/z = 371.9 | |
| | | | | | | | [M + H]⁺ | |
| 44 | NO₂ | H | H | CH₃ | H | 2-F | 2.688 min | diast. 1 |
| | | | | | | | m/z = 386.0 | |
| | | | | | | | [M + H]⁺ | |
| 45 | NO₂ | H | H | CH₃ | H | 2-F | 2.694 min | diast. 2 |
| | | | | | | | m/z = 385.9 | |
| | | | | | | | [M + H] | |
| 46 | NO₂ | H | H | H | H | 3-F | 2.509 min | diast. 1 |
| | | | | | | | m/z = 371.9 | |
| | | | | | | | [M + H]⁺ | |
| 47 | NO₂ | H | H | H | H | 3-F | 2.561 min | diast. 2 |
| | | | | | | | m/z = 371.9 | |
| | | | | | | | [M + H]⁺ | |
| 48 | NO₂ | H | H | CH₃ | H | 3-F | 2.729 min | diast. 1 |
| | | | | | | | m/z = 385.9 | |
| | | | | | | | [M + H]⁺ | |
| 49 | NO₂ | H | H | CH₃ | H | 3-F | 2.630 min | diast. 2 |
| | | | | | | | m/z = 385.9 | |
| | | | | | | | [M + H]⁺ | |
| 50 | NO₂ | F | H | CH₃ | H | H | 2.624 min | diast. 1 |
| | | | | | | | m/z = 386.1 | |
| | | | | | | | [M + H⁺ | |
| 51 | NO₂ | F | H | CH₃ | H | H | 2.733 min | diast. 2 |
| | | | | | | | m/z = 386.1 | |
| | | | | | | | [M + H]⁺ | |
| 52 | CN | H | H | CH₃ | H | H | m/z = 348.1 | diast. 1 |
| | | | | | | | [M + H]⁺ | |
| 53 | CN | H | H | CH₃ | H | H | m/z = 348.1 | diast.2 |
| | | | | | | | [M + H]⁺ | |
| 54 | NO₂ | H | H | H | H | 2-Br | m/z = 433.8 | diast. 1 |
| | | | | | | | [M + H]⁺ | |
| 55 | NO₂ | H | H | H | H | 2-Br | m/z = 433.8 | diast.2 |
| | | | | | | | [M + H]⁺ | |
| 56 | NO₂ | H | H | H | H | 3-Br | m/z = 433.8 | diast. 1 |
| | | | | | | | [M + H]⁺ | |
| 57 | NO₂ | H | H | H | H | 3-Br | m/z = 433.8 | diast. 2 |
| | | | | | | | [M + H]⁺ | |
| 58 | NO₂ | H | H | CH₃ | H | 2-Br | 2.979 min | diast. 1 |
| | | | | | | | m/z = 448.1 | |
| | | | | | | | [M + H]⁺ | |
| 59 | NO₂ | H | H | CH₃ | H | 2-Br | 2.984 min | diast. 2 |
| | | | | | | | m/z = 448.1 | |
| | | | | | | | [M + H]⁺ | |
| 60 | NO₂ | H | H | CH₃ | H | 3-Br | 2.989 min | diast. 1 |
| | | | | | | | m/z = 448.1 | |
| | | | | | | | [M + H]⁺ | |
| 61 | NO₂ | H | H | CH₃ | H | 3-Br | 3.055 min | diast. 2 |
| | | | | | | | m/z = 448.1 | |
| | | | | | | | [M + H]⁺ | |
| 62 | NO₂ | H | H | H | H | 2-Cl | 2.707 min | diast. 1 |
| | | | | | | | m/z = 388.1 | |
| | | | | | | | [M + H]⁺ | |
| 63 | NO₂ | H | H | H | H | 2-Cl | 2.758 min | diast. 2 |
| | | | | | | | m/z = 388.1 | |
| | | | | | | | [M + H]⁺ | |
| 64 | NO₂ | H | H | H | H | 4-Cl | 2.812 min | diast. 1 |
| | | | | | | | m/z = 388.1 | |
| | | | | | | | [M + H]⁺ | |
| 65 | NO₂ | H | H | H | H | 4-Cl | 2.823 min | diast. 2 |
| | | | | | | | m/z = 388.1 | |
| | | | | | | | [M + H]⁺ | |
| 66 | NO₂ | H | H | H | H | 2-I | 2.720 min | diast. 1 |
| | | | | | | | m/z = 368.2 | |
| | | | | | | | [M + H]⁺ | |
| 67 | NO₂ | H | H | H | H | 2-I | 2.736 min | diast. 2 |
| | | | | | | | m/z = 368.2 | |
| | | | | | | | [M + H]⁺ | |
| 68 | NO₂ | H | H | H | H | 4-I | 2.951 min | diast. 1 |
| | | | | | | | m/z = 479.8 | |
| | | | | | | | [M + H]⁺ | |
| 69 | NO₂ | H | H | H | H | 4-I | 2.929 min | diast. 2 |
| | | | | | | | m/z = 479.8 | |
| | | | | | | | [M + H]⁺ | |
| 70 | NO₂ | H | H | H | H | 4-F | 2.553 min | diast. 1 |
| | | | | | | | m/z = 372.0 | |
| | | | | | | | [M + H]⁺ | |
| 71 | NO₂ | H | H | H | H | 4-F | 2.585 min | diast. 2 |
| | | | | | | | m/z = 372.0 | |
| | | | | | | | [M + H]⁺ | |
| 72 | NO₂ | H | H | CH₃ | H | H | 2.652 min | diast. 1 |
| | | | | | | | m/z = 368.0 | |
| | | | | | | | [M + H]⁺ | |
| 73 | NO₂ | H | H | CH₃ | H | H | 2.696 min | diast. 2 |
| | | | | | | | m/z = 368.0 | |
| | | | | | | | [M + H]⁺ | |

| | |
|---|---|
| Ex. No. | example number |
| RT | retention time |
| m.p. | melting point |
| n.d. | not determined |

### PART B: USE EXAMPLES

The herbicidal action of the compositions according to the invention was demonstrated by greenhouse experiments:

The culture containers used were plastic pots containing loamy sand with approximately 3.0% of humus as substrate. The seeds of the test plants were sown separately for each species.

For the pre-emergence treatment, the active compounds, suspended or emulsified in water, were applied directly after sowing by means of finely distributing nozzles. The containers were irrigated gently to promote germination and growth and subsequently covered with transparent plastic hoods until the plants had rooted. This cover caused uniform germination of the test plants unless this was adversely affected by the active compounds.

For the post-emergence treatment, the test plants were grown to a plant height of from 3 to 15 cm, depending on the plant habit, and only then treated with the active compounds which had been suspended or emulsified in water. To this end, the test plants were either sown directly and grown in the same containers, or they were first grown separately as seedlings and transplanted into the test containers a few days prior to treatment.

Depending on the species, the plants were kept at 10-25° C. and 20-35° C., respectively. The test period extended over 2 to 4 weeks. During this time, the plants were tended and their response to the individual treatments was evaluated.

Evaluation was carried out using a scale from 0 to 100. 100 means no emergence of the plants, or complete destruction of at least the above-ground parts, and 0 means no damage or normal course of growth. Good herbicidal activity is given at values of at least 70, and very good herbicidal activity is given at values of at least 85.

The respective stated components A and B, and if appropriate, C were formulated as a 5% by weight or 10% by weight strength emulsion concentrate or a commercially available formulation of component B was used and, with addition of the amount of solvent system, introduced into the spray liquor used for applying the active compound. In the examples, the solvent used was water.

The test period extended over 20 or 21 days. During this time, the plants were tended, and their reactions to the treatment with active compound was monitored.

What was evaluated was the damage by the chemical compositions using a scale of from 0 to 100%, in comparison to the untreated control plants. 0 means no damage, and 100 means complete destruction of the plants.

In the examples below, using the method of S. R. Colby (1967) “Calculating synergistic and antagonistic responses of herbicide combinations”, Weeds 15, p. 22 ff., the value E, which is expected if the activity of the individual active compounds is only additive, was calculated.

E=X+Y−(X·Y/100)

where
X=percent activity using active compound A at an application rate a;
Y=percent activity using active compound B at an application rate b;
E=expected activity (in %) by A+B at application rates a+b.

If the value found in experiments is higher than the value E calculated according to Colby, a synergistic effect is present.

The plants used in the greenhouse experiments were of the following species:

| Bayer code | Scientific name | Common name |
|---|---|---|
| ALOMY | Alopecurus myosuroides | black grass |
| AVEFA | Avena fatua | wild-oat |
| APESV | Apera spica-venti | silky bent grass |
| BRAPL | Brachiaria plantaginea | alexandergrass |
| CCHEC | Cenchrus echinatus | bur grass |
| DIGSA | Digitaria sanguinalis | large crapgrass |
| ECHCG | Echinochloa crus-galli | barnyardgrass |
| LAMPU | Lamium purpureum | deadnettle |
| LOLMU | Lolium multiflorum | Italian ryegrass |
| MATIN | Matricaria inodora | scentless |
| | | chamomile |
| PANDI | Panicum | smooth witchgrass |
| | dichotomiflorum | |
| PHACA | Phalaris canariensis | canarygrass |
| POAAN | Poa annua | annual meadow- |
| | | grass |
| SETLU | Setaria glauca | yellow foxtail |
| SETFA | Setaria faberi | giant foxtail |
| SETVI | Setaria viridis | green foxtail |
| SOLNI | Solanum nigrum L. | Black nightshade |
| STEME | Stellaria media | common |
| | | chickweed |

The results of these tests are shown in the tables of use examples 1 to 23 below and confirm the synergistic action of mixtures comprising at least one piperazine dione compound of the formula I and at least one herbicide B.

Here, a.s.=active substance, based on 100% active compound. In use examples 1 to 18, the E values calculated according to Colby are stated in ( ).

### Use Example 1

### Synergistic Herbicidal Action of the Compound from Example 20 with Triallate from Group b1) by the Pre-Emergence Method

| | |
|---|---|
| Application | Herbicidal action in % |
| rate | after 20 days against |

| Compound | a.s. in g/ha | LOLMU | PHACA |
|---|---|---|---|
| Example 20 | 500 | 70 | 80 |
| Triallate | 600 | 80 | 50 |
| | 300 | 60 | 40 |
| Example 20 + | 500 + 600 | 95 (94) | 98 (90) |
| Triallate | 500 + 300 | 90 (88) | 98 (88) |

### Use Example 2

### Synergistic Herbicidal Action of the Compound from Example 20 with Prosulfocarb from Group b1) by the Pre-Emergence Method

| | Application | Herbicidal action in % after | | | |
|---|---|---|---|---|---|
| | rate | 20 days against | | | |
| Compound | a.s. in g/ha | ECHCG | MATIN | STEME | ALOMY |
| Example 20 | 250 | 100 | 90 | 50 | 85 |
| | 125 | 95 | 30 | 20 | 55 |
| | 62.5 | 70 | 0 | 0 | 45 |
| Prosulfocarb | 1000 | 40 | 30 | 80 | 70 |
| Example 20 + | 250 + 1000 | — | — | 100 | 98 |
| Prosulfocarb | | | | (90) | (96) |
| | 125 + 1000 | 100 | 65 | 90 | 100 |
| | | (97) | (51) | (84) | (87) |
| | 62.5 + 1000 | — | 55 | 85 | 95 |
| | | | (30) | (80) | (84) |

### Use Example 3

### Synergistic Herbicidal Action of the Compound from Example 20 with Imazethapyr from Group b2) by the Pre-Emergence Method

| | |
|---|---|
| Application | Herbicidal action in % |
| rate | after 21 days against |

| Compound | a.s. in g/ha | PANDI | CCHEC |
|---|---|---|---|
| Example 20 | 62.5 | 95 | 20 |
| Imazethapyr | 35 | 95 | 60 |
| | 17.5 | 95 | 50 |
| Example 20 + | 62.5 + 35 | 100 (100) | 70 (68) |
| Imazethapyr | 62.5 + 17.5 | 100 (100) | 70 (60) |

### Use Example 4

### Synergistic Herbicidal Action of the Compound from Example 20 with Isoproturon from Group b3) by the Pre-Emergence Method

| | |
|---|---|
| Application | Herbicidal action in % |
| rate | after 20 days against |

| Compound | a.s. in g/ha | ALOMY | PHACA |
|---|---|---|---|
| Example 20 | 250 | 85 | 80 |
| Isoproturon | 750 | 98 | 75 |
| | 375 | 90 | 55 |
| Example 20 + | 250 + 750 | 100 (100) | 98 (95) |
| Isoproturon | | | |

### Use Example 5

### Synergistic Herbicidal Action of the Compound from Example 20 with Terbuthylazine from Group b3) by the Pre-Emergence Method

| | |
|---|---|
| Application | Herbicidal action in % |
| rate | after 20 days against |

| Compound | a.s. in g/ha | BRAPL | DIGSA |
|---|---|---|---|
| Example 20 | 250 | 85 | 100 |
| | 125 | 70 | 90 |
| Terbuthylazine | 250 | 15 | 35 |
| Example 20 + | 250 + 250 | 95 (87) | — |
| Terbuthylazine | 125 + 250 | — | 100 (94) |

### Use Example 6

### Synergistic Herbicidal Action of the Compound from Example 20 with 2-chloro-5-[3,6-dihydro-3-methyl-2,6-dioxo-4-(trifluoromethyl)-1(2H)-pyrimidinyl]-4-fluoro-N-[(isopropyl)methylsulfamoyl]benzamide (CAS 372137-35-4) from Group b4) by the Pre-Emergence Method

| | Application | Herbicidal action in % | |
|---|---|---|---|
| | rate | after 20 days against | |
| Compound | a.s. in g/ha | AVEFA | POAAN |
| Example 20 | 500 | 40 | 95 |
| | 250 | 20 | 85 |
| 2-Chloro-5-[3,6-dihydro-3-methyl- | 6.25 | 0 | 0 |
| 2,6-dioxo-4-(trifluoromethyl)- | | | |
| 1(2H)-pyrimidinyl]-4-fluoro-N- | | | |
| [(isopropyl)methylsulfamoyl]- | | | |
| benzamide (CAS 372137-35-4) | | | |
| Example 20 + | 500 + 6.25 | 65 (40) | 100 (95) |
| 2-Chloro-5-[3,6-dihydro-3-methyl- | 250 + 6.25 | 60 (20) | 98 (85) |
| 2,6-dioxo-4-(trifluoromethyl)- | | | |
| 1(2H)-pyrimidinyl]-4-fluoro-N- | | | |
| [(isopropyl)methylsulfamoyl]- | | | |
| benzamide (CAS 372137-35-4) | | | |

### Use Example 7

### Synergistic Herbicidal Action of the Compound from Example 20 with Picolinafen from Group b5) by the Pre-Emergence Method

| | |
|---|---|
| Application | Herbicidal action in % |
| rate | after 20 days against |

| Compound | a.s. in g/ha | ALOMY | POAAN |
|---|---|---|---|
| Example 20 | 250 | 90 | 85 |
| | 125 | 40 | 60 |
| Picolinafen | 25 | 0 | 0 |
| Example 20 + | 250 + 25 | — | 95 |
| Picolinafen | | | (85) |
| | 125 + 25 | 65 (40) | 70 (60) |

### Use Example 8

### Synergistic Herbicidal Action of the Compound from Example 20 with Clomazone from Group b5) by the Pre-Emergence Method

| | Application | |
|---|---|---|
| | rate | Herbicidal action in % |
| Compound | a.s. in g/ha | after 21 days against BRAPL |
| Example 20 | 31.25 | 20 |
| Clomazon | 100 | 85 |
| | 50 | 65 |
| Example 20 + | 31.25 + 100 | 95 (88) |
| Clomazon | 31.25 + 50 | 80 (72) |

### Use Example 9

### Synergistic Herbicidal Action of the Compound from Example 20 with Isoxaflutol from Group b5) by the Pre-Emergence Method

| | Application | Herbicidal action in % | | |
|---|---|---|---|---|
| | rate | after 21 days against | | |
| Compound | a.s. in g/ha | BRAPL | DIGSA | SETLU |
| Example 20 | 250 | 95 | 100 | 100 |
| | 125 | 80 | 90 | 90 |
| Isoxaflutol | 25 | 90 | 98 | 75 |
| Example 20 + | 250 + 25 | 100 | — | — |
| Isoxaflutol | | (100) | | |
| | 125 + 25 | — | 100 (100) | 100 (98) |

### Use Example 10

### Synergistic Herbicidal Action of the Compound from Example 20 with Pendimethalin from Group b9) by the Pre-Emergence Method

| | |
|---|---|
| Application | Herbicidal action in % |
| rate | after 20 days against |

| Compound | a.s. in g/ha | ALOMY | LOLMU |
|---|---|---|---|
| Example 20 | 250 | 70 | 45 |
| | 125 | 45 | 0 |
| Pendimethalin | 250 | 30 | 0 |
| Example 20 + | 250 + 250 | 85 (79) | — |
| Pendimethalin | 125 + 250 | 65 (62) | 15 (0) |

### Use Example 11

### Synergistic Herbicidal Action of the Compound from Example 20 with Pyroxasulfone from Group b10) by the Pre-Emergence Method

| | Application | Herbicidal action in % | | |
|---|---|---|---|---|
| | rate | after 21 days against | | |
| Compound | a.s. in g/ha | SETVI | LOLMU | LAMPU |
| Example 20 | 125 | 80 | 0 | 75 |
| Pyroxasulfone | 25 | 100 | 90 | 55 |
| Example 20 + | 125 + 25 | 100 (100) | 100 (90) | 95 (89) |
| Pyroxasulfone | | | | |

### Use Example 12

### Synergistic Herbicidal Action of the Compound from Example 20 with Pyroxasulfone from Group b10) by the Pre-Emergence Method

| | |
|---|---|
| Application | Herbicidal action in % |
| rate | after 20 days against |

| Compound | a.s. in g/ha | BRAPL | SETFA |
|---|---|---|---|
| Example 20 | 250 | 55 | 80 |
| | 125 | 55 | 45 |
| Pyroxasulfone | 25 | 75 | 98 |
| | 12.5 | 40 | 75 |
| Example 20 + | 250 + 12.5 | 100 (73) | 100 (95) |
| Pyroxasulfone | 125 + 25 | 100 (89) | 100 (99) |

### Use Example 13

### Synergistic Herbicidal Action of the Compound from Example 20 with Flufenacet from Group b10) by the Pre-Emergence Method

| | |
|---|---|
| Application | Herbicidal action in % |
| rate | after 20 days against |

| Compound | a.s. in g/ha | ALOMY | LOLMU |
|---|---|---|---|
| Example 20 | 250 | 70 | 45 |
| | 125 | 45 | 0 |
| Flufenacet | 125 | 90 | 70 |
| | 62.5 | 75 | 40 |
| Example 20 + | 125 + 125 | 100 (95) | 100 (70) |
| Flufenacet | 250 + 62.5 | 100 (93) | 100 (67) |
| | 125 + 62.5 | 90 (86) | 100 (40) |

### Use Example 14

### Synergistic Herbicidal Action of the Compound from Example 20 with Dimethenamide-P from Group b10) by the Pre-Emergence Method

| | Application | Herbicidal action in % | | |
|---|---|---|---|---|
| | rate | after 20 days against | | |
| Compound | a.s. in g/ha | DIGSA | SETFA | SETLU |
| Example 20 | 125 | 90 | 95 | 90 |
| Dimethenamide-P | 31.25 | 90 | 95 | 65 |
| Example 20 + | 125 + 31.25 | 100 (99) | 100 (100) | 100 (97) |
| Dimethenamide-P | | | | |

### Use Example 15

### Synergistic Herbicidal Action of the Compound from Example 20 with Isoxaben from Group b11) by the Pre-Emergence Method

| | |
|---|---|
| Application | Herbicidal action in % |
| rate | after 20 days against |

| Compound | a.s. in g/ha | ALOMY | POAAN |
|---|---|---|---|
| Example 20 | 250 | 90 | 85 |
| | 125 | 40 | 60 |
| Isoxaben | 50 | 0 | 0 |
| | 25 | 0 | 0 |
| Example 20 + | 125 + 50 | — | 75 (60) |
| Isoxaben | 250 + 25 | 95 (90) | — |
| | 125 + 25 | 65 (40) | 80 (60) |

### Use Example 16

### Synergistic Herbicidal Action of the Compound from Example 20 with Quinclorac from Group b13) by the Pre-Emergence Method

| | Application | Herbicidal action in % | | |
|---|---|---|---|---|
| | rate | after 20 days against | | |
| Compound | a.s. in g/ha | BRAPL | SETLU | CCHEC |
| Example 20 | 250 | 85 | 98 | 90 |
| Quinclorac | 125 | 25 | 85 | 20 |
| | 62.5 | 0 | 50 | 0 |
| Example 20 + | 250 + 125 | 90 (89) | — | 95 (92) |
| Quinclorac | 250 + 62.5 | — | 100 (99) | — |

### Use Example 17

### Synergistic Herbicidal Action of the Compound from Example 20 with Pendimethalin from Group b9) by the Post-Emergence Method

| | Application | Herbicidal action in % | | |
|---|---|---|---|---|
| | rate | after 20 days against | | |
| Compound | a.s. in g/ha | ALOMY | LOLMU | SETVI |
| Example 20 | 250 | 70 | 35 | 80 |
| | 125 | 40 | 15 | 70 |
| Pendimethalin | 1000 | 75 | 75 | 95 |
| | 500 | 65 | 70 | 90 |
| Example 20 + | 250 + 1000 | 100 (93) | — | 100 (99) |
| Pendimethalin | 125 + 1000 | — | 80 (79) | 100 (99) |
| | 250 + 500 | 100 (90) | — | 100 (98) |

### Use Example 18

### Synergistic Herbicidal Action of the Compound from Example 20 with Flufenacet from Group b10) by the Post-Emergence Method

| | Application | Herbicidal action in % | |
|---|---|---|---|
| | rate | after 20 days | |
| Compound | a.s. in g/ha | against DIGSA | against SETVI |
| Example 20 | 125 | 70 | 70 |
| | 62.5 | 45 | 60 |
| Flufenacet | 125 | 75 | 70 |
| Example 20 + | 125 + 125 | 100 (93) | 100 (91) |
| Flufenacet | 62.5 + 125 | 100 (86) | 100 (88) |

In use examples 19 to 23, the piperazine dione compound of the formula I used was the compound I-1, i.e. 2-[5-benzyl-1,4-dimethyl-3,6-dioxopiperazin-2-ylidenemethyl]benzonitrile in the form of the Z isomer as a racemic mixture. Hereinbelow, 2-[5-benzyl-1,4-dimethyl-3,6-dioxopiperazin-2-ylidenemethyl]benzonitrile in the form of the Z isomer is also referred to as compound I-1 (Z).

### Use Example 19

### Synergistic Herbicidal Action of the Compound I-1 (Z) as Racemate with Isoxaflutole from Group b5) by the Pre-Emergence Method

| | Application | Herbicidal action in % after | | | |
|---|---|---|---|---|---|
| | rate a.s. in | 20 days against | | | |
| Compound | g/ha | BRAPL | DIGSA | SETFA | SOLNI |
| Compound I-1 (Z) | 250 | 75 | 65 | 85 | 65 |
| (Racemate) | | | | | |
| Isoxaflutole | 25 | 80 | 95 | 55 | 98 |
| | 13 | 75 | 75 | 40 | 85 |
| Compound I-1 (Z) | 250 + 25 | 100 | 100 | 95 | 100 |
| (Racemate) + | | (95) | (98) | (93) | (99) |
| Isoxaflutole | 250 + 13 | — | — | 95 | 100 |
| | | | | (91) | (95) |

### Use Example 20

### Synergistic Herbicidal Action of the Compound I-1 (Z) as Racemate with Picolinafen from Group b5) by the Pre-Emergence Method

| | Application | Herbicidal action in % | | |
|---|---|---|---|---|
| | rate | after 20 days against | | |
| Compound | a.s. in g/ha | APESV | PHACA | LAMPU |
| Compound I-1 (Z) | 250 | 95 | 90 | 80 |
| (Racemate) | 125 | 90 | 65 | 30 |
| Picolinafen | 25 | 60 | 0 | 0 |
| Compound I-1 (Z) | 250 + 25 | 100 (98) | 95 (90) | 85 (80) |
| (Racemate) + | 125 + 25 | — | 70 (65) | 40 (30) |
| Picolinafen | | | | |

### Use Example 21

### Synergistic Herbicidal Action of the Compound I-1 (Z) as Racemate with Flufenacet from Group b10) by the Pre-Emergence Method

| | Appli- | | | | |
|---|---|---|---|---|---|
| | cation | Herbicidal action | | | |
| | rate a.s. | in % after 20 days against | | | |
| Compound | in g/ha | ALOMY | APESV | LOLMU | LAMPU |
| Compound | 125 | 75 | 90 | 50 | 30 |
| I-1 (Z) | 63 | 30 | 80 | 30 | 0 |
| (Racemate) | | | | | |
| Flufenacet | 32 | 70 | 95 | 65 | 20 |
| Compound | 125 + 32 | — | 100 | 85 | 65 |
| I-1 (Z) | | | (100) | (83) | (44) |
| (Racemate) + | 63 + 32 | 85 | 100 | 80 | 65 |
| Flufenacet | | (79) | (99) | (76) | (20) |

### Use Example 22

### Synergistic Herbicidal Action of the Compound I-1 (Z) as Racemate with Pyroxasulfone from Group b10) by the Pre-Emergence Method

| | Application | Herbicidal action in % after | | | |
|---|---|---|---|---|---|
| | rate a.s. in | 20 days against | | | |
| Compound | g/ha | DIGSA | ECHCG | SETFA | SOLNI |
| Compound I-1 (Z) | 250 | 65 | 70 | 85 | 65 |
| (Racemate) | 125 | 40 | 20 | 75 | 40 |
| Pyroxasulfone | 13 | 95 | 85 | 98 | 85 |
| | 6.25 | 70 | 55 | 75 | 40 |
| Compound I-1 (Z) | 250 + 13 | 100 | 98 | 100 | 98 |
| (Racemate) + | | (98) | (96) | (100) | (95) |
| Pyroxasulfone | 250 + 6.25 | — | — | — | 98 |
| | | | | | (79) |
| | 125 + 6.25 | — | 70 | 95 | — |
| | | | (64) | (94) | |

### Use Example 23

### Synergistic Herbicidal Action of the Compound I-1 (Z) as Racemate with Dimethenamide-P from Group b10) by the Pre-Emergence Method

| | Application | Herbicidal action in % after | | | |
|---|---|---|---|---|---|
| | rate a.s. in | 20 days against | | | |
| Compound | g/ha | BRAPL | DIGSA | ECHCG | SOLNI |
| Compound I-1 (Z) | 250 | 75 | 65 | 70 | 65 |
| (Racemate) | 125 | 40 | 40 | 20 | 40 |
| Dimethenamide-P | 31.25 | 50 | 85 | 85 | 80 |
| | 16 | 40 | 70 | 50 | 60 |
| Compound I-1 (Z) | 250 + 31.25 | 95 | 100 | — | 98 |
| (Racemate) + | | (88) | (95) | | (93) |
| Dimethenamide-P | 125 + 31.5 | 75 | 100 | 90 | — |
| | | (70) | (91) | (88) | |
| | 125 + 16 | 65 | — | 65 | 85 |
| | | (64) | | (60) | (76) |

1. A herbicidally active composition, comprising
A) at least one piperazinedione compound of the formula I 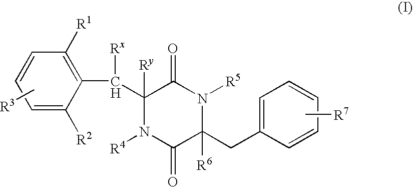
in which:
R^{x}, R^{y} are each hydrogen or together are a chemical bond;
R¹ is cyano or nitro;
R² is hydrogen, fluorine, chlorine, C₁-C₂-alkyl, ethenyl or C₁-C₂-alkoxy;
R³ is fluorine or hydrogen;
R⁴ is methyl;
R⁵ is hydrogen, methyl or ethyl;
R⁶ is hydrogen, methyl or ethyl; and
R⁷ is hydrogen or halogen;
and at least one further active compound selected from
B) herbicides of class b1) to b15):
b1) lipid biosynthesis inhibitors;
b2) acetolactate synthase inhibitors (ALS inhibitors);
b3) photosynthesis inhibitors;
b4) protoporphyrinogen-IX oxidase inhibitors,
b5) bleacher herbicides;
b6) enolpyruvyl shikimate 3-phosphate synthase inhibitors (EPSP inhibitors);
b7) glutamine synthetase inhibitors;
b8) 7,8-dihydropteroate synthase inhibitors (DI-IP inhibitors);
b9) mitose inhibitors;
b10) inhibitors of the synthesis of very long chain fatty acids (VLCFA inhibitors);
b11) cellulose biosynthesis inhibitors;
b12) decoupler herbicides;
b13) auxin herbicides;
b14) auxin transport inhibitors; and
b15) other herbicides selected from the group consisting of bromobutide, chlorflurenol, chlorflurenol-methyl, cinmethylin, cumyluron, dalapon, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-M-methyl, flurenol, flurenol-butyl, flurprimidol, fosamine, fosamine-ammonium, indanofan, maleic hydrazide, mefluidide, metam, methyl azide, methyl bromide, methyl-dymron, methyl iodide, MSMA, oleic acid, oxaziclomefone, pelargonic acid, pyributicarb, quinoclamine, triaziflam, tridiphane and 6-chloro-3-(2-cyclopropyl-6-methylphenoxy)-4-pyridazinol (CAS 499223-49-3) and its salts and esters;
and
C) safeners, and also
the agriculturally acceptable salts of the active compounds B and C and the agriculturally acceptable derivatives of the active compounds B and C, provided they have a carboxyl group.

2. The composition according to claim 1, where R^{x} and R^{y} in formula I together are a covalent bond.

3. The composition according to claim 2, comprising the compound of the formula I in the form of the (Z) isomer or in the form of a mixture of Z and E isomers which comprises predominantly the Z isomer.

4. The composition according to any of the preceding claims where R⁵ is methyl.

5. The composition according to any of the preceding claims where R⁶ is methyl.

6. The composition according to any of the preceding claims, comprising as piperazinedione compound a compound of the formula I.aa 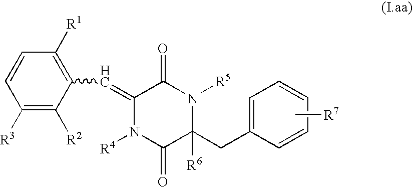
in which R¹, R², R³, R⁴, R⁵, R⁶ and R⁷ have the meanings mentioned above and R⁷ is located in the meta- or para-position to the point of attachment of the phenyl ring.

7. The composition according to claim 6, comprising the piperazinedione compound of the formula I.aa in the form of the enantiomer I.aa-S 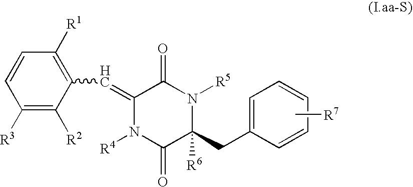
in which R¹, R², R³, R⁴, R⁵, R⁶ and R⁷ have the meanings mentioned above, and
R⁷ is located in the meta- or para-position to the point of attachment of the phenyl ring, or in the form of a mixture of the enantiomers which contains predominantly the S enantiomer.

8. The composition according to any of the preceding claims, comprising as piperazinedione compound a compound of the formula I.bb 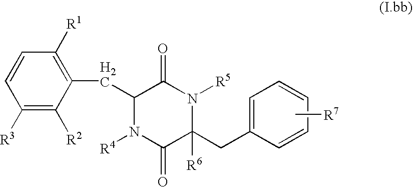
in which R¹, R², R³, R⁴, R⁵, R⁶ and R⁷ have the meanings mentioned above and R⁷ is located in the meta- or para-position to the point of attachment of the phenyl ring.

9. The composition according to claim 8 in which the benzylic groups of the 3- and the 6-position of the piperazine ring have a cis arrangement.

10. The composition according to claim 8, comprising the compound I.bb in the form of the (S,S) enantiomer, where the carbon atoms in the 3- and the 6-position of the piperazine ring have in each case the S configuration, or in the form of a mixture of enantiomers or a mixture of diastereomers having an enantiomeric excess and a diastereomeric excess, respectively, of the (S,S) enantiomer.

11. The composition according to claim 1, where the piperazinedione compound of the formula I is selected from the group consisting of:
2-[5-benzyl-1,4-dimethyl-3,6-dioxopiperazin-2-ylidenemethyl]benzonitrile,
2-[5-benzyl-1,4-dimethyl-3,6-dioxopiperazin-2-ylidenemethyl]-3-fluorobenzonitrile,
2-[5-benzyl-1,4-dimethyl-3,6-dioxopiperazin-2-ylidenemethyl]-3,4-difluorobenzonitrile,
2-[5-benzyl-1,4-dimethyl-3,6-dioxopiperazin-2-ylidenemethyl]-3-methoxybenzonitrile,
2-[5-benzyl-1,4-dimethyl-3,6-dioxopiperazin-2-ylidenemethyl]-3-ethenylbenzonitrile,
2-[5-(4-fluorobenzyl)I-1,4-dimethyl-3,6-dioxopiperazin-2-ylidenemethyl]benzo-nitrile,
2-[5-(4-fluorobenzyl)-1,4-dimethyl-3,6-dioxopiperazin-2-ylidenemethyl]-3-fluorobenzonitrile,
2-[5-(4-fluorobenzyl)-1,4-dimethyl-3,6-dioxopiperazin-2-ylidenemethyl]-3,4-difluorobenzonitrile,
2-[5-(4-fluorobenzyl)-1,4-dimethyl-3,6-dioxopiperazin-2-ylidenemethyl]-3-methoxybenzonitrile,
2-[5-(4-fluorobenzyl)-1,4-dimethyl-3,6-dioxopiperazin-2-ylidenemethyl]-3-ethenylbenzonitrile,
3-benzyl-6-[1-(2-nitrophenyl)methylidene]-1,4-dimethylpiperazine-2,5-dione,
3-benzyl-6-[1-(2-fluoro-6-nitrophenyl)methylidene]-1,4-dimethylpiperazine-2,5-dione,
3-benzyl-6-[1-(2-ethenyl-6-nitrophenyl)methylidene]-1,4-dimethylpiperazine-2,5-dione,
3-benzyl-6-[1-(2-methoxy-6-nitrophenyl)methylidene]-1,4-dimethylpiperazine-2,5-dione,
3-benzyl-6-[1-(2,3-difluoro-6-nitrophenyl)methylidene]-1,4-dimethylpiperazine-2,5-dione,
3-(4-fluorobenzyl)-6-[1-(2-nitrophenyl)methylidene]-1,4-dimethylpiperazine-2,5-dione,
3-(4-fluorobenzyl)-6-[1-(2-fluoro-6-nitrophenyl)methylidene]-1,4-dimethyl-piperazine-2,5-dione,
3-(4-fluorobenzyl)-6-[1-(2-methyl-6-nitrophenyl)methylidene]-1,4-dimethyl-piperazine-2,5-dione,
3-(4-fluorobenzyl)-6-[1-(2-methoxy-6-nitrophenyl)methylidene]-1,4-dimethyl-piperazine-2,5-dione,
3-(4-fluorobenzyl)-6-[1-(2,3-difluoro-6-nitrophenyl)methylidene]-1,4-dimethylpiperazine-2,5-dione,
2-[5-benzyl-1,4,5-trimethyl-3,6-dioxopiperazin-2-ylidenemethyl]benzonitrile,
2-[5-benzyl-1,4,5-trimethyl-3,6-dioxopiperazin-2-ylidenemethyl]-3-fluorobenzonitrile,
2-[5-benzyl-1,4,5-trimethyl-3,6-dioxopiperazin-2-ylidenemethyl]-3-methoxybenzonitrile,
2-[5-benzyl-1,4,5-trimethyl-3,6-dioxopiperazin-2-ylidenemethyl]-3,4-difluorobenzonitrile,
2-[5-benzyl-1,4,5-trimethyl-3,6-dioxopiperazin-2-ylidenemethyl]-3-methylbenzonitrile,
2-[5-benzyl-1,5-dimethyl-3,6-dioxopiperazin-2-ylidenemethyl]benzonitrile,
2-[5-benzyl-1,5-dimethyl-3,6-dioxopiperazin-2-ylidenemethyl]-3-fluorobenzonitrile,
2-[5-benzyl-1,5-dimethyl-3,6-dioxopiperazin-2-ylidenemethyl]-3-methoxybenzonitrile,
2-[5-benzyl-1,5-dimethyl-3,6-dioxopiperazin-2-ylidenemethyl]-3,4-difluorobenzonitrile,
2-[5-benzyl-1,5-dimethyl-3,6-dioxopiperazin-2-ylidenemethyl]-3-methylbenzonitrile,
2-[5-benzyl-5-ethyl-1,4-dimethyl-3,6-dioxopiperazin-2-ylidenemethyl]benzonitrile,
2-[5-benzyl-5-ethyl-1,4-dimethyl-3,6-dioxopiperazin-2-ylidenemethyl]-3-fluorobenzonitrile,
2-[5-benzyl-5-ethyl-1,4-dimethyl-3,6-dioxopiperazin-2-ylidenemethyl]-3-methoxybenzonitrile,
2-[5-benzyl-5-ethyl-1,4-dimethyl-3,6-dioxopiperazin-2-ylidenemethyl]-3,4-difluorobenzonitrile,
2-[5-benzyl-5-ethyl-1,4-dimethyl-3,6-dioxopiperazin-2-ylidenemethyl]-3-methylbenzonitrile,
2-[5-benzyl-5-ethyl-1-methyl-3,6-dioxopiperazin-2-ylidenemethyl]benzonitrile,
2-[5-benzyl-5-ethyl-1-methyl-3,6-dioxopiperazin-2-ylidenemethyl]-3-fluorobenzonitrile,
2-[5-benzyl-5-ethyl-1-methyl-3,6-dioxopiperazin-2-ylidenemethyl]-3-methoxybenzonitrile,
2-[5-benzyl-5-ethyl-1-methyl-3,6-dioxopiperazin-2-ylidenemethyl]-3,4-difluorobenzonitrile,
2-[5-benzyl-5-ethyl-1-methyl-3,6-dioxopiperazin-2-ylidenemethyl]-3-methylbenzonitrile,
3-benzyl-6-[1-(2-nitrophenyl)methylidene]-1,3,4-trimethylpiperazine-2,5-dione,
3-benzyl-6-[1-(2-fluoro-6-nitrophenyl)methylidene]-1,3,4-trimethylpiperazine-2,5-dione,
3-benzyl-6-[1-(2,3-difluoro-6-nitrophenyl)methylidene]-1,3,4-trimethylpiperazine-2,5-dione,
3-benzyl-6-[1-(2-methoxy-6-nitrophenyl)methylidene]-1,3,4-trimethylpiperazine-2,5-dione,
3-benzyl-6-[1-(2-methyl-6-nitrophenyl)methylidene]-1,3,4-trimethylpiperazine-2,5-dione,
3-benzyl-6-[1-(2-ethenyl-6-nitrophenyl)methylidene]-1,3,4-trimethylpiperazine-2,5-dione,
3-benzyl-6-[1-(2-nitrophenyl)methylidene]-1,3-dimethylpiperazine-2,5-dione,
3-benzyl-6-[1-(2-fluoro-6-nitrophenyl)methylidene]-1,3-dimethylpiperazine-2,5-dione,
3-benzyl-6-[1-(2,3-difluoro-6-nitrophenyl)methylidene]-1,3-dimethylpiperazine-2,5-dione,
3-benzyl-6-[1-(2-methoxy-6-nitrophenyl)methylidene]-1,3-dimethylpiperazine-2,5-dione,
3-benzyl-6-[1-(2-methyl-6-nitrophenyl)methylidene]-1,3-dimethylpiperazine-2,5-dione,
3-benzyl-6-[1-(2-nitrophenyl)-methylidene]-3-ethyl-1,4-dimethylpiperazine-2,5-dione,
3-benzyl-6-[1-(2-fluoro-6-nitrophenyl)methylidene]-3-ethyl-1,4-dimethylpiperazine-2,5-dione,
3-benzyl-6-[1-(2,3-difluoro-6-nitrophenyl)methylidene]-3-ethyl-1,4-dimethyl-piperazine-2,5-dione,
3-benzyl-6-[1-(2-methoxy-6-nitrophenyl)methylidene]-3-ethyl-1,4-dimethyl-piperazine-2,5-dione,
3-benzyl-6-[1-(2-methyl-6-nitrophenyl)methylidene]-3-ethyl-1,4-dimethyl-piperazine-2,5-dione,
3-benzyl-6-[1-(2-ethenyl-6-nitrophenyl)methylidene]-3-ethyl-1,4-dimethyl-piperazine-2,5-dione,
3-benzyl-6-[1-(2-nitrophenyl)methylidene]-3-ethyl-1-methylpiperazine-2,5-dione,
3-benzyl-6-[1-(2-fluoro-6-nitrophenyl)-methylidene]-3-ethyl-1-methylpiperazine-2,5-dione,
3-benzyl-6-[1-(2,3-difluoro-6-nitrophenyl)methylidene]-3-ethyl-1-methylpiperazine-2,5-dione,
3-benzyl-6-[1-(2-methoxy-6-nitrophenyl)methylidene]-3-ethyl-1-methylpiperazine-2,5-dione,
3-benzyl-6-[1-(2-methyl-6-nitrophenyl)methylidene]-3-ethyl-1-methylpiperazine-2,5-dione, and
2-[5-(4-fluorobenzyl)-1,4,5-trimethyl-3,6-dioxopiperazin-2-ylidenemethyl]-benzonitrile,
2-[5-(4-fluorobenzyl)-1,4,5-trimethyl-3,6-dioxopiperazin-2-ylidenemethyl]-3-fluorobenzonitrile,
2-[5-(4-fluorobenzyl)-1,4,5-trimethyl-3,6-dioxopiperazin-2-ylidenemethyl]-3-methoxybenzonitrile,
2-[5-(4-fluorobenzyl)-1,4,5-trimethyl-3,6-dioxopiperazin-2-ylidenemethyl]-3,4-difluorobenzonitrile,
2-[5-(4-fluorobenzyl)-1,4,5-trimethyl-3,6-dioxopiperazin-2-ylidenemethyl]-3-methylbenzonitrile,
2-[5-(4-fluorobenzyl)-1,5-dimethyl-3,6-dioxopiperazin-2-ylidenemethyl]-benzonitrile,
2-[5-(4-fluorobenzyl)-1,5-dimethyl-3,6-dioxopiperazin-2-ylidenemethyl]-3-fluoro-benzonitrile,
2-[5-(4-fluorobenzyl)-1,5-dimethyl-3,6-dioxopiperazin-2-ylidenemethyl]-3-methoxybenzonitrile,
2-[5-(4-fluorobenzyl)-1,5-dimethyl-3,6-dioxopiperazin-2-ylidenemethyl]-3,4-difluorobenzonitrile,
2-[5-(4-fluorobenzyl)-1,5-dimethyl-3,6-dioxopiperazin-2-ylidenemethyl]-3-methyl-benzonitrile,
2-[5-(4-fluorobenzyl)-5-ethyl-1,4-dimethyl-3,6-dioxopiperazin-2-ylidenemethyl]-benzonitrile
2-[5-(4-fluorobenzyl)-5-ethyl-1,4-dimethyl-3,6-dioxopiperazin-2-ylidenemethyl]-3-fluorobenzonitrile
2-[5-(4-fluorobenzyl)-5-ethyl-1,4-dimethyl-3,6-dioxopiperazin-2-ylidenemethyl]-3-methoxybenzonitrile
2-[5-(4-fluorobenzyl)-5-ethyl-1,4-dimethyl-3,6-dioxopiperazin-2-ylidenemethyl]-3,4-difluorobenzonitrile,
2-[5-(4-fluorobenzyl)-5-ethyl-1,4-dimethyl-3,6-dioxopiperazin-2-ylidenemethyl]-3-methylbenzonitrile,
2-[5-(4-fluorobenzyl)-5-ethyl-1-methyl-3,6-dioxopiperazin-2-ylidenemethyl]-benzonitrile,
2-[5-(4-fluorobenzyl)-5-ethyl-1-methyl-3,6-dioxopiperazin-2-ylidenemethyl]-3-fluorobenzonitrile,
2-[5-(4-fluorobenzyl)-5-ethyl-1-methyl-3,6-dioxopiperazin-2-ylidenemethyl]-3-methoxybenzonitrile,
2-[5-(4-fluorobenzyl)-5-ethyl-1-methyl-3,6-dioxopiperazin-2-ylidenemethyl]-3,4-difluorobenzonitrile,
2-[5-(4-fluorobenzyl)-5-ethyl-1-methyl-3,6-dioxopiperazin-2-ylidenemethyl]-3-methylbenzonitrile,
3-(4-fluorobenzyl)-6-[1-(2-nitrophenyl)methylidene]-1,3,4-trimethylpiperazine-2,5-dione,
3-(4-fluorobenzyl)-6-[1-(2-fluoro-6-nitrophenyl)methylidene]-1,3,4-trimethyl-piperazine-2,5-dione,
3-(4-fluorobenzyl)-6-[1-(2,3-difluoro-6-nitrophenyl)methylidene]-1,3,4-trimethyl-piperazine-2,5-dione,
3-(4-fluorobenzyl)-6-[1-(2-methoxy-6-nitrophenyl)methylidene]-1,3,4-trimethyl-piperazine-2,5-dione,
3-(4-fluorobenzyl)-6-[1-(2-methyl-6-nitrophenyl)methylidene]-1,3,4-trimethylpiperazine-2,5-dione,
3-(4-fluorobenzyl)-6-[1-(2-nitrophenyl)methylidene]-1,3-dimethylpiperazine-2,5-dione,
3-(4-fluorobenzyl)-6-[1-(2-fluoro-6-nitrophenyl)methylidene]-1,3-dimethyl-piperazine-2,5-dione,
3-(4-fluorobenzyl)-6-[1-(2,3-difluoro-6-nitrophenyl)methylidene]-1,3-dimethyl-piperazine-2,5-dione,
3-(4-fluorobenzyl)-6-[1-(2-methoxy-6-nitrophenyl)methylidene]-1,3-dimethyl-piperazine-2,5-dione,
3-(4-fluorobenzyl)-6-[1-(2-methyl-6-nitrophenyl)methylidene]-1,3-dimethyl-piperazine-2,5-dione,
3-(4-fluorobenzyl)-6-[1-(2-nitrophenyl)methylidene]-3-ethyl-1,4-dimethyl-piperazine-2,5-dione,
3-(4-fluorobenzyl)-6-[1-(2-fluoro-6-nitrophenyl)methylidene]-3-ethyl-1,4-dimethyl-piperazine-2,5-dione,
3-(4-fluorobenzyl)-6-[1-(2,3-difluoro-6-nitrophenyl)methylidene]-3-ethyl-1,4-dimethylpiperazine-2,5-dione,
3-(4-fluorobenzyl)-6-[1-(2-methoxy-6-nitrophenyl)methylidene]-3-ethyl-1,4-dimethylpiperazine-2,5-dione,
3-(4-fluorobenzyl)-6-[1-(2-methyl-6-nitrophenyl)methylidene]-3-ethyl-1,4-dimethyl-piperazine-2,5-dione,
3-(4-fluorobenzyl)-6-[1-(2-nitrophenyl)methylidene]-3-ethyl-1-methylpiperazine-2,5-dione,
3-(4-fluorobenzyl)-6-[1-(2-fluoro-6-nitrophenyl)methylidene]-3-ethyl-1-methyl-piperazine-2,5-dione,
3-(4-fluorobenzyl)-6-[1-(2,3-difluoro-6-nitrophenyl)methylidene]-3-ethyl-1-methyl-piperazine-2,5-dione,
3-(4-fluorobenzyl)-6-[1-(2-methoxy-6-nitrophenyl)methylidene]-3-ethyl-1-methyl-piperazine-2,5-dione and
3-(4-fluorobenzyl)-6-[1-(2-methyl-6-nitrophenyl)methylidene]-3-ethyl-1-methyl-piperazine-2,5-dione.

12. The composition according to claim 11, where the piperazinedione compound of the formula 1 is selected from 2-[5-benzyl-1,4,5-trimethyl-3,6-dioxopiperazin-2-ylidenemethyl]benzonitrile and 2-[5-benzyl-1,4-dimethyl-3,6-dioxopiperazin-2-ylidenemethyl]benzonitrile.

13. The composition according to claim 1 where the piperazinedione compound of the formula I is selected from the group consisting of:
2-[5-benzyl-1,4,5-trimethyl-3,6-dioxopiperazin-2-ylmethyl]benzonitrile,
2-[5-benzyl-1,4,5-trimethyl-3,6-dioxopiperazin-2-ylmethyl]-3-fluorobenzonitrile,
2-[5-benzyl-1,4,5-trimethyl-3,6-dioxopiperazin-2-ylmethyl]-3-methoxybenzonitrile,
2-[5-benzyl-1,4,5-trimethyl-3,6-dioxopiperazin-2-ylmethyl]-3,4-difluorobenzonitrile,
2-[5-benzyl-1,5-dimethyl-3,6-dioxopiperazin-2-ylmethyl]benzonitrile,
2-[5-benzyl-1,5-dimethyl-3,6-dioxopiperazin-2-ylmethyl]-3-fluorobenzonitrile,
2-[5-benzyl-1,5-dimethyl-3,6-dioxopiperazin-2-ylmethyl]-3-methoxybenzonitrile,
2-[5-benzyl-1,5-dimethyl-3,6-dioxopiperazin-2-ylmethyl]-3,4-difluorobenzonitrile,
2-[5-benzyl-1,4-dimethyl-3,6-dioxopiperazin-2-ylmethyl]benzonitrile,
2-[5-benzyl-1,4-dimethyl-3,6-dioxopiperazin-2-ylmethyl]-3-fluorobenzonitrile,
2-[5-benzyl-1,4-dimethyl-3,6-dioxopiperazin-2-ylmethyl]-3-methoxybenzonitrile,
2-[5-benzyl-1,4-dimethyl-3,6-dioxopiperazin-2-ylmethyl]-3,4-difluorobenzonitrile,
2-[5-(4-fluorobenzyl)-1,4,5-trimethyl-3,6-dioxopiperazin-2-ylmethyl]benzonitrile,
2-[5-(4-fluorobenzyl)-1,4,5-trimethyl-3,6-dioxopiperazin-2-ylmethyl]-3-fluorobenzonitrile,
2-[5-(4-fluorobenzyl)-1,4,5-trimethyl-3,6-dioxopiperazin-2-ylmethyl]-3-methoxy-benzonitrile,
2-[5-(4-fluorobenzyl)-1,4,5-trimethyl-3,6-dioxopiperazin-2-ylmethyl]-3,4-difluoro-benzonitrile,
2-[5-(4-fluorobenzyl)-1,5-dimethyl-3,6-dioxopiperazin-2-ylmethyl]benzonitrile,
2-[5-(4-fluoro benzyl)-1,5-dimethyl-3,6-dioxopiperazin-2-ylmethyl]-3-fluoro-benzonitrile,
2-[5-(4-fluorobenzyl)-1,5-dimethyl-3,6-dioxopiperazin-2-ylmethyl]-3-methoxy-benzonitrile,
2-[5-(4-fluorobenzyl)-1,5-dimethyl-3,6-dioxopiperazin-2-ylmethyl]-3,4-difluoro-benzonitrile,
2-[5-(4-fluorobenzyl)-1,4-dimethyl-3,6-dioxopiperazin-2-ylmethyl]benzonitrile,
2-[5-(4-fluorobenzyl)-1,4-dimethyl-3,6-dioxopiperazin-2-ylmethyl]-3-fluorobenzo-nitrile,
2-[5-(4-fluorobenzyl)-1,4-dimethyl-3,6-dioxopiperazin-2-ylmethyl]-3-methoxy-benzonitrile,
2-[5-(4-fluorobenzyl)-1,4-dimethyl-3,6-dioxopiperazin-2-ylmethyl]-3,4-difluoro-benzonitrile,
3-benzyl-6-(2-nitrobenzyl)-1,3,4-trimethylpiperazine-2,5-dione,
3-benzyl-6-(2-fluoro-6-nitrobenzyl)-1,3,4-trimethylpiperazine-2,5-dione,
3-benzyl-6-(2,3-difluoro-6-nitrobenzyl)-1,3,4-trimethylpiperazine-2,5-dione,
3-benzyl-6-(2-methoxy-6-nitrobenzyl)-1,3,4-trimethylpiperazine-2,5-dione,
3-benzyl-6-(2-nitrobenzyl)-1,3-dimethylpiperazine-2,5-dione,
3-benzyl-6-(2-fluoro-6-nitrobenzyl)-1,3-dimethylpiperazine-2,5-dione,
3-benzyl-6-(2,3-difluoro-6-nitrobenzyl)-1,3-dimethylpiperazine-2,5-dione,
3-benzyl-6-(2-methoxy-6-nitrobenzyl)-1,3-dimethylpiperazine-2,5-dione,
3-benzyl-6-(2-nitrobenzyl)-1,4-dimethylpiperazine-2,5-dione,
3-benzyl-6-(2-fluoro-6-nitrobenzyl)-1,4-dimethylpiperazine-2,5-dione,
3-benzyl-6-(2,3-difluoro-6-nitrobenzyl)-1,4-dimethylpiperazine-2,5-dione,
3-benzyl-6-(2-methoxy-6-nitrobenzyl)-1,4-dimethylpiperazine-2,5-dione,
3-(4-fluorobenzyl)-6-(2-nitrobenzyl)-1,3,4-trimethylpiperazine-2,5-dione,
3-(4-fluorobenzyl)-6-(2-fluoro-6-nitrobenzyl)-1,3,4-trimethylpiperazine-2,5-dione,
3-(4-fluorobenzyl)-6-(2,3-difluoro-6-nitrobenzyl)-1,3,4-trimethylpiperazine-2,5-dione,
3-(4-fluorobenzyl)-6-(2-methoxy-6-nitrobenzyl)-1,3,4-trimethylpiperazine-2,5-dione,
3-(4-fluorobenzyl)-6-(2-nitrobenzyl)-1,3-dimethylpiperazine-2,5-dione,
3-(4-fluorobenzyl)-6-(2-fluoro-6-nitrobenzyl)-1,3-dimethylpiperazine-2,5-dione,
3-(4-fluorobenzyl)-6-(2,3-difluoro-6-nitrobenzyl)-1,3-dimethylpiperazine-2,5-dione
and 3-(4-fluorobenzyl)-6-(2-methoxy-6-nitrobenzyl)-1,3-dimethylpiperazine-2,5-dione.

14. The composition according to claim 13, where the piperazinedione compound of the formula I is 2-[5-benzyl-1,4,5-trimethyl-3,6-dioxopiperazin-2-ylmethyl]benzonitrile.

15. The composition according to any of the preceding claims, comprising at least one herbicide B, selected from the compounds listed below:
b1) from the group of the lipid biosynthesis inhibitors:
alloxydim, alloxydim-sodium, butroxydim, clethodim, clodinafop, clodinafop-propargyl, cycloxydim, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, pinoxaden, profoxydim, propaquizafop, quizalofop, quizalofop-ethyl, quizalofop-tefuryl, quizalofop-P, quizalofop-P-ethyl, quizalofop-P-tefuryl, sethoxydim, tepraloxydim, tralkoxydim, benfuresate, butylate, cycloate, dalapon, dimepiperate, EPTC, esprocarb, ethofumesate, flupropanate, molinate, orbencarb, pebulate, prosulfocarb, TCA, thiobencarb, tiocarbazil, triallate and vernolate;
b2) from the group of the ALS inhibitors:
amidosulfuron, azimsulfuron, bensulfuron, bensulfuron-methyl, bispyribac, bispyribac-sodium, chlorimuron, chlorimuron-ethyl, chlorsulfuron, cinosulfuron, cloransulam, cloransulam-methyl, cyclosulfamuron, diclosulam, ethametsulfuron, ethametsulfuron-methyl, ethoxysulfuron, flazasulfuron, florasulam, flucarbazone, flucarbazone-sodium, flucetosulfuron, flumetsulam, flupyrsulfuron, flupyrsulfuron-methyl-sodium, foramsulfuron, halosulfuron, halosulfuron-methyl, imazamethabenz, imazamethabenz-methyl, imazamox, imazapic, imazapyr, imazaquin, imazethapyr, imazosulfuron, iodosulfuron, iodosulfuron-methyl-sodium, mesosulfuron, metosulam, metsulfuron, metsulfuron-methyl, nicosulfuron, orthosulfamuron, oxasulfuron, penoxsulam, primisulfuron, primisulfuron-methyl, propoxycarbazone, propoxycarbazone-sodium, prosulfuron, pyrazosulfuron, pyrazosulfuron-ethyl, pyribenzoxim, pyrimisulfan, pyriftalid, pyriminobac, pyriminobac-methyl, pyrithiobac, pyrithiobac-sodium, pyroxsulam, rimsulfuron, sulfometuron, sulfometuron-methyl, sulfosulfuron, thiencarbazone, thiencarbazone-methyl, thifensulfuron, thifensulfuron-methyl, triasulfuron, tribenuron, tribenuron-methyl, trifloxysulfuron, triflusulfuron, triflusulfuron-methyl and tritosulfuron;
b3) from the group of the photosynthesis inhibitors:
ametryn, amicarbazone, atrazine, bentazone, bentazone-sodium, bromacil, bromofenoxim, bromoxynil and its salts and esters, chlorobromuron, chloridazone, chlorotoluron, chloroxuron, cyanazine, desmedipham, desmetryn, dimefuron, dimethametryn, diquat, diquat-dibromide, diuron, fluometuron, hexazinone, ioxynil and its salts and esters, isoproturon, isouron, karbutilate, lenacil, linuron, metamitron, methabenzthiazuron, metobenzuron, metoxuron, metribuzin, monolinuron, neburon, paraquat, paraquat-dichloride, paraquat-dimetilsulfate, pentanochlor, phenmedipham, phenmedipham-ethyl, prometon, prometryn, propanil, propazine, pyridafol, pyridate, siduron, simazine, simetryn, tebuthiuron, terbacil, terbumeton, terbuthylazine, terbutryn, thidiazuron and trietazine;
b4) from the group of the protoporphyrinogen-IX oxidase inhibitors:
acifluorfen, acifluorfen-sodium, azafenidin, bencarbazone, benzfendizone, bifenox, butafenacil, carfentrazone, carfentrazone-ethyl, chlomethoxyfen, cinidon-ethyl, fluazolate, flufenpyr, flufenpyr-ethyl, flumiclorac, flumiclorac-pentyl, flumioxazin, fluoroglycofen, fluoroglycofen-ethyl, fluthiacet, fluthiacet-methyl, fomesafen, halosafen, lactofen, oxadiargyl, oxadiazon, oxyfluorfen, pentoxazone, profluazol, pyraclonil, pyraflufen, pyraflufen-ethyl, sulfentrazone, thidiazimin, 2-chloro-5-[3,6-dihydro-3-methyl-2,6-dioxo-4-(trifluoromethyl)-1(2H)-pyrimidinyl]-4-fluoro-N-[(isopropyl)methylsulfamoyl]-benzamide (CAS 372137-35-4), ethyl[3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6), N-ethyl-3-(2,6-dichloro-4-trifluoro-methylphenoxy)-5-methyl-1H-pyrazole-1-carboxamide (CAS 452098-92-9), N-tetrahydrofurfuryl-3-(2,6-dichloro-4-trifluoromethylphenoxy)-5-methyl-1H-pyrazole-1-carboxamide (CAS 915396-43-9), N-ethyl-3-(2-chloro-6-fluoro-4-trifluoromethylphenoxy)-5-methyl-1H-pyrazole-1-carboxamide (CAS 452099-05-7) and N-tetrahydrofurfuryl-3-(2-chloro-6-fluoro-4-trifluoro-methylphenoxy)-5-methyl-1H-pyrazole-1-carboxamide (CAS 45100-03-7);
b5) from the group of the bleacher herbicides:
aclonifen, amitrole, beflubutamid, benzobicyclon, benzofenap, clomazone, diflufenican, fluridone, fluorochloridone, flurtamone, isoxaflutole, mesotrione, norflurazon, picolinafen, pyrasulfotole, pyrazolynate, pyrazoxyfen, sulcotrione, tefuryltrione, tembotrione, topramezone, 4-hydroxy-3-[[2-[(2-methoxyethoxy)methyl]-6-(trifluoromethyl)-3-pyridyl]carbonyl]bicyclo-[3.2.1]oct-3-en-2-one (CAS 352010-68-5) and 4-(3-trifluoromethylphenoxy)-2-(4-trifluoromethylphenyl)pyrimidine (CAS 180608-33-7);
b6) from the group of the EPSP synthase inhibitors: glyphosate, glyphosate-isopropylammonium and glyphosate-trimesium (sulfosate);
b7) from the group of the glutamine synthase inhibitors: bilanaphos (bialaphos), bilanaphos-sodium, glufosinate and glufosinate-ammonium;
b8) from the group of the DHP synthase inhibitors: asulam;
b9) from the group of the mitose inhibitors:
amiprophos, amiprophos-methyl, benfluralin, butamiphos, butralin, carbetamide, chlorpropham, chlorthal, chlorthal-dimethyl, dinitramine, dithiopyr, ethalfluralin, fluchioralin, oryzalin, pendimethalin, prodiamine, propham, propyzamide, tebutam, thiazopyr and trifluralin;
b10) from the group of the VLCFA inhibitors: acetochlor, alachlor, anilofos, butachlor, cafenstrole, dimethachlor, dimethanamid, dimethenamid-P, diphenamid, fentrazamide, flufenacet, mefenacet, metazachlor, metolachlor, metolachlor-S, naproanilide, napropamide, pethoxamid, piperophos, pretilachlor, propachlor, propisochlor, pyroxasulfone, thenylchlor and also isoxazoline compounds, different from pyroxasulfone, of the formula II 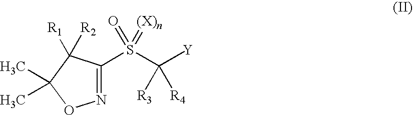
in which R₁, R₂, R₃, R₄, X, Y and n have the meanings below:
R₁, R₂, R₃, R₄ are each independently of one another hydrogen, halogen or C₁-C₄-alkyl;
Y is phenyl or monocyclic 5-, 6-, 7-, 8-, 9- or 10-membered heterocyclyl which, in addition to carbon ring members, contains one, two or three identical or different heteroatoms selected from the group consisting of oxygen, sulfur and nitrogen as ring members, where phenyl and heterocyclyl are unsubstituted or carry 1, 2 or 3 substituents R^{yy} selected from the group consisting of halogen, C₁-C₄-alkyl, C₁-C₄-alkoxy, C₁-C₄-haloalkyl and C₁-C₄-haloalkoxy, preferably phenyl or 5- or 6-membered aromatic heterocyclyl (hetaryl) which, in addition to carbon ring members, contains one, two or three nitrogen atoms as ring members, where phenyl and hetaryl are unsubstituted or carry 1, 2 or 3 substituents R^{yy};
X is oxygen or NH; and
n is zero or one;
b11) from the group of the cellulose biosynthesis inhibitors:
chlorthiamid, dichlobenil, flupoxam and isoxaben;
b12) from the group of the decoupler herbicides: dinoseb, dinoterb and DNOC and its salts;
b13) from the group of the auxin herbicides:
2,4-D and its salts and esters, 2,4-DB and its salts and esters, aminopyralid and its salts and its esters, benazolin, benazolin-ethyl, chloramben and its salts and esters, clomeprop, clopyralid and its salts and esters, dicamba and its salts and esters, dichlorprop and its salts and esters, dichlorprop-P and its salts and esters, fluoroxypyr, fluoroxypyr-butomethyl, fluoroxypyr-meptyl, MCPA and its salts and esters, MCPA-thioethyl, MCPB and its salts and esters, mecoprop and its salts and esters, mecoprop-P and its salts and esters, picloram and its salts and esters, quinclorac, quinmerac, TBA (2,3,6) and its salts and esters, triclopyr and its salts and esters, and 5,6-dichloro-2-cyclopropyl-4-pyrimidinecarboxylic acid (CAS 858956-08-8) and its salts and esters;
b14) from the group of the auxin transport inhibitors: diflufenzopyr, diflufenzopyr-sodium, naptalam and naptalam-sodium;
b15) from the group of the other herbicides: bromobutide, chlorflurenol, chlorflurenol-methyl, cinmethylin, cumyluron, dalapon, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-M-methyl, flurenol, flurenol-butyl, flurprimidol, fosamine, fosamine-ammonium, indanofan, maleic hydrazide, mefluidide, metam, methyl azide, methyl bromide, methyl-dymron, methyl iodide, MSMA, oleic acid, oxaziclomefone, pelargonic acid, pyributicarb, quinoclamine, triaziflam, tridiphane and 6-chloro-3-(2-cyclopropyl-6-methylphenoxy)-4-pyridazinol (CAS 499223-49-3) and its salts and esters.

16. The composition according to claim 15, where the herbicides B are selected from the group consisting of:
b1) clethodim, clodinafop-propargyl, cycloxydim, cyhalofop-butyl, diclofop-methyl, fenoxaprop-P-ethyl, fluazifop-P-butyl, haloxyfop-P-methyl, metamifop, pinoxaden, profoxydim, propaquizafop, quizalofop-P-ethyl, quizalofop-P-tefuryl, sethoxydim, tepraloxydim, tralkoxydim, benfuresate, dimepiperate, EPTC, esprocarb, ethofumesate, molinate, orbencarb, prosulfocarb, thiobencarb and triallate;
b2) amidosulfuron, azimsulfuron, bensulfuron-methyl, bispyribac-sodium, chlorimuron-ethyl, chlorsulfuron, cloransulam-methyl, cyclosulfamuron, diclosulam, ethametsulfuron-methyl, ethoxysulfuron, flazasulfuron, florasulam, flucarbazone-sodium, flucetosulfuron, flumetsulam, flupyrsulfuron-methyl-sodium, foramsulfuron, halosulfuron-methyl, imazamethabenz-methyl, imazamox, imazapic, imazapyr, imazaquin, imazethapyr, imazosulfuron, iodosulfuron, iodosulfuron-methyl-sodium, mesosulfuron, metosulam, metsulfuron-methyl, nicosulfuron, orthosulfamuron, oxasulfuron, penoxsulam, primisulfuron-methyl, propoxycarbazon-sodium, prosulfuron, pyrazosulfuron-ethyl, pyribenzoxim, pyrimisulfan, pyriftalid, pyriminobac-methyl, pyrithiobac-sodium, pyroxsulam, rimsulfuron, sulfometuron-methyl, sulfosulfuron, thiencarbazone-methyl, thifensulfuron-methyl, triasulfuron, tribenuron-methyl, trifloxysulfuron, triflusulfuron-methyl and tritosulfuron;
b3) amicarbazone, atrazine, bentazone, bentazone-sodium, bromoxynil and its salts and esters, chloridazone, chlorotoluron, cyanazine, desmedipham, diquat-dibromide, diuron, fluometuron, hexazinone, ioxynil and its salts and esters, isoproturon, lenacil, linuron, metamitron, methabenzthiazuron, metribuzin, paraquat, paraquat-dichloride, phenmedipham, propanil, pyridate, simazine, terbuthylazine and thidiazuron;
b4) acifluorfen-sodium, bencarbazone, benzfendizone, butafenacil, carfentrazone-ethyl, cinidon-ethyl, flufenpyr-ethyl, flumiclorac-pentyl, flumioxazin, fluoroglycofen-ethyl, fomesafen, lactofen, oxadiargyl, oxadiazon, oxyfluorfen, pentoxazone, pyraflufen-ethyl, sulfentrazone, 2-chloro-5-[3,6-dihydro-3-methyl-2,6-dioxo-4-(trifluoromethyl)-1(2H)-pyrimidinyl]-4-fluoro-N-[(isopropyl)methylsulfamoyl]benzamide (CAS 372137-35-4), ethyl[3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6), N-ethyl-3-(2,6-dichloro-4-trifluoromethylphenoxy)-5-methyl-1H-pyrazole-1-carboxamide (CAS 452098-92-9), N-tetrahydrofurfuryl-3-(2,6-dichloro-4-trifluoromethylphenoxy)-5-methyl-1H-pyrazole-1-carboxamide (CAS 915396-43-9), N-ethyl-3-(2-chloro-6-fluoro-4-trifluoro-methylphenoxy)-5-methyl-1H-pyrazole-1-carboxamide (CAS 452099-05-7) and N-tetrahydrofurfuryl-3-(2-chloro-6-fluoro-4-trifluoromethylphenoxy)-5-methyl-1H-pyrazole-1-carboxamide (CAS 45100-03-7);
b5) aclonifen, beflubutamid, benzobicyclon, clomazone, diflufenican, fluorochloridone, flurtamone, isoxaflutole, mesotrione, norflurazon, picolinafen, pyrasulfotole, pyrazolynate, sulcotrione, tefuryltrione, tembotrione, topramezone, 4-hydroxy-3[[2-[(2-methoxyethoxy)methyl]-6-(trifluoromethyl)-3-pyridyl]carbonyl]bicyclo[3.2.1]oct-3-en-2-one (CAS 352010-68-5) and 4-(3-trifluoromethylphenoxy)-2-(4-trifluoromethylphenyl)-pyrimidine (CAS 180608-33-7);
b6) glyphosate, glyphosate-isopropylammonium and glyphosate-trimesium (sulfosate);
b7) glufosinate, glufosinate-ammonium;
b8) asulam;
b9) benfluralin, dithiopyr, ethalfluralin, oryzalin, pendimethalin, thiazopyr and trifluralin;
b10) acetochlor, alachlor, anilofos, butachlor, cafenstrole, dimethenamid, dimethenamid-P, fentrazamide, flufenacet, mefenacet, metazachlor, metolachlor, S-metolachlor, naproanilide, napropamide, pretilachlor, pyroxasulfone, thenylchlor as well as isoxazoline compounds of the formulae II.1, II.2, II.3, II.4, II.5, II.6, II.7, II.8 and II.9 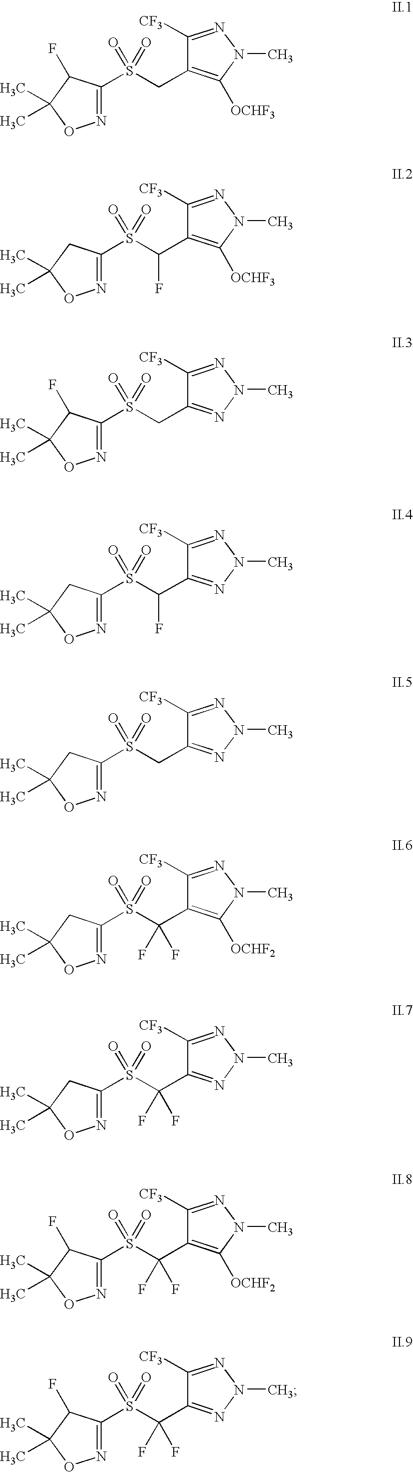
b11) dichlobenil, isoxaben, flupoxam;
b13) 2,4-D and its salts and esters, aminopyralid and its salts and its esters, clopyralid and its salts and esters, dicamba and its salts and esters, dichlorprop-P and its salts and esters, fluoroxypyr-meptyl, MCPA and its salts and esters, MCPB and its salts and esters, mecoprop-P and its salts and esters, picloram and its salts and esters, quinclorac, quinmerac, triclopyr and its salts and esters, and 5,6-dichloro-2-cyclopropyl-4-pyrimidinecarboxylic acid (CAS 858956-08-8) and its salts and esters;
b14) diflufenzopyr and diflufenzopyr-sodium;
b15) bromobutide, cinmethylin, cumyluron, dalapon, difenzoquat, difenzoquat-metilsulfate, DSMA, dymron (=daimuron), flamprop, flamprop-isopropyl, flamprop-methyl, flamprop-M-isopropyl, flamprop-M-methyl, indanofan, metam, methylbromide, MSMA, oxaziclomefone, pyributicarb, triaziflam, tridiphane and 6-chloro-3-(2-cyclopropyl-6-methylphenoxy)-4-pyridazinol (CAS 499223-49-3) and its salts and esters.

17. The composition according to claim 15, where the herbicides B are selected from the group consisting of:
b1) clodinafop-propargyl, cycloxydim, cyhalofop-butyl, fenoxaprop-P-ethyl, pinoxaden, profoxydim, tepraloxydim, tralkoxydim, esprocarb, prosulfocarb, thiobencarb, triallate;
b2) bensulfuron-methyl, bispyribac-sodium, cyclosulfamuron, flumetsulam, flupyrsulfuron-methyl-sodium, foramsulfuron, imazamox, imazapic, imazapyr, imazaquin, imazethapyr, imazosulfuron, iodosulfuron, iodosulfuron-methyl-sodium, mesosulfuron, nicosulfuron, penoxsulam, propoxycarbazon-sodium, pyrazosulfuron-ethyl, pyroxsulam, rimsulfuron, sulfosulfuron, thiencarbazon-methyl, tritosulfuron;
b3) atrazine, diuron, fluometuron, hexazinone, isoproturon, metribuzin, paraquat, paraquat-dichloride, propanil and terbuthylazine;
b4) flumioxazin, oxyfluorfen, sulfentrazone, 2-chloro-5-[3,6-dihydro-3-methyl-2,6-dioxo-4-(trifluoromethyl)-1(2H)-pyrimidinyl]-4-fluoro-N-[(isopropyl)-methylsulfamoyl]benzamide (CAS 372137-35-4) and ethyl[3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6);
b5) clomazone, diflufenican, fluorochloridone, isoxaflutole, mesotrione, picolinafen, sulcotrione, tefuryltrione, tembotrione, topramezone and 4-hydroxy-3-[[2-[(2-methoxyethoxy)methyl]-6-(trifluoromethyl)-3-pyridyl]-carbonyl]bicyclo[3.2.1]oct-3-en-2-one (CAS 352010-68-5);
b6) glyphosate, glyphosate-isopropylammonium and glyphosate-trimesium (sulfosate);
b7) glufosinate, glufosinate-ammonium;
b9) pendimethalin and trifluralin;
b10) acetochlor, cafenstrole, dimethenamid-P, fentrazamide, flufenacet, mefenacet, metazachlor, S-metolachlor, pyroxasulfone as well as isoxazoline compounds of the formulae II.1, II.2, II.3, II.4, II.5, II.6, II.7, II.8 and II.9, as defined in claim 16;
b11) isoxaben;
b13) 2,4-D and its salts and esters, aminopyralid and its salts and its esters, clopyralid and its salts and esters, dicamba and its salts and esters, fluoroxypyr-meptyl, quinclorac, quinmerac and 5,6-dichloro-2-cyclopropyl-4-pyrimidinecarboxylic acid (CAS 858956-08-8) and its salts and esters;
b14) diflufenzopyr and diflufenzopyr-sodium,
b15) dymron (=daimuron), indanofan, oxaziclomefone and triaziflam.

18. The composition according to any of the preceding claims, comprising at least one active compound selected from the herbicides of classes b1), b2), b3), b4), b5), b9), b11) and b13).

19. The composition according to any of claims 1 to 17, comprising at least one active compound selected from the herbicides of class b10).

20. The composition according to any of the preceding claims, comprising at least one safener C selected from the group consisting of benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, MON4660 [CAS RN 71526-07-3], naphthalic anhydride, oxabetrinil, 4-(dichloroacetyl)-1-oxa-4-azaspiro[4.5]decane (MON4660, CAS 71526-07-3) and 2,2,5-trimethyl-3-(dichloroacetyl)-1,3-oxazolidine (R-29148, CAS 52836-31-4).

21. The composition according to any of the preceding claims in which the weight ratio of component A to component B is in the range of from 500:1 to 1:500.

22. The composition according to claim 21 in which the weight ratio of component A to component C is in the range of from 100:1 to 1:100.

23. The composition according to claim 21 in which the weight ratio of component B to component C is in the range of from 500:1 to 1:500.

24. The composition according to any of the preceding claims in the form of a crop protection composition formulated as a 1-component composition comprising an active compound combination comprising at least one piperazinedione compound of the formula I and at least one further active compound selected from the herbicides B and the safeners C, and at least one solid or liquid carrier and/or one or more surfactants.

25. The composition according to any of claims 1 to 23 in the form of a crop protection composition formulated as a 2-component composition comprising a first component comprising at least one piperazinedione compound of the formula I, a solid or liquid carrier and/or one or more surfactants, and a second component comprising at least one further active compound selected from the herbicides B and safeners C, a solid or liquid carrier and/or one or more surfactants.

26. A method for controlling unwanted vegetation wherein a herbicidally effective amount of a composition according to any of claims 1 to 25 is allowed to act on plants, their habitat or seed.

27. The method according to claim 26 wherein a composition according to any of claims 1 to 25 is applied before, during and/or after emergence of the unwanted plants, where the herbicidally active components A) and B) and/or C) are applied simultaneously or in succession.

28. The method according to claim 26 wherein the leaves of the crop plants and the unwanted plants are treated.

29. The use of compositions according to any of claims 1 to 25 for controlling unwanted vegetation.

30. The use of compositions according to any of claims 1 to 25 for controlling unwanted vegetation in crops of the following plant species: Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica raps var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus armeniaca, Prunus avium, Prunus cerasus, Prunus dulcis, Prunus domestica, Prunus persica, Pyrus communis, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticale, Triticum aestivum, Triticum durum, Vicia faba, Vitis vinifera and Zea mays.
